(19) United States
(12) Patent Application Publication
(10) Pub. No.: US 2006/0044307 A1
(43) Pub. Date: Mar. 2, 2006

(54) System and method for visually representing project metrics on 3-dimensional building models

(75) Inventor: Kyuman Song, Moon Township, PA (US)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Kyuman Song, Brookline, MA (US)

(21) Appl. No.: 11/209,043

(22) Filed: Aug. 23, 2005

Related U.S. Application Data
(60) Provisional application No. 60/603,534, filed on Aug. 24, 2004.

(51) Int. Cl. G05B 19/418; G06T 15/00

(52) U.S. Cl. 345/419; 705/8

(57) ABSTRACT

Provided are a system and method for visually representing project metrics on 3-dimensional product models. The system comprises: a user interface unit for receiving an input of color information, including variations in the colors and color tones of objects to be visualized in response to the course of a project, and output conditions, including a time interval at which an output is required, from a user; a database unit for storing the objects and temporal and/or spatial relationships between the objects; and an image formation unit for determining colors and color tones of the objects according to the project course based on the output conditions input by the user, and forming and outputting 3-dimensional images of the objects by the determined colors and color tones.

### RELATED APPLICATIONS

The present application claims priority of U.S. Provisional Application Ser. No. 60/603,534, filed Aug. 24, 2004, entitled 3-Dimensional Model Based Project Management And Control System And Method Of The Same, the disclosure of which is incorporated by reference herein in its entirety.

### BACKGROUND OF THE INVENTION

1. Field of the Invention

The present invention relates to a system and method for visually representing project metrics on 3-dimensional (3-D) product models, and more particularly, to a 3D model-based visual representation system and method utilizing the power of information technology.

2. Description of the Related Art

The construction industry requires effective control methods for numerous quantitative data relating to design, cost, schedule, and performance information. The construction field is where design, budget, and schedule goals are implemented, and thus is the major area where issues of cost and schedule control are determined. Exact definable tasks must be started, worked on, and completed within a definite time period by a specific resource. Project management is responsible for preparing the action plan and for establishing and maintaining the appropriate working relationships among members of the construction team. Actual conditions in the field environment often demand adjustments from time to time in either the sequencing or the phasing of the work to be accomplished.

Because of the dynamic site conditions, information is frequently out of date, incomplete, inaccurate, or unavailable when needed. To alleviate this inefficiency, various computer-based management systems are used in construction projects. They have been adapted and optimized quite effectively to meet the needs of their specific users throughout the life cycle of a project (Howard 1998). However, these tools do not use a common language to communicate among the project team members and require special knowledge on the part of the user to interpret the data. Suhanic (2001) states that inadequate control of a project is derived from a lack of systematic analysis of information gathered on a common base. Information is only valuable when raw data is organized into a meaningful form, presented them appropriately, and communicates in which it is produced (Shedroff 1999). Since all work environments and disciplines deal in one way or another with the products of construction, it is not unreasonable to expect some commonality across all work environments and disciplines that could be used as the primary vehicle for communication and integration. The discovery of this commonality is the principal challenge of this research.

Project managers are responsible for keeping overall track of project status and keeping operations running smoothly during construction. The project manager's most important responsibility, however, is to forecast the possible impact of problems on cost and schedule, and to prevent cost overrun or schedule delays. Project managers requires the most up-to-date design, schedule, cost, and performance data delivered in a timely and comprehensible manner in order to obtain an accurate picture of the project at any given point in time and to implement efficient control. But data is only raw material and converting this material into useful information is a matter of judiciously filtering, organizing, recording, and presenting it. Each member of a project team produces data and none of them is independent. Therefore, seamless integration of project data from the various disciplines is the foundation of efficient project control.

Project managers usually acquire these data in two different ways. One is through direct monitoring of the construction site, and the other is through summarized documents in various visual formats from those responsible for various aspects of a project.

Direct monitoring of the construction site gives to the project manager a more accurate picture than any second hand data can. However, it is dependent on the current visual status and doesn't reveal the impact of current circumstances on construction activity going forward. The ability to anticipate possible outcomes depends on the project manager's experience and subjectivity. Thus, in addition to direct monitoring and control, a project manager requires data from a range of field personnel.

The field staff collects data from the construction site, and these data are then organized, analyzed and delivered to the project manager in the data format particular to there area of expertise, be it drawings, spreadsheets, bar charts, or CPM. Nor do they capture the necessary interrelated information and their interdependencies in a legible manner for efficient project control. Such discrete and massive reports are produced throughout the life of a project and do not explicitly convey level of performance, problems, their causes, or their impact associated with physical construction situation. Consequently, the project manager needs vast amounts of time and effort to sort through, prioritize, and interpret these data. As the conduit and facilitator for all facets of the project, the project manager must understand the data as a coherent picture every moment throughout the project lifecycle.

A. Management Process During Construction

Meredith and Mantel stated in their publication, Project Management: Managerial Approach (1995) that construction management has three reiterative and overlapping phases; planning-monitoring-control. Monitoring and control, in particular, enable management to assess the current status of a project, predict project completion and take proper actions before schedule and cost deviation of any kind occur. In other words, management must constantly evaluate progress, compare progress to the plan, and take corrective action if progress does not match the plan.

Pierce further divides this three-step control process into the seven steps shown in FIG. 1. Referring to FIG. 1, Steps 1 and 2 are part of the planning stage, which is defined by Meredith and Mantel. Actual control action starts at step 3 (progress monitoring) and step 6 (corrective action) as a final step.

The typical stages of project control are defined as follows:

Monitoring

Monitoring involves collecting, recording, and reporting information concerning all aspects of project performance that the project manager or others in the organization wish to know (Meredith and Mantel 1995). Successful monitoring depends on an assessment of accurate measurement of progress and timely updates of the schedule.

TABLE 1

| Method | Content | Distinctiveness |
|---|---|---|
| Weighted | Spilt weighted cost into | Set up one or two objective milestones |
| Milestones | milestones | per month. Best suited to short-term |
| | | works. Most preferred but difficult on |
| | | framing and managing. |
| Fixed Formula by | Pro rata, i.e. spilt it into 0/100 | Widely used during early stage of |
| Task | or 50/50 | C/SCSC, but decreasing its usage |
| | | recently. Easy to understand. Should |
| | | be maintained under small |
| | | management units in order to utilize it |
| | | efficiently. |
| Percent Complete | Monthly actual progress is | Evaluated by subjective decisions. |
| Estimates | determined by evaluations of | Utilized under managerial guides in |
| | someone who take in charge | order to elevate objectivity. Due to ease |
| | | of managing, the use of the method is |
| | | increasing. The functions of maximum |
| | | ceiling amount and ‘check & balance’ |
| | | are required. |
| Percent Complete | Compare weighted milestones | Estimate subjective actual progress |
| & Milestone Gates | and subjective actual progress | within the limits of major milestones. |
| | | Excessive efforts of writing the |
| | | standard progress can be alleviated |
| | | when only weighted milestones |
| | | methods are applied. |
| Earned | Set up standards based upon | Most sophisticated method. Systematic |
| Standards | past actual results | management is required. Used under |
| | | certain restrictions on repetitive work or |
| | | routine production work. |
| Apportioned | Evaluate the work with closely | Drive no big errors in regular |
| Relationships to | correlative works | differences but can drive big errors in |
| Discrete Work | | cost differences. |
| Level of Effort | Evaluate progress by time | Evaluated by planned progress, not by |
| | rather than by work | physical progress. Not a recommended |
| | accomplished | method |

Progress Measurement

This step is frequently called progress measurement or updating the schedule. It is primarily a process of collecting detailed data on the work, then processing it in a computer or manual system to arrive at an accurate representation of the current job status (Pierce 1998).

Among the many ways to measure progress, weighted milestone or fixed formula methods are simple and less prone, but measurement does not continuous status of a project. Measuring progress by comparing remaining inventory of material to the actual amount of material that has been used during construction can result in serious error. Measuring progress in percentiles, which is used in most construction fields, heavily relies on the experience and knowledge of the project manager. Thus, the measurement lacks objectivity and is ineffective at presenting progress due to its abstract nature (See, Table 1).

Process Information

A computer is usually used to manipulate data collected during the monitoring phase of a project. The data is set up so that it can be compared to original plans. This processed information enables the project manager to determine if the project is deviating from the planned sequence or rate of progress, and whether that deviation is significant enough to warrant action in the control phase (Pierce 1998).

Control

Control is action taken to alter trends inferred from monitoring (Ninos and Wearne 1984). The final element in the construction management cycle is the authority to order changes. The project's schedule, cost, and performance are compared with that of the plan. Action is taken if reality and the plan differ enough that the controller (manager) wishes to decrease the difference. In essence, control is the act of reducing the gap between plan and reality (Meredith and Mantel 1995).

Comparing Progress to Goals

The actual progress on the job is compared to the progress planned in the original plan.

Taking Corrective Action

The project manager corrects any deviations based on all of the available information.

Constant management activities, monitoring and control are distinctive but sequential. In a very dynamic and unpredictable construction environment, field information, collected from monitoring, should be appropriately summarized and instantly delivered to the person, who has the authority to control and take immediate action.

FIG. 2 shows the role of the typical members of a project management team according to the control process during construction.

Raw data; concerning work progress, costs, resource inventory, etc, are collected by the field specialists such as field scheduler, cost engineer, architect and superintendent. The collected information is then organized in various discipline-specific management systems—scheduling, accounting, or CAD system-, and reported to the project managers. With summarized reports in various and discrete formats from the scheduler, cost engineer, or architect, Project manager must interpret them based on his experience and knowledge, often assisted by consultations and discussions with related specialists or other personnel. For the last, collective action is implemented as result of the project manager's order.

In order to have effective management, various computer-aided applications are used in project control during construction. In the following section, the definition and the current state of project control systems will be explored.

B. Project Control System

Concept

According to Barrie and Paulson (1992), a control system quantitatively measures actual performance against the plan and acts as an early warning system to diagnose major problems while management action can still be effective in achieving. On the other hand, Mantel (Mantel 2001) states that the purpose of a monitoring system is to increase the speed and effectiveness of gathering, organizing and reporting data while the control system is to act on that data. Meredith and Mantel (Meredith and Mantel 1995) assert that schedule and cost information should be handled by the scheduling system and accounting system respectively, and that monitoring and control systems should also be treated in a separate manner. As for Suhanic (2001) and Mueller (1986), they considered the system for monitoring and control to be one, but they believe schedule and cost should each be handled by a different system. Through the development of the Pollalis system, Pollalis described schedule and cost as one integrated system. FIG. 3 shows the concept of control system.

However, for the purpose of this research, it is reasonable that the distinction between monitoring and control systems be identified not by system functionality and capability but by actual user responsibility and authority. For example, most current scheduling systems, such as Primavera P3 or Microsoft Project, which are called planning, monitoring, or control systems because they can be used for different purpose at the different project phases, are only used by scheduling professionals. Thus, they can not be considered as a control tools. Control tools must be directly accessible to the project controller who has the authority to make decisions on the project. Here are the objectives of the control system defined by Barrie and Paulson:
To provide an organized and efficient means of measuring, collecting, verifying, and quantifying data reflecting the progress and status of operations on the project with respect to schedule, cost, resources, procurement, and quality.
To provide an organized, accurate, and efficient means of converting the data from the operations into information. The information system should be realistic and should recognize (a) the means of processing the information, (b) the skills available, and (c) the value of the information compared with the cost of obtaining it.
To identify and isolate the most important and critical information for a given situation, and to get it to the correct managers and supervisors that is, those in a position to make best use of it.
To deliver the information to them in time for consideration and decision making so that, if necessary, corrective action may be taken on those operations that generated the data in the first place.
To report the correct and necessary information in a form which can best be interpreted by management, and at a level of detail most appropriate for the individual managers or supervisors who will be using it.

(Barrie and Paulson 1992, 184-185)
The Current Status

However, project management systems, which are frequently called control systems, are very function-oriented and discipline-specific. The functions and user interfaces of these systems do not distinguish between planning and control or the needs and disciplines of the users.

As illustrated in FIG. 4, one system is used scheduling and another for cost from the planning stage to the end of construction. Primavera, a project scheduling system commonly called a project management system, offers a variety of sophisticated functions needed for scheduling, such as scheduling, cost & resource management, document management, and team collaboration. However, due to its complexity and function-oriented interface, in practice it is rarely used for anything other than scheduling by professional schedulers. For instance, the actual data from the jobsite during construction is input and analyzed in the system by the field scheduler, but it is not delivered electronically to the superintendent or project manager—the project controller—, who are the project controllers, but in the form of a summarized hardcopy.

FIG. 5 shows a visual interface according to the functions of Primavera, a system most widely used for construction project management. Although it offers scheduling, cost, resource, contingency management functions as well as reporting and communication functions, it is an aggregate of many different systems into one package rather than one system having many functions, and thus may lack full integration among the multiple functions. The reason is still the fact that visual interfaces are distinctive due to each separate individual function, and there is a constraint that only professionals with specialized knowledge in each of the individual areas can handle the interfaces.

C. Project Controller

Responsibility

Depending upon the size and complexity of the project, team organization can be modified to most effectively delegate responsibilities and duties. Many more parties are usually involved in the construction stage, specially contractors, subcontractors, material suppliers and other public authorities. In this situation, according to Ceran and Dorman (1995), building quality is achieved not through the management of quality but by the quality of management. The quality of management as it relates to the project manager, who has ultimate control and decision-making authority for the project, is the single most important factor in project success. Ceran and Dorman summarize the responsibilities of the project manager as follows:
Quality management
Project acquisition
Project work plan
Project controls
Change orders
Financial goals
Client relationship
Managing subcontractors
Staff management and development

Saram and Ahmed (2001), on the other hand, divide the roles of project manager into three categories: planning, organizing and controlling.
Planning is subdivided into
Identifying
Communicating
Analyzing/planning/scheduling
Organizing is subdivided into
Leading
Facilitating
Distributing information and records
Controlling is subdivided into
Monitoring
Analyzing
Controlling/correcting/maintaining
Recording/communicating

Upon start of construction, the full participation of the project manager is required. As controller of the project, he or she must collect updated data through continuous communication with all project participants. Project manager must interpret them and act based on such data. The project manager must accurately judge of circumstances, and predict the future based on the information, and clearly communicate changes in project conditions as well as their impact on schedule and cost to the top management and clients.

Project control does not rely on documentation alone. In many cases, project managers control various issues by relying on their experience. For the purpose of this study, however, the control process is defined as the acquisition and management of diverse project data that can be quantified or visualized and is used as the basis for decision-making on the part of the project manager.

Control Process

The control process has been defined as a repetitive process of data collection, identification, analysis, control, and recording. Saram and Ahmed (2001) excluded data collection from the project manager's responsibilities. However, without data collection or a comparison of planned and actual performance, there would be no basis for control decisions. Therefore, data collection was included as the first stage of project control. And data identification, the second, since dynamic identification of information, rather than of data already determined in the planning stage, is the most important part of the control process. The specifics of the control process are depicted in FIG. 6.

Collecting

Data reflecting the status and progress of a project come from numerous sources. Accuracy, timelines, and completeness of these data are foundation of a project's success (Barrie and Paulson 1992). Providing accurate explanation of the actual project condition by gathering and compiling this raw data from other professionals or different subsystems and by organizing them for predictive purposes are the first part of a project managers responsibility during construction. Although the authority for final decisions in most decision-making processes is reserved for the project manager, most issues brought up during construction are related to the many disciplines (Ninos and Wearne 1984). Therefore, distributing such information to the project team is another important responsibility of the project manager.

It is not easy for project managers to manage vast amounts of raw data from many disciplines in a complex and dynamic situation without a computer management system. Barrie and Paulson (1992) mention that if the more routine aspects of planning and control are organized into an accurate and effective information system, management is an even better able to cope with the unexpected events that inevitably occur.

Currently, there is no appropriate system that can effectively collect and compile such raw data and comprehensively and systematically deliver it to the project manager. Partial communication and document management can be performed using a web-based project extranet, but as yet, there is no way to integrate large quantities of data produced in diverse formats.

Identifying

Even though raw information can be collected from the job site, if the necessary information cannot be identified at the right time, the time period within which to control critical issues may be compromised. Cost increases and time losses could be incurred due to management's failure to notice potential problems. Thus, the project manager must always monitor collected data and identify issues requiring control such as following:
the timeliness of all work carried out
the budget and cost on all activities
resource requirements
delivery, storage, and handling of material
strategic activities and potential delays (Saram and Ahmed 2001)
design changes
differences/conflicts/confusion among participants (Saram and Ahmed 2001)
performance of each section and department of the project

It is important to monitor their progress regularly, but the project manager reviewing the vast amount of information constantly produced, and then making control decisions for variance or conflicts is both impossible and inefficient. Thus, exception-based management is required. Barrie and Paulson (1992) use the term “management by exception” which is defined as identifying only those operations with variances or other parameters exceeding certain predefined limits. To enable “management by exception,” an integrated management system is necessary to collect all the information, analyzes impact within the relationship of each raw data, and use the results to express data in a way that is easy to understand parts that go beyond certain level of tolerance determined by the project manager.

Analyzing

The project manager must interpret all contractual commitments and documents and analyze the project performance in terms of time, cost and quality, detecting variances, and anticipating their effect on time and resource constraints. Project managers are overwhelmed with excessive detail (e.g., CPM chart), which requires a lot of effort and time to analyze, or alternatively, important issues are minimized with over simplified data (e.g., Earned value chart) which are unable to give full explanations on the cause and impact of variances. As a result, it has become a common practice for project managers to rely more on their past experience than on analysis of data for their decision making.

Controlling

Project control, from a macroscopic sense, is a comprehensive term incorporating all responsibilities of the project manager throughout a project and is subdivided into the stages: monitoring, analyzing, controlling, and recording. In this section, control refers to the direct actions taken by the project manager to minimize variances or resolve conflicts discovered through monitoring. Specifically, the project manager is responsible for control over the following:
conflict resolution
change orders
improving/altering/eliminating activities and considering alternatives that might more efficiently meet the project objectives
coordinating and rescheduling the sequence of onsite work
coordinating offsite fabrications and their delivery with the onsite work
coordinating the purchases, delivery, and storage of material
agreeing on detail methods of construction
proposing remedial work methods and programs for executing them in the event of damage or defects
submitting material for approval by the engineer
facilitating payments to own employees and subcontractors
optimizing resource allocation and utilization

(Saram and Ahmed 2001)

Recording

According to Saram and Ahmed (2001), diverse information should be kept, since recording is the responsibility of the project manager. As document (or information) management systems, web-based extranet services are most often used, but they only enable the posting and reading of various messages, drawings, and files. Data recording (or storing) does not refer to simply collecting various data created in many places into one place, but refers to recording through full integration of such data sets sorted according to relevance in order to create one complete form of project information. Currently, however, there is no way of integrating and connecting updated data from many parties. In other words, all the data are stored according to discipline rather than level of importance (drawings by drawings, and the same for cost data, schedule, resource, etc).

Interaction

Interaction between the field management team and the project manager during construction is the most decisive factor for project success. Table 2 shows a summary of responsibilities and needs of the project and field management team toward each other.

TABLE 2

| Description of Role | Definition of Success | |
|---|---|---|
| | Success for Project Manager | Success for field supervision team |
| | Under budget and time | Under budget and under schedule |
| | Document control | Resolve conflict between trades |
| | Monitor on time | Quality workmanship |
| | Team coordinator | Labor harmony |
| | No contractual claims | No change orders |
| | Items delivered on time | Fast turnover |
| | No field changes | No down time |
| | No open items | Client, architect & engineer satisfaction |
| Role of Project Manager | | Field needs from PM |
| Monitor schedule | | Answers in timely fashion |
| Process change order | | Material ordered in time to meet |
| Keep owner's satisfaction | | schedule |
| Coordinate with field | | Expedite/distribute info from all parties |
| Think ahead | | to field |
| Defines roles and | | Up to date requisitions/payments |
| responsibilities of staff | | Be familiar with site & field conditions |
| Requisition process | | Resolve owner/engineer/architect |
| Anticipate schedule and | | conflicts |
| cost problems | | Up to date logs/reporting |
| | | Open line of communications |
| Role of Field supervision team | PM needs from field team | |
| Monitor trade/quality | No field changes without approval | |
| Schedule/sequence | Build per plan | |
| Coordination of trades | Safety | |
| Look ahead | Communicate daily with PM | |
| Safety | Meet date commitments | |
| RFI | Understand contract | |
| Update plans | Relayed information on schedule | |
| Resolve field condition | Daily reports on time | |
| conflicts | Monitor spending (cost awareness) | |
| Controlled inspection | Be aware of owner priorities | |
| Daily reports | Coordinate and track all deliveries | |
| | Maintain drawings | |

Needs

Saram and Ahmed (2001) classify the project manager's activities by importance and by time consumption, based on a survey of project managers (See. Table 3).

TABLE 3

| | | Importance | | | | | Time Consumed | | | |
|---|---|---|---|---|---|---|---|---|---|---|
| | | High | Mid | Low | N/A | Number | High | Mid | Low | Number |
| Number | Construction coordination activity | (%) | (%) | (%) | (%) | responses | (%) | (%) | (%) | responses |
| 1 | Conducting regular meetings and project reviews | 64 | 27 | 9 | 0 | 33 | 48 | 48 | 3 | 29 |
| 2 | Analyzing the project performance on time, cost | 63 | 31 | 6 | 0 | 32 | 48 | 34 | 17 | 29 |
| | and quality. Detecting variances from the | | | | | | | | | |
| | schedule requirements and dealing with their | | | | | | | | | |
| | effects considering time and resource constraints | | | | | | | | | |
| 3 | Identifying/gathering information in requirements | 45 | 42 | 12 | 0 | 33 | 48 | 28 | 24 | 29 |
| | of all parties and consolidate for use in planning | | | | | | | | | |
| 4 | Interpreting all contractual commitments and | 64 | 27 | 9 | 0 | 33 | 45 | 45 | 10 | 29 |
| | documents | | | | | | | | | |
| 5 | Resolving differences conflicts confusions among | 42 | 55 | 3 | 0 | 33 | 45 | 28 | 28 | 29 |
| | participants | | | | | | | | | |
| 6 | Liaison with the Client and the Consultants | 76 | 18 | 6 | 0 | 33 | 41 | 45 | 14 | 29 |
| 7 | Identifying or gathering information on defects, | 67 | 24 | 9 | 0 | 33 | 34 | 48 | 17 | 29 |
| | deficiencies, ambiguities and conflicts in drawings | | | | | | | | | |
| | and specifications and having them resolved | | | | | | | | | |
| 8 | Translating documents into task assignments | 41 | 41 | 19 | 0 | 32 | 32 | 43 | 25 | 28 |
| 9 | Maintaining records of work done outside the | 70 | 27 | 3 | 0 | 33 | 31 | 59 | 10 | 29 |
| | contract, variations, dayworks and all facts/data | | | | | | | | | |
| | necessary to support claims | | | | | | | | | |
| 10 | Communication project progress, | 48 | 42 | 9 | 0 | 33 | 31 | 52 | 17 | 29 |
| | financial/commercial status, plans, schedules, | | | | | | | | | |
| | changes, documents, etc., to all relevant | | | | | | | | | |
| | participants | | | | | | | | | |

The activities which require more efficient methods of project control for the project manager are summarized as follows.
communication/meeting
analyzing performance
identifying variances
interpretation of information maintaining records

In order for project managers to perform these very time-consuming activities more efficiently, two hypothetical strategies are recommended:
a) Single point of control
b) Control support system

Single Point of Responsibilities for Project Control

Ninos and Wearne (1984) argue that the controller should be a single individual called project director in construction projects. The problem is that the authority to control a project is fragmented. Decisions are rarely made by an individual entity because most issues that arise during construction are related to and have an effect on many disciplines. In practice, the difficulty lies in achieving control of a project as a whole when decisions on objectives, financing, planning, design and construction are divided among the owner, engineers, architects, contractors and sub-contractors. The project manager must listen to various parties, perform duties as coordinator, and attend frequent meetings. Consequently, a complicated control process unnecessarily consumes effort and time as even the simplest issues demand authority of the various parties. FIG. 7 is a typical example of a control process during construction with MIT as building owner and Turner Construction with responsibility as construction management and contractor. A complicated process of review by many parties is required to obtain permission for even one change.

If one decision maker had all the decision-making authority, the process of review and authorization on issues could be simplified, drastically reducing the time spent on generating change orders. Also, since all information would be directed to one person, confusion or omission in information management and exchange can be minimized. In addition, should a conflict arise, no time is wasted determining who is responsible since there is a fixed decision-maker. This saves a lot of effort and time when issues need to be resolved immediately. However, the idea of a single “project director” is unrealistic in actuality for the following reasons:
All entities participating in a project share a certain amount of risk. This makes it difficult for them to accept an arbitrary decision by a project director who has total authority on relevant issues. The project director also must shoulder the enormous responsibility for all decisions.
The person with total authority is bound to represent the entity that bears the most risk, and in most projects, the client or the contractor under GMP contract (Guaranteed Maximum Price) becomes the responsible party. It is almost impossible for such a project director to represent the position of all parties and be completely neutral.

Therefore, the hypothetical project director has very little chance of being realized in actual practice. However, if a truly neutral, virtual project director, independent of any entity, existed, the issue of inefficient and time-consuming project controls could be resolved. In the following section, the conditions for a project control system as a virtual project director will be investigated.

Control System as a Virtual Project Director

The difficulties of project managers can be alleviated through a control system created to meet the demands of the project manager. By communicating through visual interface, which can be shared and understood by all parties, the project manager can save a great deal of time. Such a system should have an environment enabling all participants to share information, in order not to favor one or another party. However, the level of access permission would have to be controlled, depending on the role of the user. For instance, the scheduler could update and modify schedules under his/her responsibility but would not have access authority to modify other areas. The project manager could access all information and can send requests electronically to relevant professionals to modify information. In such a system, all information would be transparent and the person in charge would be clearly known. If the information required by the project manager for data analysis, identification, and interpretation, could be provided intuitively with an optimum level of detail in real-time among the diverse systems of the field management team, architect, and engineer and control system of the project manager, it would greatly reduce the time and effort required for the control process. What a project manager needs is not a complex system for inputting and calculating, as is the case with currently used control systems. The project manager desperately needs a monitoring and control interface much like the dashboard or instrument panel of a car, through which he/she can comprehensively and intuitively read the information transferred from each party and professional, make judgments, and provide feedback. This control system could perform the role of “project director,” as presented by Ninos and Wearne but as a virtual, truly neutral project manager acceptable to all project participants.

D. Control Methods

Various types of graphical representation of data are used for monitoring and controlling a project as the prime means of tracking, communication and decision making. Scheduling methods have been the principal vehicles of project control in spite of their visual limitations and complexity. Scheduling integrates the separate efforts of team members by coordinating each individual's work within an interdependent time sequence (Degoff and Friedman 1985). A schedule is a time-based graphic representation of resources and time constraints. It should include activity logic, a resource plan, and the budget and cost for each unique project context. As a main communication platform, scheduling information must be expressed in a language understood and used by all participants from planning to the end of construction (Kerzner 2001).

Traditional Methods

Evolution

Since the invention of the simple Gantt chart in 1915, various scheduling techniques have been introduced to satisfy the demands of different industries. The methods mentioned in FIG. 8 have evolved in terms of information capability and functionality, but have not address a graphical efficiency or specific user needs in construction projects. In other words, as scheduling techniques have evolved in terms of functionality, they have stalled in terms of their graphic manifestation.

Despite new methods that have been introduced, the Gantt chart and critical path method are the most prevalent visual interfaces in the existing scheduling and management applications. The Gantt chart is still the main communication interface used in construction projects due to its simple visual representation. A logical network is the main planning method for schedulers; however its visual clarity is minimal. Table 4 shows evolution of scheduling methods.

TABLE 4

| Model | Method | Use | Benefits | Drawbacks | Year |
|---|---|---|---|---|---|
| Deterministic | Gantt | Presentation | Easy to read | Weak information | 1917 |
| Model | | & communication | Hierarchy of information | | |
| | CPM (Critical | Planning & control | Critical Path | Limited and | 1958 |
| | Path Method) | | | complex visual | |
| Probabilistic | PERT | Statistical | Probabilistic times | representation | 1958 |
| Model | (Program | | calculate probability of | | |
| | Evaluation and | | completing the project | | |
| | Review | | (optimistic, pessimistic, | | |
| | Technique) | | expected duration) | | |
| | PDM | Planning & control | Criticality | | 1964 |
| | (Precedence | | Splitting | | |
| | Diagram | | Warnings | | |
| | Method) | | Lag | | |
| | GERT | Planning | network modeling | Too many visual | 1966 |
| | (graphical | | technique for complex | elements to | |
| | evaluation and | | situation | interpret | |
| | review | | allow project planning | | |
| | technique) | | under “what if” conditions | | |
| | QGERT | | management of multiple | | 1977 |
| | | | project & team | | |

Milestone Chart

Milestone charts are most commonly used by senior management to focus on the “big picture” Selected customers also like to review performance on selected milestones as they monitor a project (Fleming 1988). Milestone charts typically use a “triangle” to illustrate the plan, and a “diamond” to reflect changes to the original baseline plan. The “diamond” indicates any change to a baseline, whether earlier or later than was originally planned.

Gantt Chart

The Gantt chart has been the main scheduling, communication, and control interface since it was developed due to its simple visual representation. Start and finish time and duration of planned activities or tasks are presented in a spreadsheet format as colored bars by a horizontal time scale. As progress is made in accomplishing the tasks, the bars are filled in with a second color to indicate this. When the horizontal progress lines are compared to a vertical time line, one can immediately visualize whether the tasks are on, ahead, or behind schedule (Fleming 1988).

Drawback of Gantt Chart

However, this method has two limitations as the main control method in a construction project. Firstly, it only shows time-related information by scaleable bars. Reliability as a control system is very low because it does not show the relational impact between time, cost, resource, and performance. Even if the bar chart shows the progress of an activity is on schedule, it does not mean that the activity is going well since cost and resource information are not included.

For example, Activities A and B in Table 6 are presented as equally successful according to the Gantt chart because the actual percentage completed is the same as the planned percentage completed. However, activity B spent 20 percent more than the planned budget. If the 20 percent cost overrun is a result of resource usage, this activity will have a resource shortage soon. If management doesn't recognize this problem in time, it may cause a schedule delay due to the need for an additional resource delivery at the last moment.

TABLE 6

| | Planned % | Actual % | Budgeted cost of | Actual cost of |
|---|---|---|---|---|
| Activity | completed | completed | work performed | work performed |
| Activity A | 70% | 70% | 50% | 50% |
| Activity B | 70% | 70% | 50% | 70% |

Secondly, information presented in a conventional spreadsheet format, which lays out data in columns and rows, is only useful to show a relatively small amount of data, such as weekly meetings or a summary schedule. A control schedule usually contains hundreds of bars in row. Such a vast amount of data presented in separate pages whether on paper or screen cannot possibly convey a clear or comprehensible picture of a project.

Network Diagrams

Another technique used to plan and schedule a project is network scheduling, sometimes referred to as logic diagramming. Network schedules simulate a project by taking the planned tasks or events and tying them together with constraint or dependency lines. Such constraints prevent later tasks or events from occurring until earlier ones are finished (Fleming 1988). FIG. 9 shows Network Scheduling Types (Fleming 1988).

Critical Path Method (CPM)

In 1957, Dupont developed a project management method designed to address the challenge of shutting down plants for maintenance and then restarting them once the maintenance had been completed. The critical path method (CPM) is a network analysis method whereby the overall project duration can be estimated based on the duration of each of the activities and their schedule dependencies. Activities are depicted as nodes on the network and events that signify the beginning or end of an activity are depicted as a line between the nodes. FIG. 10 is an example of a CPM network diagram.

CPM was developed for complex but fairly routine projects with minimal uncertainty in terms of project completion time. For less routine projects there is more uncertainty in the completion times, and this uncertainty limits the usefulness of the deterministic CPM model. Even though CPM is most commonly used at the lower levels in a cost/schedule control system in construction projects, it is not an adequate control method for the extremely uncertain construction field.

Program Evaluation and Review Technique (PERT)

The Program Evaluation and Review Technique (PERT) charts depict task, duration, and dependency information (Modell 1996). A PERT chart presents a graphic illustration of a project as a network diagram consisting of numbered nodes (either circles or rectangles) representing events, or milestones in the project linked by labeled vectors (directional lines) representing tasks in the project. The direction of the arrows on the lines indicates the sequence of tasks. PERT was found to be mathematically accurate, and computers quickly accepted the logic input without difficulty. But the intended users, conservative, “old guard” management, had trouble digesting the logic of the original PERT displays. FIG. 11 is an example of a PERT chart.

Precedence Diagram Method (PDM)

In about 1963, another approach to network scheduling was introduced, the Precedence Diagram Method (PDM). In this method, the focus is also on tasks, which are displayed as nodes (boxes) also linked together with dependency lines. This approach is the most popular today, because it allows project managers considerable flexibility in the re-planning of a project as circumstances dictate. This is critical since the re-planning of a project is perhaps of greater importance to those who schedule than is the preparation of the original plan (Fleming 1988).

Benefits of Network Diagram Methods
CPM pinpoints the activities whose completion times are responsible for determining the overall project duration. With these critical operations clearly identified, major attention can be directed toward keeping them on schedule in order to meet the planned completion date (Suhanic 2001).
They are of considerable value in isolating alternate approaches, the “what-if”, as progress goes poorly, and other ways must be found to accomplish a project (Fleming 1988).
Network diagrams give a quantitative evaluation of the float that each activity has. Activities with float can be started and finished after the earliest dates, or they may be shifted in time to smooth labor or equipment requirements (Suhanic 2001).

Drawbacks of Networked Diagram Method
Even though the calculation of the critical path is precise and systematic, the concept of it is unrealistic. The critical path depends on predictable time duration of the tasks and their precedence. However, the duration of each task is so variable and depends on a number of factors (Pollalis 1993).
Changes in the amount of resources or productivity will change the duration, possibly precedence and, consequently, the critical path. The network diagrams cannot display any of those changes.
Recalculation necessitated by the new data may result in a completely different critical path than before causing serious consequences (Pollalis 1993).
The result is a schedule which frequently does not reflect reality, and certainly not the project manager's reality (Pierce 1998).

Visual Representation of the Traditional Methods

In terms of visual representation, the Gantt chart does not provide all the information necessary for control, due to limitations in information representation. Therefore, this is not an adequate tool for identifying the reasons for cost or schedule issues or their impact.

George Suhanic (2001) noted that “Although both CPM and PERT are logically elegant and analytically powerful tools, they are visual disaster.” CPM is a method well-known to schedulers and most project managers at construction sites, but it is not fully understood. Even if it were fully understood, it has only limited usage in calculating simple critical paths and floats. A critical path calculated only with time constraints neglects other constraints, such as spatial conflicts, resource shortages, manpower unavailability, which occurs in actual construction. This is why it is almost never used by project managers for project control.

Even though the newer interfaces provide more data and better functionality, they are overly complex and poorly reflect the true nature of construction project. Quantity of data is substituted for quality of data. Thus users become overwhelmed and give up using it.

Integrated Control Methods

Earned Value Analysis

The concept of earned value analysis was actually developed as early as the 1800s when it became desirable to measure performance on the factory floor (Wilkens 1999). The idea was revived in the early 1960s when the U.S. Department of Defense attempted to employ the resource-added PERT. As already noted above, PERT was ignored by industry, and failed due to ineffective implementation by the government and lack of computer software technology. However, overlooked aspect of PERT/Cost was a new concept called “earned value” management. It introduced the idea of planning a project in sufficient detail to precisely measure performance along the way, and included the ability to obtain reliable estimates of total costs, to calculate the total cost of completing various programs (Fleming 1988).

Components

The greatest benefit of earned value analysis is that it provides an accurate measure of current progress, and also shows future impact using a uniform unit of measure, a consistent methodology and a basis for cost performance analysis. Components of the earned value method can be divided into two indicators: actual performance and forecast. FIG. 12 shows components of earned value analysis.

Actual Performance

It is necessary to first discuss how a project manager can use components of earned value analysis in construction. The first thing to know as a project manager is the percent of project completion. Earned value analysis provides clear answer to the following questions:
How complete is the project?
Assuming a project consists of Activities; A, B, C and D, if the first two of them are completed, does it mean 50% of the work completed?
What is each activity worth? How is one to equate it with the other activities?
Does 10% of Activity “A” has same value as 10% of Activity “B”?

Earned value analysis provides an easy understanding of the different nature or measurement of data to a project manager by uniformed manners. It combines cubic yards of concrete with square feet of forms, and tons of rebar, etc (Wilkens 1999).

For example, a concrete subcontractor reports to the project manager that he/she has finished 50% of his work, because:
50% of the concrete has been used
50% of the planned area on floor plan has been finished
50% of the budgeted labor hours are spent

Are any of these three measurements actual indicators that 50 percent of the work has been completed? Using earned value analysis, the concrete subcontractor would measure the total quantity of concrete installed and compare that against the budgeted quantity to determine the percent completed. Similarly, he/she would compare the installed quantity against the quantity planned to be installed up this point in time to determine if he/she is ahead or behind schedule.

The three major components of earned value for indicating actual status are:
BCWS: budgeted cost of work scheduled, BCWS=planned % completed×BAC (budgeted at completion)
BCWP: budgeted cost of work performed, BCWP=actual % completed×BAC
ACWP: actual cost of work performed

By integrating cost and schedule variances, the control system can provide the basis for monitoring work performance.
CPI: cost performance index
BCWP/ACWP=budgeted cost of work performed/actual cost of work performed
CPI=1.0, perfect performance.
If CPI>1.0, exceptional performance
If CPI<1.0, poor performance
SPI: schedule performance index
BCWP/BCWS=Budgeted cost of work performed/Budgeted cost of work scheduled
SPI=1.0, perfect performance
If SPI>1.0, exceptional performance
If SPI<1.0, poor performance

Forecasting

Earned Value is a key forecasting tool for managing a project. On the other hand, the estimate at completion (EAC) is the best estimate of the total cost at the completion of the project (Kerzner 2001).

The Estimate at Completion (EAC)

The EAC, the final forecast of the cost of a project or a task, is a number of great interest each update cycle. It indicates where the project cost is heading. The ability to calculate an EAC is one of the great benefits of earned value analysis (Wilkens 1999). FIG. 13 shows an example of forecasting the estimate at completion.
EAC: estimate at completion, EAC=ACWP+ETC (estimate to complete)

In FIG. 13, the actual cost is greater than the planned cost for the completed work (ACWP>BCWP). If performance continues at the same trend, at completion the actual cost (EAC) will far exceed the budget (BAC) (Wilkens 1999).

Earned Value Management System of Samsung Construction

In the case of Samsung Construction (Table 7), the earned value management system has been applied in order to integrate the management of different schedules and costs, enabling a consistent management of information. The display of performance according to Schedule Performance Index (SPI) and Cost Performance Index (CPI) using different colors, also allows users to identify the project performance intuitively. Blue indicates the most desirable progress in schedule and cost, followed by sky blue, yellow, purple, and red in descending order of desirability.

TABLE 7

| SPI | CPI | Judging | Contents of analysis |
|---|---|---|---|
| Over 95% | Less than 100% | Blue | Normal process on the progress |
| | | | Normal cost over budget |
| | 100%˜105% | Sky | Normal process on the progress |
| | | blue | Slight cost over budget |
| | Over 105% | Yellow | Normal process on the progress |
| | | | Excessive cost over budget |
| 90%˜95% | Less than 100% | Sky | Slight delays on progress |
| | | blue | Slight cost over budget |
| | 100%˜105% | Yellow | Slight delays on progress |
| | | | Excessive cost over budget |
| | Over 105% | Purple | Slight delays on progress |
| | | | Excessive cost over budget |
| Less | Less than 100% | Yellow | Excessive delays on progress |
| than 90% | | | Normal cost over budget |
| | 100%˜105% | Purple | Excessive delays on progress |
| | | | Slight cost over budget |
| | Over 105% | Red | Excessive delays on progress |
| | | | Excessive cost over budget |

E. Control Information for Project Manager

The information necessary for project control should be filtered and analyzed data, rather than raw data from the field. The project manager does not produce information, but must understand the actual conditions of the project and make forecasting, based on the diverse information produced by the various parties in order to anticipate and circumvent problems. The information that can help the project manager is data showing actual conditions, pointing out potential issues, and predicting future events.

Current Status

Currently, project conditions are evaluated by comparing actual field performance with the planned performance. The information to be identified here includes the following elements:

Physical Location of and Responsible Entity for the Task

Current scheduling interfaces are code-based, and demand a great deal of time and effort for the project manager to identify the physical location and responsible entities for activities outside the jobsite. Such information should be displayed in an easy manner.

Productivity

As quantity-adjusted budget, productivity is important as the trending index that identifies performance of each entity assigned to tasks, to manage each sub-contractor.
Productivity=QAB (quantity-adjusted budget) person-hours/actual person-hours
Productivity=% physical completion/% QAB person-hours used

Performance: Cost/Schedule Performance Index

As shown in Table 7, the CPI and SPI, which are methods of earned value for Samsung Construction, should show the relationship between the two in an integrated manner. If performance falls below the level of tolerance defined by the user, it should clearly display this to allow for immediate action.

Criticality

CPM-based criticality is useful for indicating the total duration of a project and the level of potential risk when planning the construction schedule. However, once construction begins, this information has no significance for project management teams that must meet fixed deadlines, and criticality due to various constraints. In the actual field, such as spatial conflicts, material deliveries, availability of equipments, becomes more important. In many cases, such criticality is manually detected by the field management team rather than generated by the scheduling system. This information must also be displayed in the control system.

Float

Float does not affect total project duration, but it is a time frame which allows delays at the outset or upon completion of the work. Float clearly shows what work is important and how much extra time exist, and is therefore an important indicator for control.

Deviation

Although it is important to identify each of the deviations, it is more important for the project manager to understand the reasons for and characteristics of such deviations.

Reason for Deviation

Sriprasert and Dawood (2003) divided reasons for deviation into the following five categories:
accident
weather
equipment
material
labor

For instance, if there is a schedule delay, it is important to know whether it is the result of a productivity issue, conflict with other activities, a resource shortage, a weather issue, etc. Unless the cause of the delay is identified, the problem cannot be resolved.

Delay

There are various types of delays and these should be specified be along with the length of delay to help the project manager act upon them.
excusable delay vs nonexcusable delays
compensable vs noncompesable delays

critical vs noncritical delays

TABLE 8

| Excusable Delay | Non-excusable Delay |
|---|---|
| Design problems | Unavailability of personnel |
| Employer-Initiated changes | Subcontractor failures |
| Unanticipated weather | Improperly installed work |
| Labor disputes | |
| Fire | |
| Unusual delay in deliveries | |
| Unavoidable casualties | |
| Acts of god | |

Forecast

The estimate at completion (EAC) is the most valuable forecasting information for determining the total cost at the completion of the task (or the project). By giving the project manager this information when a task or project is in progress, he/she has an opportunity to plan required measures before an actual cost overrun occurs.
EAC: estimate at completion
ETC estimate to completion

CPI/SPI Indices

The cost and schedule performance index is most often used for trend analysis. The usefulness of trend analysis is that it provides an early warning system so that corrective action can be taken as soon as there are signs of unfavorable trends (Kerzner 2001).

However, as FIG. 14 shows, CPI/SPI indices depict a summary trend of the entire project, and therefore it is impossible to identify the source of the trend. Thus, while this tool performs the important but limited function of alerting management that an unfavorable trend is developing, it is unable to analyze the causes of such a trend or explain what impact it will have in the future.

F. Information Requirement for Project Control

As described so far, the control information based on earned value analysis provides concise and accurate picture to help the project manager's monitoring and controlling function. The control information that must be displayed by the control system for the project manager can be organized as shown in Table 9.

TABLE 9

| | |
|---|---|
| Item | Description |

Basic Information

| | |
|---|---|
| Activity | Description of activities |
| Responsibility | List of entities assigned to the activities |
| Criticality | Type of criticality |
| Float | Amount of float |
| Percentage of cost | Cost distribution of each item based on the |
| distribution | percentage of total project cost |

Actual performance

| | |
|---|---|
| % Complete | Percent of work performed |
| Productivity | % physical completion/% QAB (quantity-adjusted |
| | budget) person-hours used |
| CPI | Value of Cost Performance Index |
| SPI | Value of Schedule Performance Index |
| Schedule deviation | Causes of schedule deviation |
| Delay | Types of delay |
| Cost deviation | Causes of cost overrun |

Forecasting information

| | |
|---|---|
| EAC | Estimate at completion |
| ETC | Estimate to completion |

G. Data Visualization in Construction

Construction project produces massive amount of data in different forms through complex processes. According to Kerzner's (2001), between thirty and forty different visual methods are currently being used to represent construction information throughout the lifecycle of a project. All graphics and charts in construction project consider four sets of data; time, cost, resource, and performance because all project participants must have an accurate picture of the relations between them.

Types of Visual Representation in Construction

Sriprasert and Dawood (2003) described graphics in construction in six different types of visual representation in construction:
a) Worksheet: easy to prepare and generally used for work-face instruction or method statement
b) Bar chart or Gantt chart: used at crew level planning or as a representation of CPM network
c) Line-of-balance: a particular representation for line-of-balance scheduling technique
d) 2D drawings: normally used for site layout and space planning
e) 3D CAD: generally used for product clash detection or clarification of detailed connections
f) 4D CAD (3D+time): presents temporal and spatial aspects of construction and so is useful for plan evaluation and communication

Among the various types of information representation, the method chosen depends on the intended audience. For example, upper-level management may be interested in costs and integration of activities with very little detail. Summary-type charts normally suffice for this purpose. Daily practitioners, on the other hand, may require as much detail as possible in activity schedules. If the schedule is to be presented to the client, then the presentation should include cost and performance data as well (Kerzner 2001). However, none of these methods effectively present the multivariable information of time, cost, resource and performance in a holistic manner, not do they reflect the unique circumstances of each construction project.

Value of Graphics in Construction

It is extremely hard for a project manager to monitor and control all aspects of a project on the basis of firsthand observation alone. Significant information can be omitted or disguised during discussion or meeting with field professionals. Text-based information is often overly detailed or too technical detail or technical. Moreover, most organizations do not have standardized reporting procedures, which further complicate the situation. As already noted, each party or division may have its own method of showing information. Fragmentation of data by non-standardized formats and information expressed by discipline-specific methods limit a project manager's ability to effectively monitor and control a project.

In his book Envisioning Information, Edward Tufte (1990) points out that the most rewarding and challenging form of information graphics are compositions that convey multi-variable data. Proper visual representation of construction data can assist the project manager in a number of important ways.
Cutting cost and reducing the time for gathering and interpreting data
Reducing search effort and time (Card, Mackinlay et al. 1999)
Understanding complex relationships between multivariable data
Identifying exceptions by the recognition of patterns
Increasing memory
Reducing time spent for monitoring, but allowing more time for decision making
Obtaining better control of subcontractor activities
Developing better troubleshooting procedures

These purposes of visualization are explained in the following case examples.

### EXAMPLE 01

### 3D Syllabus

FIG. 15 shows the screenshot from an existing training manual for Fuji-Xerox printers and copiers. This multimedia content is distributed on a CD-ROM and was produced using Macromedia Authorware. The user interface has hyperlinks and buttons for page turning. The content is organized hierarchically. At the top level are modules, and within each module is a tree diagram. The leaves of the trees are pages that can be accessed and viewed. The pages contain text, images, and video clips.

The current hidden structure of hierarchical tables of contents in digital format requires users to unnecessarily turn pages to find certain information and doesn't provide a clue as to the amount or the location of that information. Users may not remember the location of information as soon as they have turned several pages of the syllabus. As a result, it is very hard for users to spend the time and effort needed to finish the contents.

A screen shot of the 3D syllabus is shown in FIG. 16. It visually presents the content of the Fuji-Xerox CD-ROM in a very different manner than that of FIG. 15.

Features

Three-Dimensional Tile Structure: Sense of Location

The content set is organized as a table that is represented by a grid of square tiles. These tiles are set on the flat ground plane in the 3D landscape. Spaces between the tiles allow the user to see the objects above and below ground. Part names are listed along one axis and task types are listed along the other axis.

Balloon: Sense of Amount & Priority

A balloon (or sphere) represents an index to the multimedia content; Each balloon has a string connecting it to the square tile beneath it. Clicking on a balloon accesses or plays the content corresponding to the square. The size of the balloon indicates the amount of content (e.g. in bytes) for that lesson. When content has been accessed, the user can give a rating to the content (e.g. through a dialog box or by directly manipulating the balloon). The height of a balloon indicates the rating (e.g. very low, low, medium, high, very high) given by the user.

Color: Classification

Color is used to visually group tiles of related content. For example, tiles of the same color belong to the same training module. Color patches of each balloon represent the different media: video, audio, slide image, text notes, bookmarks, etc. A balloon that has been visited has a red circle painted on its square tile (shown in FIG. 16).

Pipes: Guidance

The pipes connecting the balloons represent paths through the content. For example, an instructor can prescribe a course by using a path. Alternatively, a path can show the history of the lessons taken by a user studying independently. Arrows on the pipes indicate direction. The pipes represent a path through the various lessons.

The visualization is a double-sided landscape with one side for personal indexes and the other side for group indexes (See FIG. 17). The side with the balloons is the personal side, and the side with the cubes is the group side. For the training application, the group can comprise the students in the class. The height of a cube indicates the average rating given by the group. The brightness indicates how many people rated the content; this is important to know since an average rating from a small number of people may be less reliable. Clicking on a cube accesses group content such as the annotations created by other people.

To compare the group and personal indexes, a feature called Superimpose Indexes is provided. This function moves the indexes below ground to above ground, overlaying both group and personal indexes (See FIG. 17). Since the group indexes (cubes) are semi-transparent, both sets of indexes are visible

Benefits

Reducing Search Effort and Time

Visualization can essentially index data spatially by location and landmarks to provide rapid access (Card, Mackinlay et al. 1999). According to the results of a user test of the given example, users could remember the location of information far more easily than with the 3D model than with tree interface.

Understanding Complex Relationships

Visual representation automatically supports a large number of perceptual inferences that are extremely easy for humans. Visualizations simplify and organize information, supplying higher centers with aggregate forms of information through abstraction and selective omission (Card, Robertson, and Mackinlay, 1991).

Increasing Memory

Tufte (1983) observed that visualization can represent a large amount of data in a small space. Compared to the interface pictured in FIG. 15, which shows a very limited list of contents divided into over twenty pages in three levels of hierarchy, 3D syllabus presents it on a single layer. As a result, search time is dramatically reduced. The user's memory is increased, helping them navigate and search efficiently without time consumed becoming familiar with the information structure.

Enhancing the Recognition of Patterns

Visualizations can also allow patterns in the data to reveal themselves through clustering or common visual properties (Card, Mackinlay et al. 1999). These patterns suggest schemata at a higher level. FIG. 18, “Arc Diagram” by Martin Wattenberg shows visual representation of music. “Arc Diagram” is a method for representing sequence structure by highlighting repeated subsequences. It generalizes the musical notation by using a pattern-matching algorithm to find repeated substrings and then representing them visually as translucent arcs (Wattenberg 2002). The pattern or structure of music, which cannot be easily found in conventional musical notes, is intuitively identified.

Cutting Time for Monitoring

Visualizations can allow for the monitoring of a large number of potential events if the display is organized so that these stand out by appearance or motion (Card, Mackinlay et al. 1999).

### SUMMARY OF THE INVENTION

The present invention provides a system and method for visually representing project metrics on 3-dimensional product models.

The present invention also provides a computer readable medium having recorded thereon a computer readable program for executing the method for visually representing project metrics on 3-dimensional product models.

According to an aspect of the present invention, there is provided a system for visually representing project metrics on 3-dimensional product models, the system comprising: a user interface unit for receiving an input of color information, including variations in the colors and color tones of objects to be visualized in response to the course of a project, and output conditions, including a time interval at which an output is required, from a user; a database unit for storing the objects and temporal and/or spatial relationships between the objects; and an image formation unit for determining colors and color tones of the objects according to the project course based on the output conditions input by the user, forming and outputting 3-dimensional images of the objects by the determined colors and color tones.

According to another aspect of the present invention, there is provided a method for visually representing project metrics on 3-dimensional product models, the method comprising the steps of: establishing temporal and/or spatial relationships between objects to be visualized; setting the variations in the color and color tone of the objects in response to the course of a project; receiving an input of information concerning the project course from a user or an external system; determining colors and color tones of the objects according to the project course based on output conditions input by the user; and forming and outputting 3-dimensional images of the objects by the determined colors and color tones.

### BRIEF DESCRIPTION OF THE DRAWINGS

The above and other features and advantages of the present invention will become more apparent by describing in detail exemplary embodiments thereof with reference to the attached drawings in which:

FIG. 1 is a drawing illustrating construction project control cycle by Pierce 1998;

FIG. 2 is a drawing illustrating responsibilities of project control during construction;

FIG. 3 is a drawing illustrating the concept of control system;

FIG. 4 is a drawing illustrating system usages in the construction of the Zesiger Athletic Center at MIT, MA;

FIG. 5 is a drawing illustrating a visual interface according to the functions of Primavera;

FIG. 6 is a drawing illustrating project manager's control process;

FIG. 7 is a drawing illustrating change process in controlling;

FIG. 8 is a drawing illustrating evolution of scheduling methods;

FIG. 9 is a drawing illustrating Network Scheduling Types;

FIG. 10 is an example of a CPM network diagram;

FIG. 11 is an example of a PERT chart;

FIG. 12 is a drawing illustrating components of earned value analysis;

FIG. 13 is a drawing illustrating an example of forecasting the estimate at completion;

FIG. 14 is a drawing illustrating result of trend analysis by using performance index;

FIG. 15 is a drawing illustrating the screenshot from an existing training manual for Fuji-Xerox printers and copiers;

FIG. 16 is a drawing illustrating a screen shot of the 3D syllabus;

FIG. 17 is a drawing illustrating a view of the personal and group indexes;

FIG. 18 is an arc diagram by Martin Wattenberg showing visual representation of music;

FIG. 19 is a drawing illustrating the Quantified Bar;

FIG. 20 is a drawing illustrating alternative scheduling for a task using quantified bars;

FIG. 21 is a drawing illustrating the relationship between duration and intensity;

FIG. 22 is a drawing illustrating the superimposition of two quantified bars;

FIG. 23 is a drawing illustrating the quantified bars in their new position;

FIG. 24 is a drawing illustrating different repeating tasks represented on a line of balance chart;

FIG. 25 is the matrix-balance chart;

FIG. 26 is a drawing illustrating arrangement of quantitative bars by physical locations;

FIG. 27 is a drawing illustrating outworld applets of the two-dimensional version of Phase (X);

FIG. 28 is a drawing illustrating outworld applets of the perspective version of Phase (X);

FIG. 29 is a drawing illustrating existing visualization methods: a scatter plot, linked histogram, hierarchical tree, and tree map layouts;

FIG. 30 is a drawing illustrating an Interactive Information Visualization of a Million Items;

FIG. 31 is another example of visualization using the tree map;

FIG. 32 is a tree map representation of the pay item level of monthly cost report;

FIG. 33 is a drawing illustrating transformations of bar chart-based scheduling techniques;

FIG. 34 is a drawing illustrating an example of scheduling system;

FIG. 35 is a 3D CPM diagram;

FIG. 36 is a drawing illustrating a visual representation of activity with manpower & work load;

FIG. 37 is a drawing illustrating a structure of three areas of the building model-based system;

FIG. 38 is a drawing illustrating a possible structure of information exchange among disciplines with the existing capability of computer-based systems;

FIG. 39 is a drawing illustrating an example of ArchiCAD's user interface;

FIG. 40 is a flowchart of 4-D CAD process;

FIG. 41 is a drawing illustrating Bentley's Schedule Simulator as an example;

FIG. 42 is a drawing illustrating visually assess impact to ongoing facility operations;

FIG. 43 is a drawing illustrating a color select pane;

FIG. 44 is a drawing illustrating examples of user interfaces of 4D CAD system;

FIG. 45 is a drawing illustrating an example of 4D component pane;

FIG. 46 is a drawing illustrating the concept of identifying space conflicts by time;

FIG. 47 is a drawing illustrating the different patterns for the various spaces;

FIG. 48 is a drawing illustrating a case when 3D models become the platform for all project information;

FIG. 49 is a drawing illustrating an example of interview summary;

FIG. 50 is a drawing illustrating a section of highway;

FIG. 51 is a drawing illustrating a building floor plan with core;

FIG. 52 is a drawing illustrating cranes by site constraints;

FIG. 53 is a drawing illustrating information availability through the project phases;

FIG. 54 is a flowchart of project control;

FIG. 55 is a drawing illustrating types of information relationships;

FIG. 56 is a drawing illustrating the construction of the structural skeleton of a typical floor in a cast-in-place concrete building;

FIG. 57 is a drawing illustrating relations according to different schedule structure;

FIG. 58 is a drawing illustrating many-to-many relation;

FIG. 59 is a drawing illustrating the links between the schedule and 3D objects when the building model consists of a column, beam, and slab;

FIG. 60 is a drawing illustrating the link when the inner steel reinforcement can be visually distinguished in the column;

FIG. 61 is a drawing illustrating visual properties of 3-dimensional object;

FIG. 62 is a drawing illustrating an example of visual representation of the status of activities by color on 3D model;

FIG. 63 is a drawing illustrating another example of visual representation of the status of activities by color on 3D model;

FIG. 64 is a drawing illustrating visualization of progress in the existing model-based system;

FIG. 65 is a drawing illustrating visualization of progress in the present invention;

FIG. 66 is a drawing illustrating a construction plan for the temple front project by Shih and Huang;

FIG. 67 is a drawing illustrating representation of sequence by time-based animation in 4D CAD;

FIG. 68 is a drawing illustrating sequence by degrees of tone;

FIG. 69 is a drawing illustrating work sequence by tone;

FIG. 70 is a drawing illustrating visual representation of construction sequence in 4D CAD;

FIG. 71 is a drawing illustrating visual representation of construction sequence in the present invention.

FIG. 72 is a drawing illustrating visual representation of activity dependencies;

FIG. 73 is a drawing illustrating visual representation of finish to finish relationships by border color of 3D model;

FIG. 74 is a pseudocolor map;

FIG. 75 is a drawing illustrating a color scheme for the types of 3D models;

FIG. 76 is a drawing illustrating a representation of the work sequence for the construction of the Allamilo Bridge;

FIG. 77 is a drawing illustrating concurrent representation of information on a 3D model;

FIG. 78 is a drawing illustrating visual representation of activity float;

FIG. 79 is a drawing illustrating visual representation of cost distribution;

FIG. 80 is a typical interface of Gantt (Bar) Chart;

FIG. 81 is a drawing illustrating visual representation of progress in building construction of steel frame structure;

FIG. 82 is a drawing illustrating user-defined column concrete work direction;

FIG. 83 is a drawing illustrating user-defined “Slab concrete” work direction;

FIG. 84 is a drawing illustrating visual representation of percent of completion by ghost image;

FIG. 85 is a drawing illustrating a linear color scheme of performance index;

FIG. 86 is a drawing illustrating a quadrangle color scheme of performance index;

FIG. 87 is a drawing illustrating visual representation of performance index;

FIG. 88 is a drawing illustrating visual representation of performance on bridge;

FIG. 89 is a drawing illustrating visual representation of performance index for project;

FIG. 90 is a drawing illustrating visual representation of overall performance on bridge;

FIG. 91 is a drawing illustrating variables of Deviation;

FIG. 92 is a drawing illustrating concurrent representations of deviation-related information on a 3D model;

FIG. 93 is a drawing illustrating a color scheme for types of causes;

FIG. 94 95 is a drawing illustrating superimposition of the clone models;

FIG. 95 is a drawing illustrating examples of data sets where 3D objects can be simultaneously applied;

FIG. 96 is a drawing illustrating an example of five types of information expressed in the 3D model at once;

FIG. 97 is a drawing illustrating multi-dimensional representation of multi-variable information;

FIG. 98 is a graph for consistent use of color;

FIGS. 99A and 99B are examples of dashboard interfaces;

FIG. 100 is a graphical user interface of Project Dashboard;

FIG. 101 is a drawing illustrating an example of time control slider;

FIG. 102 is a drawing illustrating how to select visual representation of performance by controlling of actual and time ranger sliders;

FIG. 103 is a drawing illustrating an output image corresponding to visual representation of sequence by time range slider and actual time slider FIG. 104 is a drawing illustrating opacity control sliders, navigators, and level of detail control buttons of Project Dashboard;

FIG. 105 is a drawing illustrating a data selector of Project Dashboard;

FIG. 106 is a drawing illustrating Information Panes of Project Dashboard; and

FIG. 107 is a drawing illustrating prototyping process.

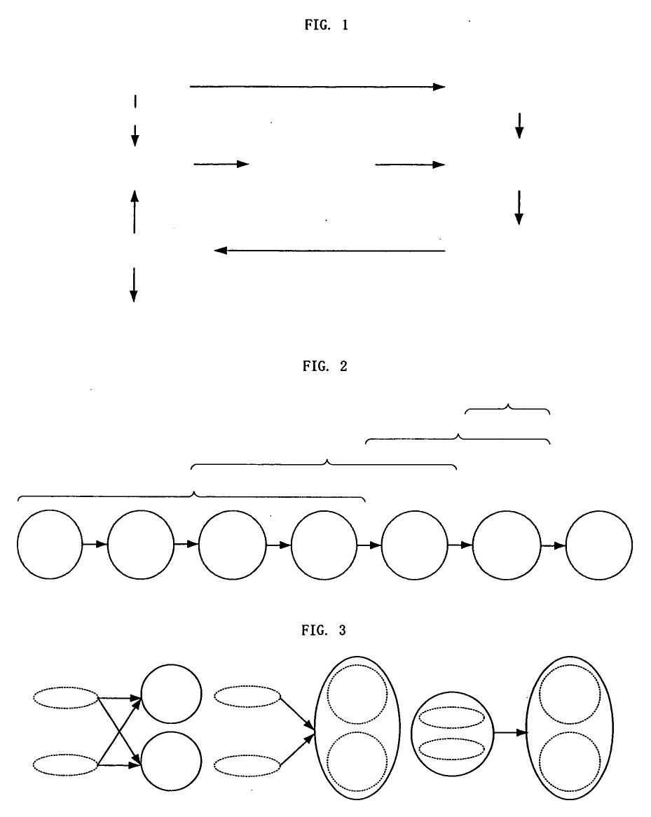

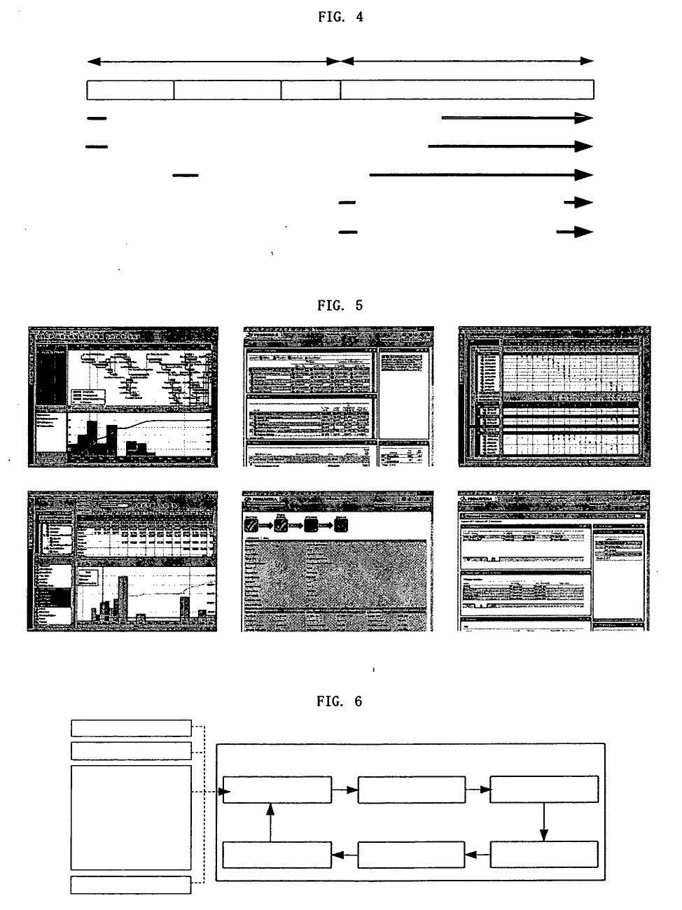

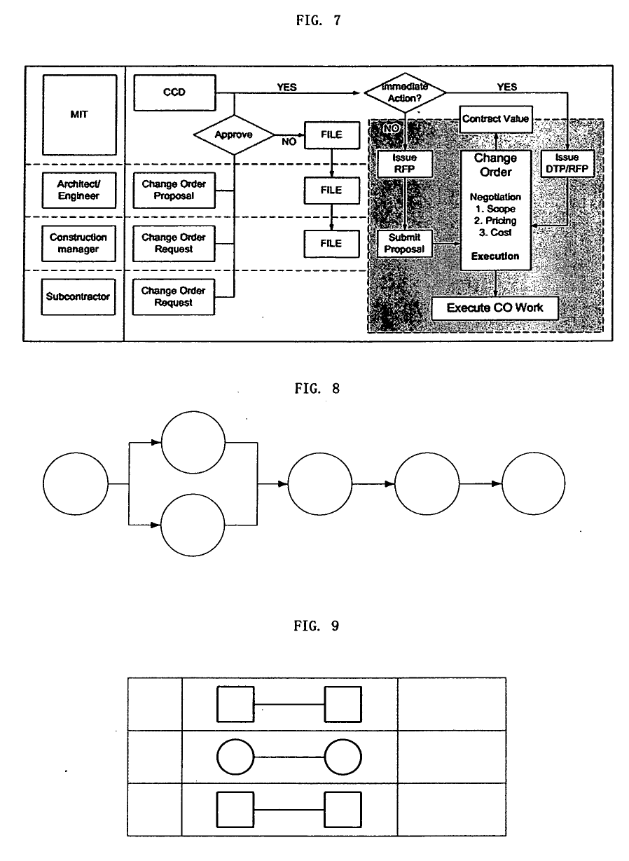

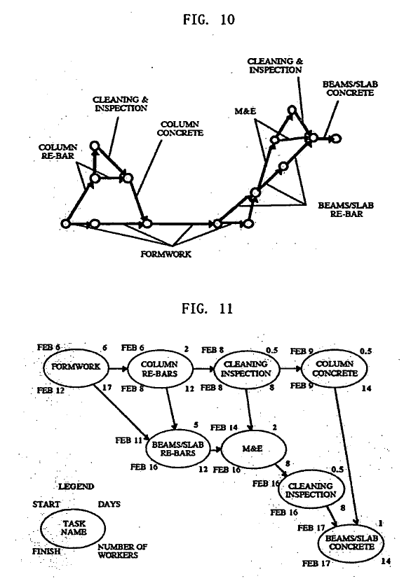

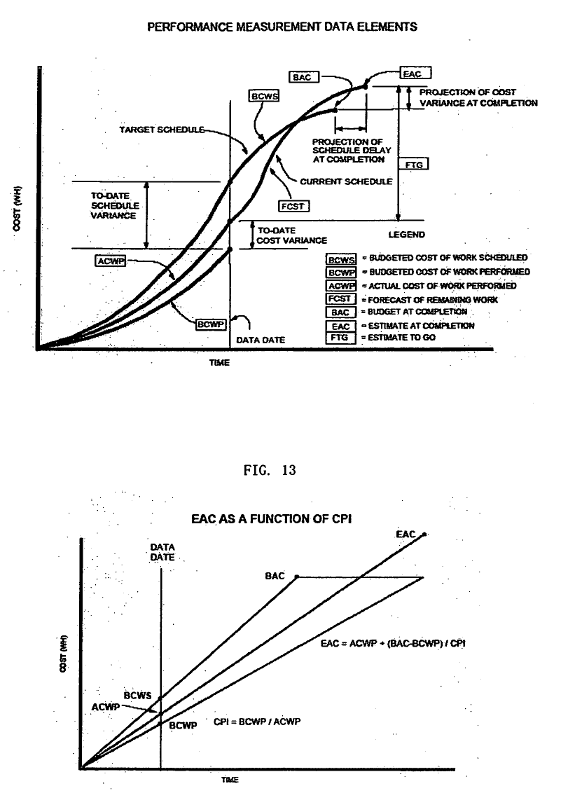

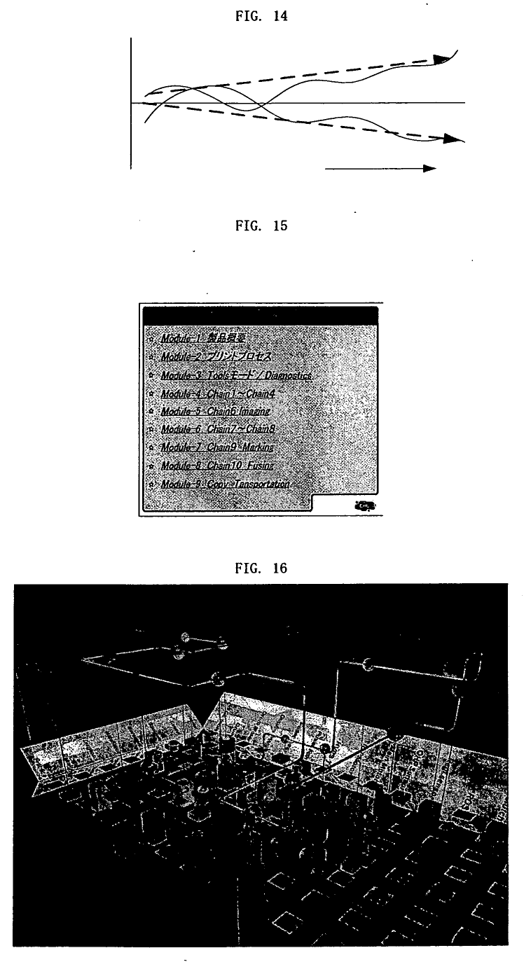

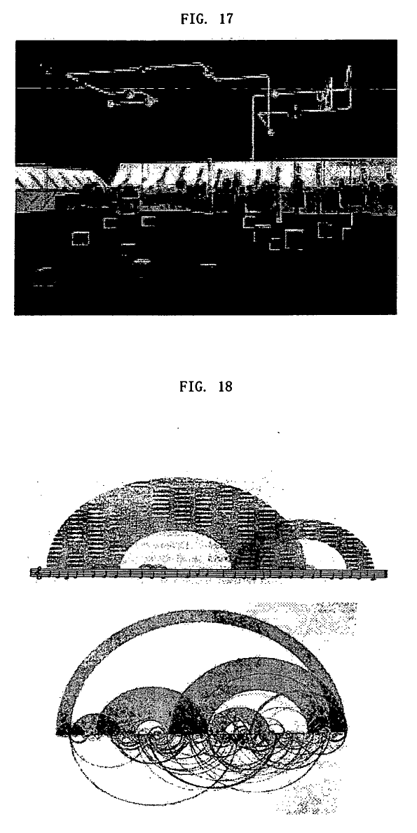

### DETAILED DESCRIPTION OF THE INVENTION

The present invention will now be described more fully with reference to the accompanying drawings, in which preferred embodiments of the invention are shown.

A. Abstract Representation of Project Management System

A-1 The Pollalis System

The Pollalis system was invented by Professor Spiro N. Pollalis at Harvard University in 1993. This bar chart based system can show far more information with analytical representation than can be shown on the traditional Gantt chart. The distinct features of the Pollalis system can be summarized as:
Qualitative representation of quantitative information by “quantitative bar”
Visual comparison by “superimposition” and “ghost” images of quantitative bars
Integrated representation of the matrix-balanced chart

Qualitative Representation

Quantitative Bar

The quantitative bar explicitly presents resources, together with time durations, as part of the representation of each task. In one of the alternative displays, the area of the bars indicates the work of the corresponding task, while the intensity of the bars indicates the production per time unit.

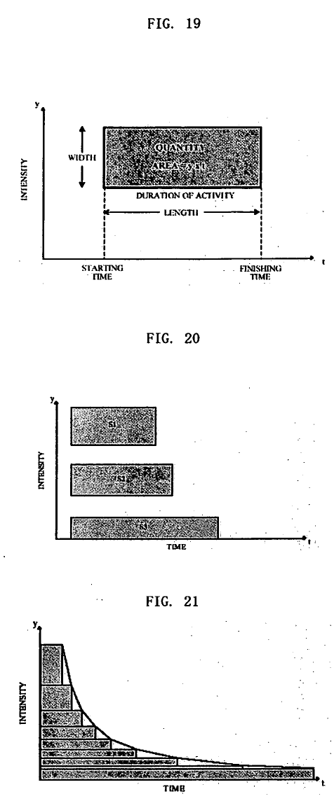

The quantitative bar offers an easier and more intuitive view of integrated data on the additional dimensions (see FIG. 19). Such an integrated representation of schedule information and quantitative information not only provides multiple points of view of the project, but also presents its qualitative value. Assuming the same amount of time is required for completion, the visual expressions of two tasks requiring different quantities of resources are expressed as identical tasks in the Gantt chart, which is able to display only time value (duration). In the Pollalis system the qualitative value of each task is clearly displayed based on the quantities of resources displayed on the quantitative bar.

Alternative Display

Thanks to an integrated expression of activity duration and intensity of resource requirements/usage, the interaction between the two can be expressed. The alternative displays of quantity indicate (Pollalis 1993):

The work of task;
Resources used or required;
*The cost of each resource; or
The total cost of the task.

If the quantity is constant, then there is a specific relation between the intensity and the duration of the task. FIG. 20 shows that the same task could be planned in several intensities and durations.

However, the quantity of resources used in a task depends on its duration. A very short or a very long duration may be inefficient and could lead to an increased resource cost for the same task. Thus, quantified bars that correspond to alternative planning scenarios for the same task may not have the same area.

If this non-symmetrical relationship could be expressed automatically in the system, it would contribute enormously to planning by providing qualitative alternatives (See FIG. 21).

Visual Comparison

Superimposition (Mate Quantified Bars)

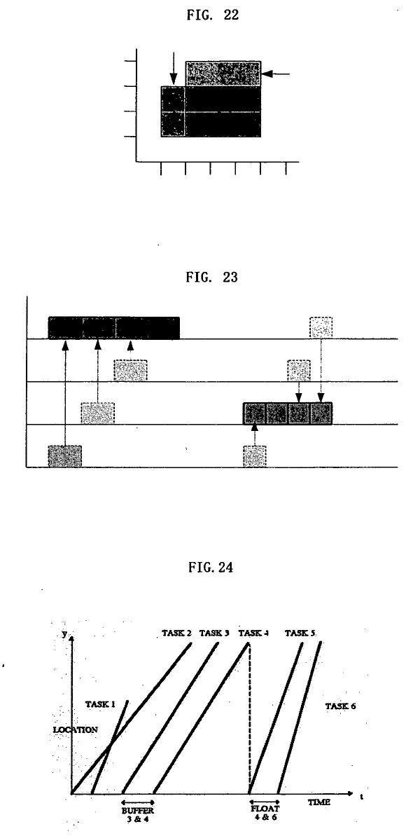

By superimposing the two quantified bars with different colors, or hatching, the planned versus the actual displays of the quantified bars can be shown in FIG. 22. If the execution of the task is different from the way it was planned, the two quantified bars will have a different shape. Also, changes are performed on the quantified chart itself and the various implications of those changes are immediately seen on the display. The activity in FIG. 22 explicitly shows that although planning envisaged eight person power days (two person power/daily for four days), the fact that a fewer day was available meant that extra manpower (one person) had to be provided to prevent a schedule delay and to meet the finish date, resulting in a cost overrun. A visual comparison of the planning versus the actual quantified bars shows the delay in the completion of the project and the cause is visually identifiable.

The superimposition of bars can also be very helpful for scheduling. When the time and cost relationship, as seen in FIG. 22, is shown automatically, time and cost trade-offs through alternative schedules can be easily compared, allowing for more effective planning. FIG. 22 shows immediately that it is more economical to implement the schedule for four days instead of three days due to one person power saving.

Ghost

Users can get a bird's eye view of each of the tasks through mate bars and the comparison of changes in schedule, structure or organization caused by rearranging information through a ghost image. FIG. 23 shows the quantified bars in their new position, while their original positions are indicated by ghost images.

Vertical arrows connect the ghost images with the final position, to indicate the procedure or history. This flexible rearrangement allows the user to study the scheduling of the tasks according to location, sequence, resource, criticality, etc. As a powerful visual cue, ghost images can express the following information:
The user can make visual comparisons by studying the schedule from different angles, according to changes in position made by rearranging the information.
The history of modifications for a project is visually expressed, allowing users to predict or influence future impact by comparing it with other considered plans.

Physical Context of Construction

Matrix-Balanced Chart

The matrix-balanced chart is a two-dimensional representation of multi-dimensional information about tasks: their magnitude, resources, cost, location and time of execution.

A task that is repeated at different physical locations during a project but requires similar resources, is a repeating task. A repeating task may also occur at the same location at different time intervals or for different projects (See FIG. 24). By definition, the vertical axis of a matrix-balanced chart indicates location. Location will mean either physical location at the project site or a specific time interval (Pollalis 1993).

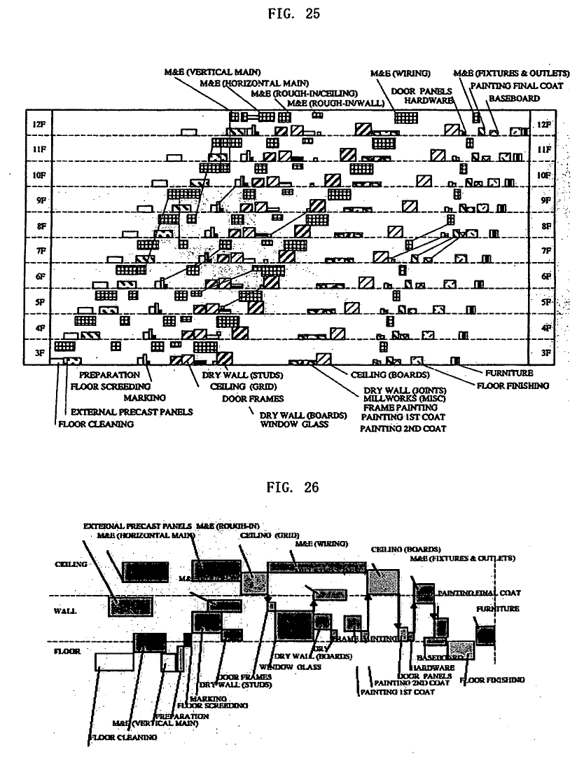

The Pollalis system displays the additional dimension of location through the location-specific layout of quantitative bars. All the tasks at the same location are displayed on the same horizontal zone within the chart, corresponding to the location-specific quantified chart. Each location-specific quantified chart indicates tasks of different constituencies, identifiable by different visual attributes, such as hatching, color or text. A reversal of order between constituency and location along the vertical axis can produce a useful chart, after the balancing of the matrix chart (See FIG. 25).

The Pollalis system provides a sense of physical location through the position of each bar. For a construction project, spatial context expression is vital. This is because the specific location of the job site where an actual task is implemented is the most important cause of differences in dependencies, constraints, and costs in terms of scheduling. The actual cost may vary greatly depending on the required equipment, manpower, and delivery frequency. FIG. 26 shows arrangement of quantitative bars by physical locations.

A-2 The Phase (X)

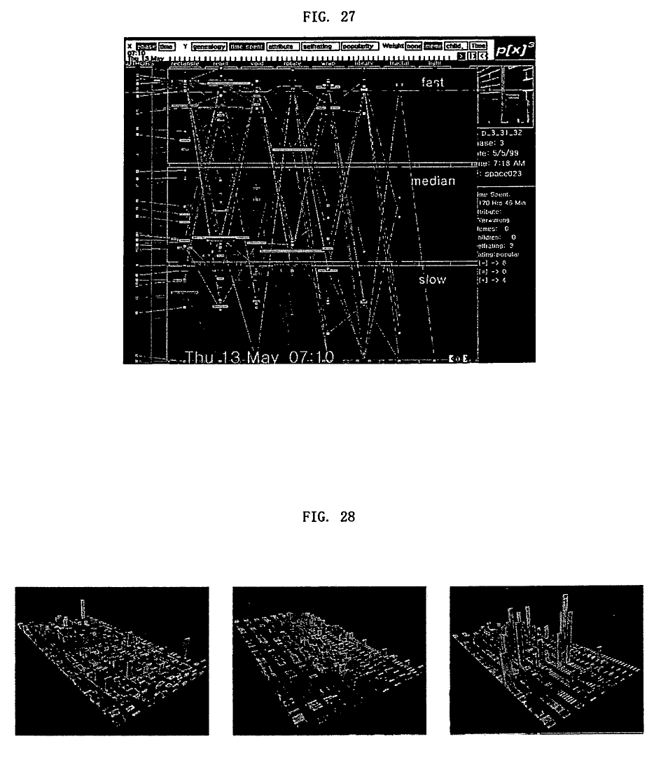

As a similar example of visualization, the Phase (X) was developed as a collaborative design environment in an elective design course of the Department of Architecture at the Swiss Federal Institute of Technology, Zurich (See FIG. 27). Phase (X) is a web-based system which visualizes students' studio activities and collective authorship, designed to allow students to post and share design assignments throughout the course. Its features are as follows:
Students' studio activities and collective authorship
Multi-user environment
Alternative representation of multi-data variables in the same visual representation

(Hirschberg 2001, 41-47)

With a multi-user environment, each color represents one author, and one rectangular bar or a hexahedron in three dimensions, expresses one completed work. The length, width, and height of the rectangle (or hexahedron) express the information established by the user. The data variables display the user's genealogy, phase, children, rating, and memos.

FIG. 27 is the two-dimensional version of Phase (X), where the layout expresses time through the horizontal line along the x-axis, and the y-axis is divided into three zones, with rectangles allocated according to the relative time spent completing the work. The Pollalis system, as in FIGS. 25 and 26 also organizes construction work using physical location, and allows rearrangement by user definition. Alternative representation of multi-data variables using such a customizable layout provides a consistent graphical representation through uniform visual attributes, while offering users powerful analytical capabilities. FIG. 28 is a perspective views of Phase (x) (Hirschberg 2001)

The Pollalis system and Phase (X) both use uniform visual attributes to express diverse information. Where change has occurred, the former expresses it through ghosting and the latter through line connection, offering a flexible and intuitive user interface for reviewing history or change. The 2-dimensional rectangle of the Pollalis system provides one less information dimension than the 3-dimensional hexahedron of Phase (X). In the following chapter, additional information on integrating methods based on the Pollalis system will be discussed by presenting the prototype development of a new three-dimensional Gantt chart.

A-3 Multi-Dimensional Visualization of Project Control Data

Multi-dimensional visualization of project control data was introduced by Anthony Songer and Benjamin Hays in 2003. Songer and Hays summarize the benefits of efficient visualization as the following:
Compact representation of large amounts of complex data
Intuitive overview
Reduced information search time and effort
Proactive management environment
Greater accuracy of information
Amplified cognition of quantitative data
Simplified process of visual representation
Reduced time and effort for understanding information

(Songer and Hays 2003, 2)

With these benefits in mind, Songer and Hays set out to investigate an underlying visualization theory and to develop a visual framework for applying budget and cost control information. Data is the raw material for building communication; when it is transformed to reveal relationships and patterns (the context), it becomes information.

The issue of budgeting or cost control represents one of many data-rich, information-poor problems that exist in construction controls (Songer and Hays 2003). Numerically rich construction problems exist, but value added, visually communicated information is lacking. Budget and cost information is mostly expressed through numerical representation using tables (or spreadsheets) consisting of columns and rows. Such number line-up methods accurately represent data in precise numbers, however they are unable to express large amounts of complex data compactly and intuitively in a unique context. Information should be appropriately transmitted with a level of detail and visual representation that meets the specific needs of the audience. The current uniform representation of budget and cost data has failed to function as an effective information delivery vehicle.

Tree Map

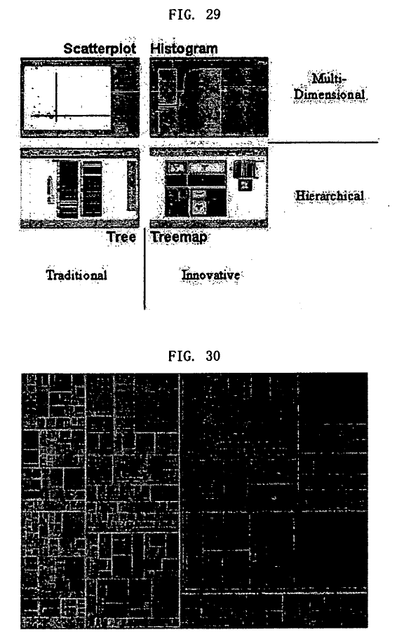

FIG. 29 shows existing visualization methods: a scatter plot, linked histogram, hierarchical tree, and tree map layouts. Unlike most two-dimensional data representation methods, the tree map, which has graphical variables such as the size and position of rectangles, is not only useful for representing hierarchical data, but also allows density and an intuitive representation of both hierarchy and budget. Information visualization using a hierarchical tree map is used in many industries as a methodology that can make the most efficient use of limited screen space for complex data.

Fekete and Plaisant (2002) used the tree map to express a million items on a 1600×1200 display. The size of each rectangle expresses the relative file size, color represents file type, and the degree of shade represents the depth of nested directories (See FIG. 30). The graphical pattern produced by file size, type and shade provides users with an intuitive overview of as many as a million files, an impossible task for the index style currently used. FIG. 30 shows an Interactive Information Visualization of a Million Items.

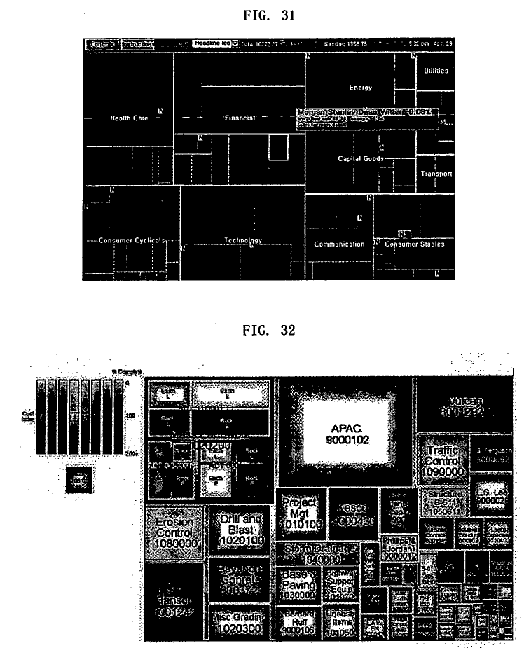

FIG. 31 is another example of visualization using the tree map. It is a web-based tree map, developed by Martin Wattenberg of IBM Research and is used widely today, which shows changes in the stock market every fifteen minutes in real time. The display shows approximately 600 publicly traded companies grouped by sector and industry. Each colored rectangle in the map represents an individual company. The rectangle's size reflects the company's market cap and the color shows price performance. (Green means the stock price is up; red means it's down. Dark colors are neutral). Within each industry the layout is designed so that neighboring companies have historically similar stock price movements (Wattenberg 1998).

The rectangles representing each company are laid out according to the industry category they belong to, while macro market trends, as well as micro performance for each individual company. As an additional feature, sets of color schemes are provided for the colorblind, using the blue/yellow color scheme instead of the red/green for a clearer view.

Multi-Dimensional Visualization of Project Control Data:

Large branches in the hierarchy are given large areas displaying the budget size. A color scale is used to show the cost index information. The degree of shading for each rectangle displays the completion percentage of each pay item. Thus, pay items with an aggregated completeness of 50 percent are shaded 50 percent. For quantity overrun items, black shading begins from the center of the rectangle out. Dark shading provides a powerful indicator for all quantity-overrun items. FIG. 32 is a tree map representation of the pay item level of monthly cost report.

Table 10 compares the three different systems and displays their common features. The size of the square shows the quantitative value of information, while color variations express the quantitative value of performance, which is primary information. Secondary information expresses quantitative value by changes in shade or tone, providing complimentary color variation.

TABLE 10

| | Visualization | | Multidimensional |
|---|---|---|---|
| Visual | of a Million | Map of | visualization of project |
| Attributes | Items | stock market | control data |
| Size of | File size | The company's | Budget size |
| square | | market cap | |
| Color | File type | Price performance | Cost performance |
| | | | index |
| Color scale | Depth of nested | Value of price | % of completion |
| (tone) | directories | performance | |
| Degree of | NA | NA | Percent complete of |
| shade | | | pay items |
| Degree of | NA | NA | Quantity overrun items |
| black shade | | | |
| Position of | File categories | Grouping by | Grouping by cost |
| square | | sector and | structure |
| | | industry | |

Representation of budget and cost information using tree maps is useful as the first stage in providing information to an audience. By visually expressing plan (budget size), actual condition (percent complete of pay items), and analyzed information (cost performance index) together, it offers a holistic overview which can not be provided by conventional methods such as spreadsheets or simple tree maps.

Graphical representation of budget size provides an intuitive overview of the relative size of problems and the presence of overruns, as well as project context. Shading with respect to unanswered RFIs or procurement delays in one diagram could reveal reasons why the schedule or cost index is a particular shade in another diagram. A colored cost index and its shading provides comparative answers to cost issues for currently active work items (Songer and Hays 2001).

A-4 Three-Dimensional Gantt Chart

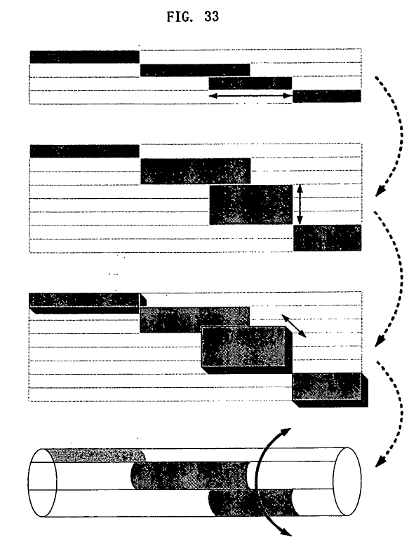

The 3D Gantt was developed in the early stages of this research as an implementation of abstract visualization for scheduling information. FIG. 33 shows transformations of bar chart-based scheduling techniques.

Each unit of the three-dimensional cylinder represents project duration (e.g., day, week, month, etc.) and the surface of the outer cylinder is occupied by the bar chart, with its height representing labor. In other words, the surface of the outer cylinder is the same as the Pollalis system. Due to its three-dimensional visualization, each bar's depth represents level of accomplishment. As a result, if the schedule is delayed the task bar pops out and creates an uneven surface for the given unit. The user can intuitively read the project condition by the degree of shape distortion. A schedule delay would be automatically manifested by distortion of the cylinder, and the user can “take apart” the cylinder and troubleshoot the task represented by the distorted unit. FIG. 34 shows an example of scheduling system (VRML Model).

A-5 Three-Dimensional Critical Path Method

3D CPM was also developed as part of this research for evaluating the efficiency of the abstract representation of scheduling information based on the critical path method. 3D CPM represents not only construction logic but also the line of balance on behalf of a three-dimensional interface (See FIG. 35). The top view shows activity paths such as a typical CPM diagram; while the “line of balance,” which represents repetitive activities on different locations, is presented from the side view. FIG. 35 is a 3D CPM diagram.

Activity:

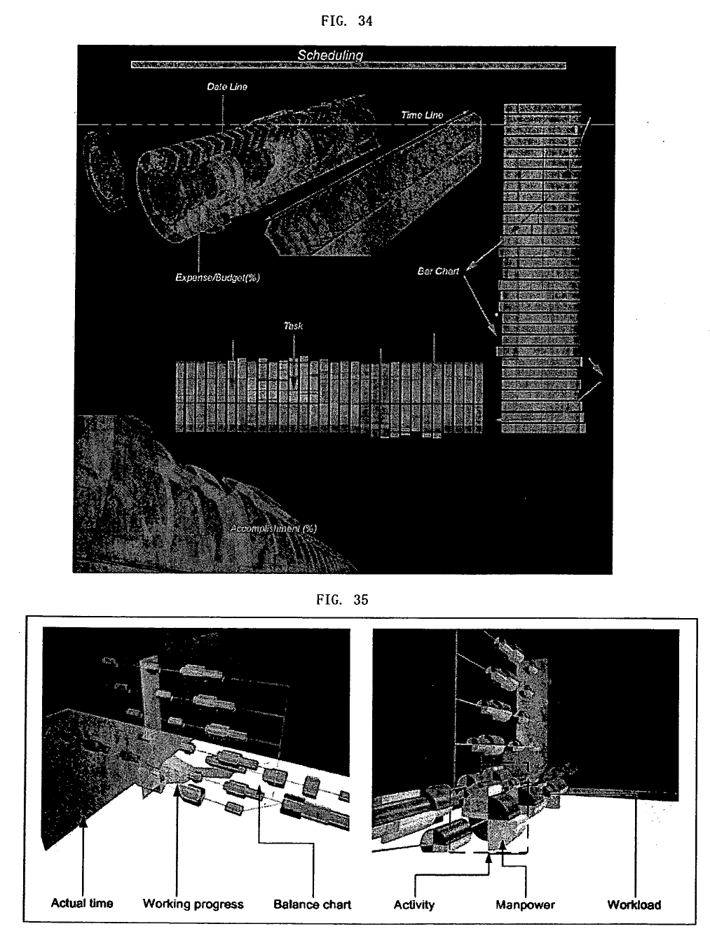

Task information is applied to the 3D graphical object and combined with resources (e.g., manpower) so that the user can easily compare resource allocation with actual need. Each activity is represented as a cylindrical object divided into four pieces, with two different colors by two axes. The length of each cylinder represents duration, while the diameter, by two different axes, shows allocated manpower and actual workload (See FIG. 36). For example, any activity requires a different amount of effort every minute, even though constant labor is allocated. By the graphical combination of these two elements, the user can immediately recognize over- or under-allocated labor, and make changes. The user also has the option of replacing manpower with a different resource and workload with its actual usage interactively.

Activity Relationship:

Typical CPM indicates many important scheduling factors such as the critical path and float of activities, but it cannot concisely show repetitive activities in linear scheduling. Three-dimensional CPM can present both CPM and balance in a single interface with intuitive graphical elements, as shown on FIG. 36. In the top view, the critical path is easily identified while the repetitive activities are shown in the side view.

Time & Duration:

Actual time is represented by a translucent screen moving through the objects, while actual progression is shown by the other screen. Overall progression can be intuitively recognized by the degree of distortion.

Drill Down:

Three-dimensional CPM can include explanatory text boxes, which appear as the viewer rolls over certain parts of the graphic. It can give interactive drill-down capability for vertical information navigation by clicking on certain data items.

Delay & Impact:

Delayed activity is indicated by extending the length of the cylinder with a different color, and the impact upon other activities can be shown as the diameter and color of the line between two activity cylinders.

Exception & Warning:

Exception or warning can be represented by a flashing activity cylinder or network line. For instance, information displayed in flashing red may represent an exception or warning, while information in flashing yellow may alert the user that the information needs to be recalculated. FIG. 36 is a visual representation of activity with manpower & work load (VRML Model).

A-6 Comparison of Visual Analogy

Table 11 shows visual attributes and representations of data in 2-dimensional systems. And Table 12 shows visual attributes and representations of data in 3-dimensional systems.

TABLE 11

| | System | | | |
|---|---|---|---|---|
| | | Treemap of | | Map of |
| Visual | | project | | Stock |
| Attribute | Pollalis system | control data | Phase (x) | Marker |
| Size | Quantity: time + resource | Quantity | Time (2D), Multiple | Quantity |
| | | (budget size)) | criteria (3D) | (market cap) |
| Color | N/A | Performance | Identity | Performance |
| | | (numerical | | (direction of |
| | | value) | | price |
| | | | | movement) |
| Tone | N/A | % of | N/A | Performance |
| | | completion | | (numerical |
| | | | | value) |
| Shade | N/A | Deviation | N/A | N/A |
| | | (quantity | | |
| | | overrun items) | | |
| Texture | Type of activities | N/A | N/A | N/A |
| Superimposition | Comparison | N/A | N/A | N/A |
| Line connector | History of | N/A | Inheritances | N/A |
| | Change | | | |
| Layout | Location by | Grouping by | Location by | Grouping by |
| | multiple criteria | cost structure | multiple criteria | sector and |
| | (e.g., by physical | | (e.g., by authors, by | industry |
| | location, by types | | popularity) | |
| | of activities) | | | |

TABLE 12

| | System | | |
|---|---|---|---|
| Visual Attribute | 3D syllabus | 3D Gantt | 3D CPM |
| Size | Quantity (size of | Quantity: time + | Quantity: time + resource, |
| | contents | resource, (dynamic | (dynamic size |
| | | size by completion | by completion of activity) |
| | | of activity) | |
| Color | Type | Status of activities | Status of activities (in |
| | (of contents) | (in progress, | progress, completed, |
| | | completed, etc) | etc) |
| Tone | N/A | N/A | N/A |
| Shade | N/A | N/A | Completion |
| Texture | N/A | N/A | N/A |
| Superimposition | Double sides | N/A | Two quantitative sets of |
| | (comparison) | | information (planned and |
| | | | actual resource) |
| Line connector | Guidelines | N/A | Activity logics |
| Layout | By type | By time | By critical path |
| | (of contents) | | |

B. 3D Building Model-Based Systems

There is a tendency to see a few spectacular developments as solving a range of problems in construction. Virtual reality is one of these and, while its present manifestation is just another stage in the development of visualization, its potential is for simulating buildings in many ways; not just their appearance but their performance and the process of constructing them as well (Howard, R. (1998). Computing in Construction, Pioneer and the Future).

Recent developments in computer technology, such as hardware performance, software development and web-based collaboration tools, enable professionals to perform design and construction tasks much faster and more efficiently than ever before. However, these computer-based project support systems are not fully utilized. Information about a project is often scattered in an uncontrolled and uncoordinated way, using different information systems and media. During the design and construction process, a variety of data formats and applications are used by the project participants. The project participants use different kinds of software packages such as. The various software packages used—word processing, spread sheets, cad-programs, and scheduling and management methods—cover different steps for different purposes in the project delivery. A common problem is that each system is an island unto itself and does not share linked information. To solve the problem, numerous research approaches to model-based systems have been introduced. This chapter will discuss the accomplishments, potential values, limitations, and development directions of research and development on 3D model-based systems so far.

B-1 Current Status

Chaaya and Jaafari (2001) state that computer-aided design (CAD) systems are not being fully utilized in the AEC industry even though they are extremely powerful tools. The virtual product model so far has only been partially used for automation in the architect or engineer's own narrow areas of specialization. The 3D model not only has value as a tool for design expression, but it is a central information platform that can gather, organize, record, and distribute various information on the overall project, to the extent that it can serve as a base for downstream processes towards the completion of the building (Tarandi 2003).

Despite the potential of 3D virtual building models, their use is extremely limited due to two main obstacles, one of which is incompatibility of data formats, and the other is heterogeneous visual representation. In an effort to overcome such barriers, research and development has been conducted in diverse fields, with some success. One example is a study conducted by the Building Information Model (BIM) founded on Industry Foundation Classes (IFC), and another is the development of the 4D CAD approach. Both approaches offer 3D product models as platforms for data exchange and integration, but BIM is a design tool based on parametric CAD developed for the purpose of productivity enhancement, and 4D CAD was developed for evaluation of scheduling and construction logic.

The IFC provides a cornerstone for data exchange between heterogeneous systems by presenting a standard for building data models. Below that foundation, parametric CAD systems like ArchiCAD, developed to provide an effective system as a design tool for architects, are expanding their functional boundary as building information models to include data on material, structure, and schedule. Through design support systems as well as other various approaches like 4D CAD, a new paradigm is being created in project support systems, such as constructability analysis capability, while a common virtual environment allows the designer, constructor, and client to collaborate with one another. This new paradigm of design and management systems in the AEC industry has developed in a mutually complementary manner, and the most distinct results are three achievements in particular:
Building Information Model (BIM)
Parametric CAD
4D CAD

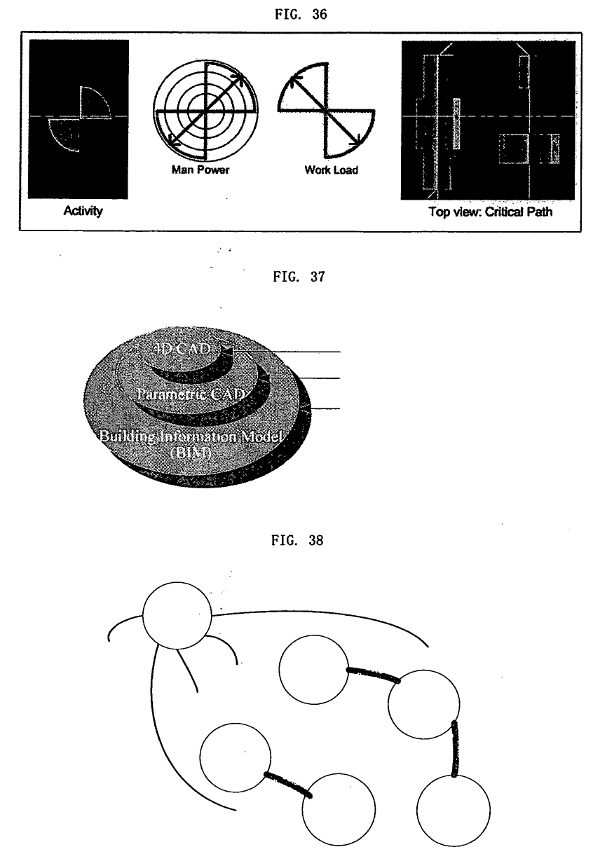

The Structure of three areas of the product model-based system is shown in FIG. 37

B-2 Building Information System (BIM)

In construction project, the need exists for exchange of increasingly complex information. During the 1980s interest in a standardized exchange of 3D geometries and product structures increased. The International Alliance for Interoperability (IAI) was founded and introduced Industry Foundation Classes (IFCs). According to the IAI the mission of the organization is: ‘To provide a universal basis for process improvement and information sharing in the construction and facilities management industries, using Industry Foundation Classes (Tarandi 2003). “Class” describes a range of things with common characteristics. For instance, every door has the characteristics of opening to allow entry to a space; every window has the characteristic of transparency so that it can be seen through. “Door” and “window” are names of classes.

The objectives for developing the Industry Foundation Classes include:
defining by the AEC/FM industry
providing a foundation for the shared project model
specifying classes of things in an agreed-upon manner that enables the development of a common language for construction

Currently, various commercial software tools for the AEC industry (such as Autodesk's Architectural Desktop, Graphisoft's ArchiCAD, Microsoft's Visio and Timeberline's Precision Estimator) are beginning to implement IFC file exchange capabilities (Froese 2003). Project information in a number of diverse systems, based on IFC standards, can be accessed concurrently by many users, or can enable transactional forms of data exchange among project participants and applications.

FIG. 38 shows a possible structure of information exchange among disciplines with the existing capability of computer-based systems. In the design phase, the designer develops a product model using CAD and 3D modeling tools. This data is handed over to the structural engineer for designing the building structure and to manufacturers for producing building materials. Meanwhile, a contractor uses this design data to calculate cost and schedule manually. A scheduler in the organization develops a project schedule based on design data after a detailed construction drawing has been completed. In this situation, data transfer between the architect and engineer is digitally feasible because they use the same kind of visual platform and data format. Nevertheless, it is impossible to exchange design information and scheduling or cost information. The reasons are first, because the information structures are different, and second, because their visual platforms are different.

B-3 Parametric CAD System

A parametric CAD system stores all the information about a building in a central database. Changes made in one view are updated in all others, including floor plans, sections/elevations, 3D models and bills of material. A central database of 3D model data contains not only building geometric data but also drawing sets, construction detail, bills of material, window/door/finish schedules, renderings, and animations. And these sets of linked building information are interactively stored, extracted, and controlled. This concurrent work makes the management of the project easier. The benefits of a central information repository for a project are numerous and substantial for all project participants (Holtz, Orr et al. 2003).

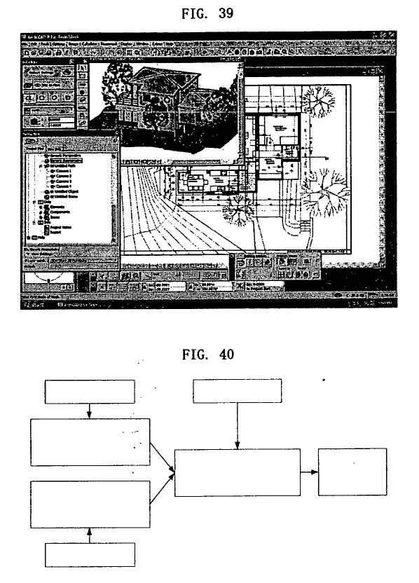

FIG. 39 is an example of ArchiCAD's user interface. When building elements are produced or modified either on a 2D-based floor plan or in a 3D model view, all data sets automatically and simultaneously reflect this. If a window was produced on a 2D floor plan, a realistic model of the window as well as relevant specifications is simultaneously produced on the 3D model view. The material, structure, cost, and typical schedule of the window itself is produced, and with the creation of a window, the quantity and cost of wall materials where the window is to be installed is automatically reduced.

B-4 4D CAD

If the parametric CAD system is considered a designer-oriented system, then the 4D CAD is a constructor-oriented system, developed for the main purpose of detecting space and time conflicts and understanding construction logistics. Four-dimensional CAD was developed by CIFE (Center for Integrated Facility Engineering) at Stanford University. It visually delivers sequence of a building construction by animated 3D product model corresponded to the schedule and construction sequence. Four-dimensional CAD (3D plus time) technology allows designers and builders to represent their view of the project in one common and sharable model. Currently, various commercial applications are being used in the construction industry. Four-dimensional CAD is also already being broadly applied in other fields of research, such as geodynamic or seismic visualization, etc.

System Description

In order to visualize in 4D, a 3D CAD tool (e.g., AutoCAD, Microstation, or Jacobus 3D, etc), a project scheduling tool (e.g., Primavera P3 or Microsoft Project), and a 4D simulation tool that is capable of integrating both 3D graphics and schedules are necessary. For example, Bentley System's Schedule Simulator can create time-based 4D simulation through a process of combining product model produced by 3D CAD tools, such as Auto Cad and ArchiCAD, with schedule information produced by PM tools, such as Primavera P3 and MS Project, and then importing this to the Schedule Simulator to link both information sets. FIG. 40 is a flow chart of 4-D CAD process.

Interface

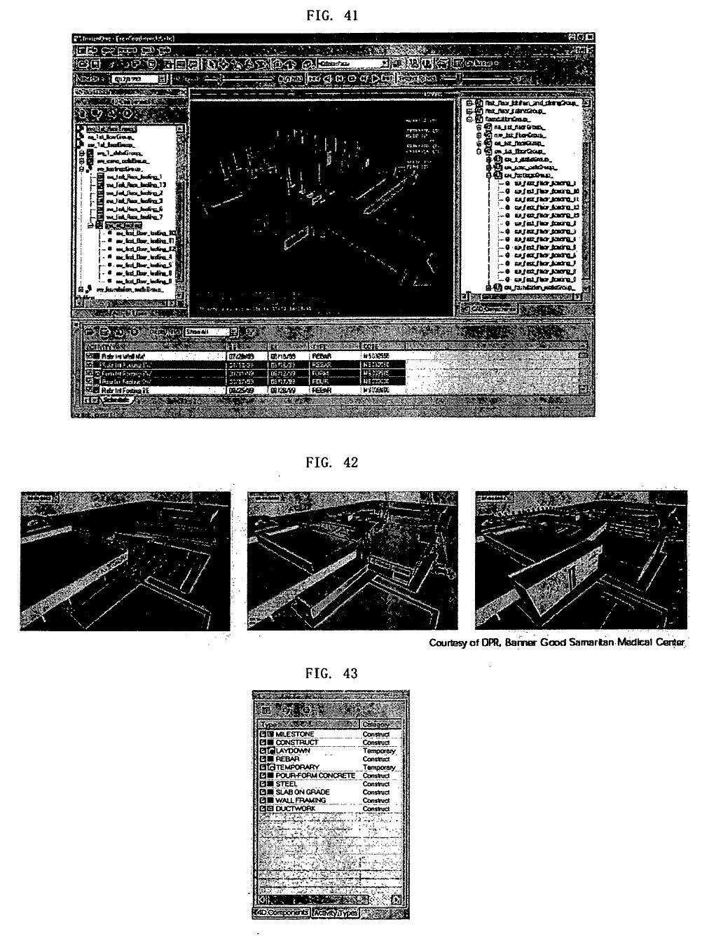

FIG. 41 shows Bentley's Schedule Simulator as an example. The left-hand side of the screen shows a 3-D object list in hierarchical order and the right-hand side shows schedule information. A simple drag & drop can link both data sets. A 4D component consists of one or more CAD components (copied from the CAD components window) that are linked to one or more activities from the schedule.

The 3D model can be reorganized in any way necessary for schedule visualization.

Visual Variables

Color

The color of the objects plays a roll in indicating critical information based on systems. In the case of CommonPoint's Project 4D (See FIG. 42) and Bentley's Schedule Simulator the user can easily recognize the status by assigning same colors to both objects and schedules of the activities.

In Schedule Simulator, a user can assign colors to model objects to show that a simulation activity is in progress, to denote the amount of progress toward the completion of the activity, or to distinguish between critical activities and non-critical activities (Bentley 2001). FIG. 43 shows a color select pane.

Blend

An object color can be blended by several user-defined steps to represent the progress of the linked activities. The number of steps and the start and end colors for the critical and non-critical activities from the color palette can be selected and the colors for each step activity can be blended or computed by the system. Table 13 is a Bentley schedule simulator user guide 2-7.

TABLE 13

| | | | | Object |
|---|---|---|---|---|
| Activity | | Object Display | Object Display | Display |
| Type | Description | Before Activity | During Activity | After Activity |
| Constructive | Objects are not present at the | Not Visible | In-Progress | Native Color |
| | start of the simulation, then are | | Color; | |
| | constructed during the activity, | | Critical or | |
| | and then remain on the site | | Non-Critical | |
| Destructive | Objects are present at the start | Native Color | In-Progress | Not Visible |
| | of the simulation, are | | Color; | |
| | demolished, and then removed | | Critical or | |
| | from the site during the activity | | Non-Critical | |
| Permanent | Objects are present at the start | Native Color | In-Progress | Native Color |
| | of the simulation, then work is | | Color; | |
| | performed on or with them | | Critical or | |
| | during the activity, and then they | | Non-Critical | |
| | remain on the site | | | |
| Temporary | Objects are not present at the | Not Visible | In-Progress | Not Visible |
| | start of the simulation, then work | | Color; | |
| | is performed on or with them | | Critical or | |
| | during the activity, and then they | | Non-Critical | |
| | are removed from the site | | | |

Functionality

Schedule Status and Comparison

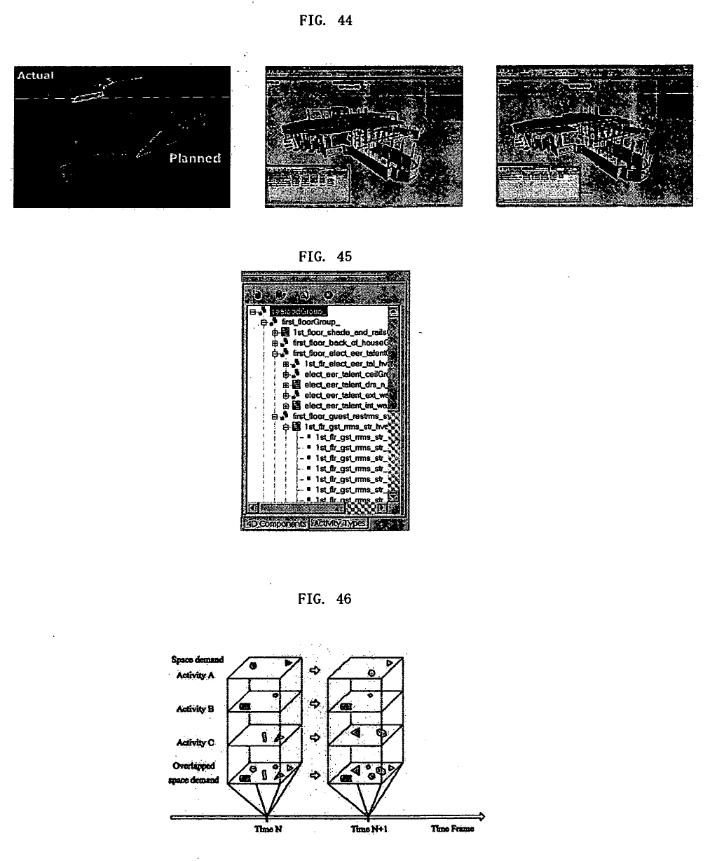

In Common Point Project 4D, the user can select a window, which compares the plan to the actual status, as seen in FIG. 44. The first display shows both images on the one screen. The next two show the results of two different the schedule alternatives. FIG. 44 shows examples of user interfaces of 4D CAD system.

Hierarchical Data Structure

The 4D Components window shows the 4D components organized hierarchically. A 4D component is one or more CAD components (copied from the CAD components window) that is linked to one or more activities from the schedule. The 3D model can be reorganized in any way necessary for schedule visualization. FIG. 45 is an example of 4D component pane. Meanwhile, 4D Software & Service Providers are set forth in Table 14.

TABLE 14

| Company | Software | Website |
|---|---|---|
| Common Point | Project 4D | http://www.commonpointinc.com |
| Bentley | Schedule | http://www.bentley.com/products/ |
| Systems | Simulator | simulator/ |
| VirtualSTEP | 4D Builder | http://www.virtualstep.com/4dbuilder/ |
| | | 4dbuilder.htm |
| BALFOUR | fourDscape | http://www.bal4.com/ |
| technologies | | |
| Visual | The Visual | http://www.visual-engineering.com/ |
| Engineering | Project | EMISScheduling.html |
| | Scheduler | |

Evolution

Early 4D CAD only progressed as far as displaying construction sequence through the manual integration of a 3D model and schedule. However, it has recently expanded its usefulness and diversified its functions through research and development. Examples of this include the automatic detection of space-time conflicts as proposed by Akinci and Fischer (2000), and Cuo's (2002) research on path planning.

Detection of Space-Time Conflict

Akinci and Fischer (2000) proposed the 4D Work Planner, a prototype system, as the framework for a system that can automatically detect time-space conflicts due to dynamic changes in space requirements on the construction site. This prototype consisted first of a module for automating the generation of project-specific activity space requirement and secondly, a module for categorization through the formulation of analysis of time-space conflicts.
4D WorkPlanner Space Generator
In this study, space was categorized into four types: labor crew space, equipment space, hazard space, and protected space. In the spaces defined by these categories, conflicts are automatically detected according to changes in space requirements based on the schedule.
4D WorkPlanner Time-Space Conflict Analyzer
In order to appropriately manage different types of detected conflicts, they must be categorized and ranked according to the types of problems. In this module, the types of conflicts are defined and categorized by the types of spaces conflicting and the conflict ratios for each conflicting space.

Path Planning

Cuo (2002) stated that space management involves three primary aspects—site layout planning, path planning, and space scheduling. He argued that a minimum traveling distance or cost applies only to a transportation optimization, and not directly to the optimization of the work itself, nor the shortest working period. Efficient space scheduling comes from combining all working elements (worker, equipment, material, path, temporary facilities, and physical layouts) and subjecting them to the variations in time frames or schedules, and thus eliminating or minimizing space conflicts among these working elements.

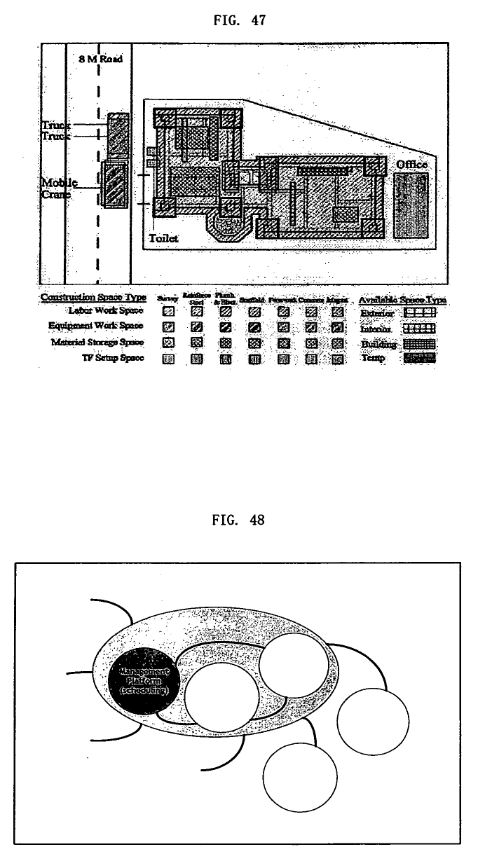

FIG. 46 shows the concept of identifying space conflicts by time. By overlaying space requirements for each dynamic activity according to when it takes place, one can visually detect the conflicts quite easily. For various activities, different colors are applied for identification within CAD. FIG. 47 displays the different patterns for the various spaces, such as working, storage, waste, or setup space. Based on the different colors and patterns on the CAD drawing, the space user can be identified easily (Cuo 2002).

Challenge

Four-dimensional CAD enables project participants and clients, regardless of their level of construction knowledge, to understand spatial constraints and explore design and construction alternatives before construction starts. It creates synergies between the knowledge and experience of the designers and the constructors. The 4D CAD modeling approach might be able to detect some scheduling error in the construction of a building (Griffis and Sturts 2000). However, current 4D CAD systems are not able to cope with the rapid changing of information characteristic of construction sites (Barrett 2000). Therefore, Griffis and Sturts (2000) discussed the desperate need for developing a 4D CAD system for schedule evaluation and control that reflects construction's dynamic conditions and performance. O'Brien (2000) proposes 5D CAD, asserting the need for a new model-based system that can, by using an additional dimension, express the complex interactions among cost, resource, and schedule, or cost and resource performance. Barret (2000) emphasizes the need for “nD CAD” that can be applied flexibly to project performance, since the current 4D CAD become useless when there is a change of information during construction. However, no study on 3D model-based systems has yet proposed a clear solution.

B-5 3-Dimensional Model as an Information Platform

The value of building 3D model, as an information platform, can be summarized as follows. It provides:
realistic visual expression
a consistent visual platform
a common language

Realistic Expression

One of the distinct characteristics of the construction industry is the uniqueness of each constructed facility. Products are built by performing numerous construction operations that involve complex interactions between multiple pieces of equipment, labor trades, and materials (Kamat and Martinez 2001). Also, spatial constraints are different for every project, and greatly influence the construction method, sequence, and logic.

A building 3D model can express more complex ideas without increasing the risks of construction mistakes. Better quality of decisions when the stakeholders are reviewing a model, as the representation of the project leads to lower lifecycle costs. Assessments about the order of construction, site safety, and location of the temporary site facilities can be explicitly represented by the building 3D model (Aspin, DaDalto et al. 2001).

Common Language

IT systems currently used in the industry are stand-alone, point-to-point applications dealing with parts of the internal operations of participants in the process (Aspin, DaDalto et al. 2001). Most construction projects involve a large number of participants-owner representatives, consultants, builders, trades, and more. Each party is issued sets of documents-which must be tracked and coordinated. Changes made by each must be assimilated back into the master set of documents (Holtz, Orr et al. 2003). These systems are optimized to enable professionals in each area to operate effectively; however, they lack a common language in which all project participants can communicate. A 3D model, as an integrated communications infrastructure, will allow improve co-ordination and communication among the different project partners and stakeholders around a visual, and thus intuitive, 3D shared conceptual model of the planned construction (Aspin, DaDalto et al. 2001).

FIG. 48 displays a case when 3D models become the platform for all project information. Through this common information platform, design, technology, management, and communication can be integrated into a single model-based system, and within each system, there are functional units made up of modules: schedule module, accounting module, communication module, etc. This allows each professional to use the module pertaining to their own responsibility, and to retrieve information from other modules whenever necessary. The information produced by each professional is automatically organized and stored in a central data repository. If such a model-based system were possible, it would have the following advantages:
Without having to learn each method of expression, the client, architect, engineer, contractor, vendor, etc could compare and understand data and information produced by other entities on a single and common visual platform.
Trandi (2003) states that bills of quantity, space, time and cost are some examples of what the construction sector wishes to exchange as well as drawings and 3D models of the building itself. Going beyond these demands, by enabling all project participants to work simultaneously within a single system, real time collaboration becomes possible, and data import and export among different systems becomes unnecessary.
In addition, instant feedback and evaluation can be sent among the various parties, minimizing the time and effort required to process a change or a request.
Since a single data change is automatically reflected in all relevant data, it minimizes redundancy of work by various entities.
The information input or modification by each entity is accurately stored in a single database, providing basis data for dispute resolution since the person responsible can be clearly identified.

Consistent Information Platform

IAI (International Alliance for Interoparability) reported that 50-85 percent of all construction problems are caused by missing, bad, or uncoordinated information. The virtual building serves as the basis for design, planning, construction, project management, and facility management, providing a vehicle for moving seamlessly from one phase of a project to the next (Holtz, Orr et al. 2003). Since more than 70 percent of the total lifecycle cost of a building is incurred after it is handed over to the owner, the product model can serve facility management in the period following construction (Holtz, Orr et al. 2003). Building 3D models starting from the design stage do not become an as-build model at once, but are refined and changed in terms of design and construction method, logic, schedule, resource, cost, etc. as the project progresses. By implementing appropriate procedures, the building information model can thus embody an audit trail for the project—an authoritative record of everything that happened, indexed by time (Holtz, Orr et al. 2003).

Interview: Value of 3D Model-Based System

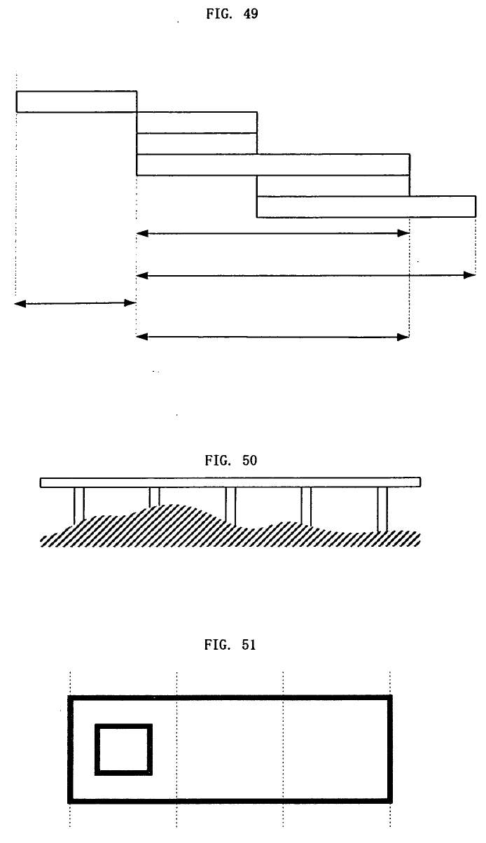

Interviews were conducted with four professionals in different areas of the A/E/C industry, regarding the efficiency of the system currently used in each professional's work. And feedback on the potential value of the 3D model based system for improving the work in each field through prototype presentation was also gathered. Only because there was a lot of overlapping feedback from the interviewees, those comments with greatest value from each professional's perspective are summarized in FIG. 49 below.

Quantity takeoff & Estimation: Interview 01

Despite the effort that the architects expand producing CAD drawings, the data cannot be transferred to the estimator's system. Hence, Stanley Kim, the cost estimator, manually estimates cost by reading the plotted hardcopy. He calculates the area by reading 2D drawings that he has scanned from a quantity takeoff system, such as Onscreen Takeoff then repeatedly inputs the data into a cost estimation system, such as timberline. The scheduler also produces the schedules from 2D drawings. Through repetitive oral communication between the scheduler and estimator, a final document is drafted. The process is usually repeated three times from schematic estimation to detailed estimation reducing the contingency. Even an experienced estimator makes errors due to misunderstanding or information omission in the process of reading 2D drawings.

At Bovis Lendlease, cost estimation and schedules are performed in different departments, with cost broken down into the five areas of architecture, structure, mechanical, electrical, and plumbing, digitalized by scanning the 2D hardcopy drawings. The scanned images are then imported to Onscreen Takeoff (On Center Software. Inc. 2004) where the quantity takeoff is done by the cost estimator, using Timberline cost estimation software (Timberline, Inc. 2004). The estimated cost data for each component is integrated within Timberline. The CAD Integrator provided by Timeberline software allows a direct quantity takeoff from CAD drawings, but this function is not in use.

The cost estimator, Stanley Kim, remarked that the cost engineer calculates quantities on each cost estimating item an average of three times for the quantity takeoff that uses hardcopy 2D drawings as an information source. When using a 3D model based-parametric CAD system, the quantity takeoff can be done automatically, minimizing construction problems caused by missing, misunderstood or uncoordinated information.

Scheduling: Interview 02

Minosca Alcantra, a scheduler and cost engineer from with over ten years of scheduling experience, uses Primavera P3 as the main tool for scheduling, and express frustration at the limitations of using CPM and Gantt charts, scheduling methods.

CPM and Gantt chart uses a work breakdown structure to organize data into groups, such as division, project phase, location, responsibility, team, and type of work. However, large-scale projects, with virtually hundreds or thousands of activities, are fragmented into many separated pages, making it difficult to see the schedule as a whole. Also, many steps are required to find specific data, and it is difficult to identify data location. Minosca states, “Nobody in the office can use and understand the scheduling system unless I am there.” Except for a constant user with ample knowledge of scheduling systems, the abstract expression of the code and text based information is too difficult for anyone to use. In addition to obscurely preserved information, the required functions for a scheduler are visual classification by different requests, such as by work type, structure, or areas of construction. In the highway construction project depicted in FIG. 50, five columns support the highway, but each column is very distinct in terms of construction schedule and cost due to topographical differences. With the current system, it is impossible to visually distinguish such differences. Identification of such nuances is fundamental for continuous tracking of complex links among task, resources, work type, and location.

A 3D model-based visual platform most useful for the scheduler should be able to identify in advance space and schedule conflicts or scheduling requirements through an accurate understanding of design and spatial constraints in scheduling. If a change is needed due to a schedule delay during construction, schedule alternatives can be tested using 3D simulation to plan a more effective construction sequence.

Project Control: Interview 03

Monitoring and Control Tool

Hanmi Parsons currently deploys Primavera P3 as a management system of the job site. Despite its many sophisticated functions, the system is primarily used for producing bar chart and CPM without integrating costs and resources due to the following reasons:
insufficient manpower to collect and manage the fragmented information it produces
manager's lack of understanding for the different control methods of time, cost, resource, and performance
the complexity of the system

Thus, in reality, the system is mainly used not for project evaluation and forecasting but for documentation.

Progress Measurement

The existing methods of measuring process are quite vague and non-systematic. Progress measurement, is usually based upon the consumption rate of resources. This approach might result in serious scheduling fiasco if a field manager makes the wrong decision.

As an example, in FIG. 51, “core” area in the floor requires a high proportion of concrete compared to other areas. Without a specific comparison analysis among the floor plan, evaluation, section and resource and cost data, the wrong assumptions could be made as follows:
one third of total construction is finished when Zone C is completed
one third of the concrete is used when Zone C is completed by passing over the additional requirement of concrete for core area in Zone A

Due to inaccurate progress measurement, a project manager can commit faults of control as well. For example,
the subcontractor might request or be paid more than the actual progress demands
over-usage of concrete in one specific area such as zone A might cause a time delay;
overlooking of expected delay might bring the opportunity of establishing the early counterplan

Such mistakes do happen now and then. However, if the construction process can be visualized in 3-D, such mistakes could be eliminated and quicker and more precise decision could be made.

Resource Management

Current systems are rarely used for resource management because precise quantity estimates and system updates are almost impossible. Construction manager, Hyosung Kim states that it is very important to express visually the difference between cost and time derived from clear information delivery, construction methods for each structure, and differences in raw material. For instance, in FIG. 51, one third of the cost should not be paid to the concrete subcontractor because he has completed zone C. In addition, when only one third of the concrete remains, it is obvious that a shortage of concrete for the construction of Zone A will result. The 3D model-based system graphically expresses actual progress and performance, rather than providing an abstract expression of information using numerical value, and thereby allows intuitive comparison with the actual situation.
Construction Logistics: Interview 04

Denis Leff, a project scheduler at Bovis Lendlease, Inc. and the person in charge of the 4D planner was the first to introduce and use 4D CAD in an actual project. Four-dimensional visualization is done through the 4D CAD system and 3D studioMax of CommonPoint, which is the easiest to use. As a project presentation and marketing tool, it places the greatest value on helping clients or project teams without construction knowledge understand the project, and it is helpful for finding schedule errors through visualization of space-time conflicts. However, product modeling as well as temporary installation or equipment must be modeled based on 2D architectural drawings, and the biggest issue pointed out is the fact that its use is limited in comparison to the time and effort needed for 4D visualization.

Temporary Installation

Since temporary installation items like scaffolding or fencing are not displayed in architectural drawings, they may be omitted in cost estimation and scheduling, and calculating the accurate quantity and expense using 2D-based hard copy building drawing requires a lot of time and experience. As for site fence quantity, there may be large discrepancies depending on the actual form of the site. Also, often a temporary installation needs to be dynamically moved during the course of a project, possibly generating space-time conflicts.

Equipment

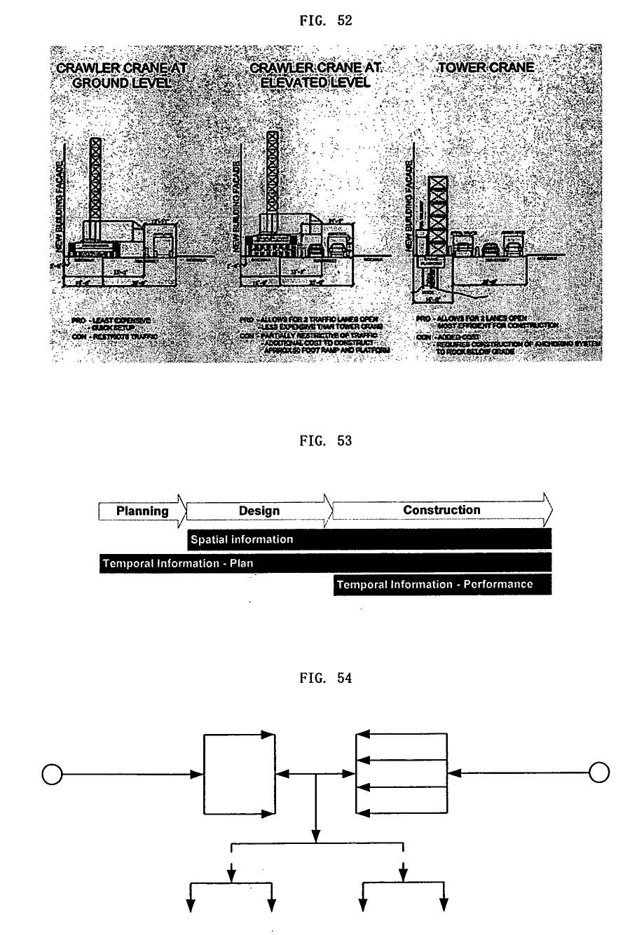

Construction equipment like the tower crane also does not appear in architectural drawings. For instance, space requirements and costs differ depending on the crane type. Furthermore, since work space moves as time progresses, 3D visualization of the construction progress would be very helpful in such equipment planning. FIG. 52 shows cranes by site constraints.

Space-time conflicts can be identified using 4D CAD system, which also provides the advantage of being easily comprehended communication tool. However, its usage is limited, and it requires a great deal of time and effort for production. As a result, its functionality remains circumscribed.

C. Design Principles of 3D Model-Based Control System

Up to now, research in 3D model-based management systems has only been capable of providing visual detection for space-schedule sequences and conflicts and assisting better communication through a pre-defined animation of construction logic and sequence at the planning stage. The key reason for this stalled development is the lack of a visual methodology for effectively integrating two different data sets of spatial and temporal information. Hereinafter, a methodology and design principle which integrates spatial and temporal information will be introduced. Firstly, visual attributes of 3D models, which can be used to represent information, are investigated. Secondly, types of information are defined along with methods of linking them to one another. Thirdly, design principles are presented using the control information for project managers.

C-1 Attributes of Design & Construction Information

In the prevent invention, project information is classified into two categories: spatial and temporal information. Temporal information can then be divided into two subcategories: plan and actual performance. FIG. 53 illustrates information availability through the project phases.

Architects create the design of a building, using 2-dimensional drawings and 3-dimensional models as spatial information. Engineers in all fields produce drawings and specifications for structural, electrical, and plumbing, based on the spatial information produced by the architect. From this information, the contractor develops a schedule and work logic, using various scheduling and accounting techniques. Design is expressed mainly using spatial information, process with temporal information, and cost is related to both temporal and spatial aspects of a project (Shih and Huang 2001). The representation of spatial and temporal information in a project is different and separate, yet the relation between the design to be constructed and the process used to construct it is important (Shih and Huang 2001). Thus, an integrated method, which has the ability to clearly express the relationship between spatial and temporal information in a project, is required for project managers to make a quick and accurate decisions.

Types of Spatial Information

Spatial information, as presented on Table 15, can be categorized as four different types:
Items to be demolished for the construction of a building, which are still visually expressed in architectural drawings or models;
Building elements presented in drawings and models that must be constructed and will remain as part of the building;
Temporary components such as scaffolding or field offices temporarily installed for certain activities during building construction;

Equipment used for construction that can be moved to multiple locations, such as cranes.

TABLE 15

| Types | Description | Sub-Categories | Example |
|---|---|---|---|
| Destructive | Construction elements destroyed | | Excavation |
| components | for building construction | | |
| Permanent | The building parts remaining in the | Architectural | |
| components | site after project completion. These | elements | |
| | are classified into five elements, | Structural elements | |
| | depending on the type of item. | Mechanical | |
| | | elements | |
| | | Electrical elements | |
| | | Plumbing elements | |
| Temporary | Temporary installations needed for | | Scaffolding, |
| components | constructing a building but not | | etc |
| | displayed in the drawing | | |
| Construction | Equipment or machinery occupying | | Crane, etc |
| equipments | various spaces included in building | | |
| | construction site | | |

Types of Temporal Information

In the present invention, temporal information can be classified into four categories; schedule, work logic, resource, and cost. This information is again subdivided into two subcategories. The first is planned information, which is produced at the initial stage of a project and is refined and revised until project completion. The other is actual performance information from the job site, which is measured from the start of the construction.

As can be seen in the flowchart of FIG. 54, project control evaluates the current status by comparing planned performance to actual performance. The evaluated historical data then becomes the standard for decision making and forecasting.

C-2 Levels of Integration of Spatiotemporal Information

Shih and Huang (2001) describe the relations between spatial and temporal information as evolving in four stages.

(Shih and Huang 2001. 50-55)
Level 01: the recording and presentation of sequential changes of objects over time
Level 02: the cross analysis of spatial and temporal information in the construction process
Level 03: automatic analysis of spatial relationships among construction activities
Level 04: graphical simulation of the dynamic process of construction

Level 1 is the stage, where “Record and Play” of the changes in spatial status is possible, using animated versions of a product model. This is similar to the current 4D CAD system. Compared to the 4D CAD system, visualizing a temporal sequence using 3D model changes is relatively time and effort consuming for the limited value of the outcome produced. Moreover, the system itself is quite rigid. Thus, the system cannot be used as a control system due to its inability to convey dynamic information during construction.

Level 2 enables automatic analysis through the partial integration of spatiotemporal information, rather than the current conventional analysis method with which requires project managers to manually interpret both the construction schedule and drawings. Shih and Huang (2001) state that the integration of spatiotemporal information may support automatic analysis of the following situations:
Concurrent changes in construction schedule and design
Current status of activities; active, completed, etc.
Occurrences in the construction process where there is more than one active activity in the same area at the same time
Depiction of work areas for activities that need to use the same kind of equipment
Estimation of the required quantity of materials in a given work area at a given time

Integration at this level requires a CAD model that incorporates a lot of information concerning construction time and cost, such as material and quantities, in addition to geometric attributes, such as location and shape.

In level 3, automatic analysis of interdependencies of construction activities is possible, according to the state of related objects and spatial conflicts in the use of equipment and work areas. In order to visually present interdependencies of construction activities on the building 3D model, the use of resources and equipment must be spatially expressed along with the activity sequence and criticality in network diagrams. This not only shows the plan through an animated 3D model, but also applies dynamic changes of construction information during the construction. In addition, through its simulation function, it visually displays possible consequences, thereby providing the project management with forecasting capabilities.

In level 4, it can simulate the effect on the construction plan of possible situations that might result in unexpected outcomes. The dynamic process of construction can be visualized and alternatives can be generated through simulation.

This model created by Shih and Huang clearly and systematically shows levels of spatial and temporal information integration. However, the current model-based systems are not able to present methods of visual interaction above level 2 in terms of the activity sequence seen in various 4D CAD systems.

C-3 Integration Method of Design & Construction Information

Hereinafter, the rules and integration methodology linking temporal information and graphical objects will be presented. Due to the incompatibility between WBS (work breakdown structure) and SBS (space breakdown structure), a strategy for integrating efficient spatial and temporal information is required. In reality, it is very rare that the two types of information have one-to-one compatibility. Furthermore, because in most cases several temporal data sets explain and support one graphical object or one temporal data set explains several 3D graphical objects, a rule is required for visually expressing such complex information linkages.

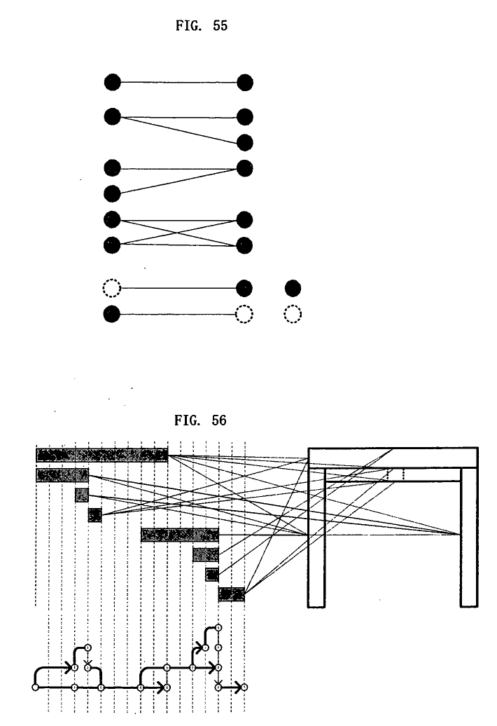

As described in FIG. 55, for the most part, schedule and graphical objects can be categorized into four types of relations. While they exist in the schedule as “cleaning” or “inspection,” there are cases where they may or may not be expressed as graphical objects.

Schedule Example: FIG. 56 shows the construction of the structural skeleton of a typical floor in a cast-in-place concrete building. The following eight tasks compose the construction of the skeleton of a typical floor:
a. Formwork: making the formwork
b. Re-bar columns: bending and positioning the reinforcing steel for the columns
c. Cleaning and inspection: cleaning and inspection of the formwork and the steel of the columns
d. Column concrete: placing concrete for the columns
e. Beams/slab re-bar bending and positioning the reinforcing steel for the beams and the slab
f. M&E: preparation for mechanical and electrical installations
g. Cleaning and inspection: cleaning and inspection of the formwork and the steel of the beams and the slab
h. Beams/slab concrete: placing concrete for the beams and the slab

Relations between the schedule and the building components can be defined as the following four types:

One-to-One

One-to-one relation is when one 3-D object is linked to one activity. This is expressed most clearly in integration. But in some cases, such as cleaning or inspection, the activity does not result in the production of an actual physical object.

One-to-Many

This refers to one activity being linked to a 3D building object. In the example of FIG. 57, the activity “formwork” in the bar chart is linked to all components in the 3D product model (A). A clearer expression is possible if the activity in the bar chart is broken down, with the formwork expressed as column formwork, beam formwork, or slab formwork (B, C).

Many-to-One

In many-to-one, contrary to the case of one-to-many, diverse activities are included in one 3D object.

Many-to-Many

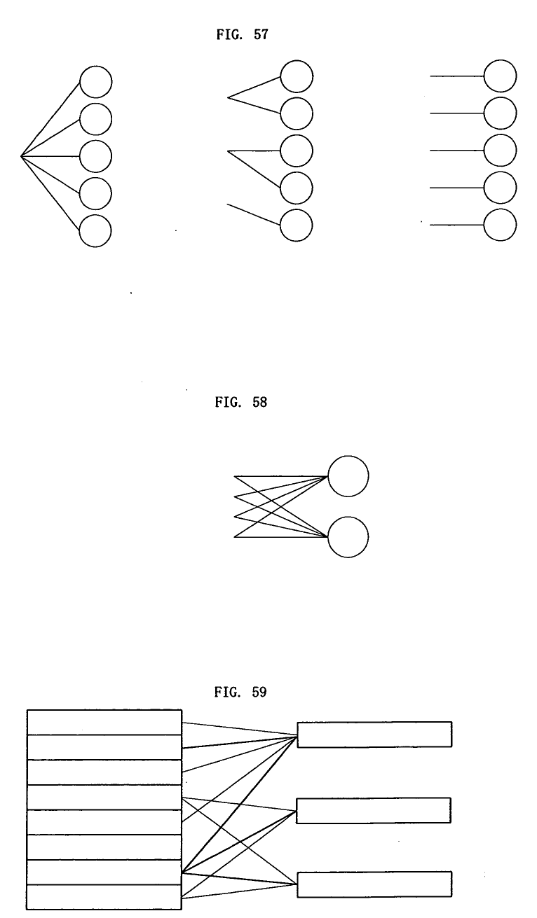

Many-to-many combines one-to-many and many-to-one, with multiple activities linked to multiple 3D objects. The relationship of one-to-many or many-to-one is based on one activity or object, as in the example of FIG. 57. However, when the schedule is seen in its entirety, it is many-to-many. In FIG. 58, column re-bar, cleaning & inspection, and column concrete are linked to Columns A1 and A2.

C-4 The Level of Detail

The hierarchical structure and layer concept of 3D models produced by an architect or engineer are distinct from the activities seen in the schedule. The sets of drawings categorized into architectural, structural, mechanical, electrical, and plumbing are created with a structure and information layer suitable for design production. Therefore, integration with WBS (work breakdown structure) is difficult to link in the schedule. In addition, there are many construction elements that cannot be expressed through 3-dimensional models, and many activities that cannot be linked with certain physical objects of a building. FIG. 59 shows the links between the schedule and 3D objects when the product model consists of a column, beam, and slab. FIG. 60 shows the link when the inner steel reinforcement can be visually distinguished in the column. The relationship may be displayed differently depending on the level of detail of the displayed graphical objects.

As was displayed in FIGS. 59 and 60, the relationships between 3D building objects and activities can be summarized as follows:
Links between spatial and temporal information can be changed according to the level of detail of the 3D objects;
Activities like inspection or cleaning, which do not influence construction directly, cannot be linked to an object one-to-one, and can only be expressed as a many-to-many or many-to-one relationship with the object, making clear visual representation difficult;
Details like M&E, which are hard to express through 3D objects, may not be linked to any object at all. In other words, 3D visualization of every detail of electrical cable in the building is impractical and unrealistic;
When the critical path or float is displayed in the current network diagram as a model, it loses most of its significance. Since many activities are included in one object, those displayed using CPM in the detailed level control schedule have no meaning in the model.

The clearest method for integrating spatial and temporal information is, to synchronize the work breakdown structure in the schedule with the space breakdown structure. This enables the 3D object to have a one-to-one relationship with the schedule. To do that, the design layer according to the work breakdown structure (WBS) of the construction schedule must be established from the design stage. However, it is practically unrealistic due to the limitation of modeling for every detail of the building components. Moreover, invisible activities, like inspection, cannot be expressed by a 3D model.

Therefore, merely integrating the 3D product model and activities in the existing schedule methods limits the potential value of the model. This thesis instead focuses on finding a new way to use the 3D model as an information platform for revealing hidden data in the existing methods.

C-5 Application of Information

Graphical Attributes of 3-D Objects

Geometric properties of 3D objects that can display data include point, wire-frame (border), and face. Dynamic properties include distortion or scaling and various kinds of movements. FIG. 61 shows visual properties of 3-dimensional object.

Tables 11 and 12 summarize the visualization methods introduced in the previous chapters. As visual data indicators, size, color, and tone of the graphical object are commonly used. The sizes of graphical objects can represent not only the quantitative value of information, but also a qualitative overview. This is shown in the Pollalis system, which applies two sets of quantitative data in the height of two axes of a rectangle. Color is a primary attribute used in most visualization systems, since color is one of the most pervasive visual experiences (Dondis 1974). Tone is also a very powerful tool for indicating and expressing dimensions. It is commonly used as a complementary visual attribute to support information represented by color.

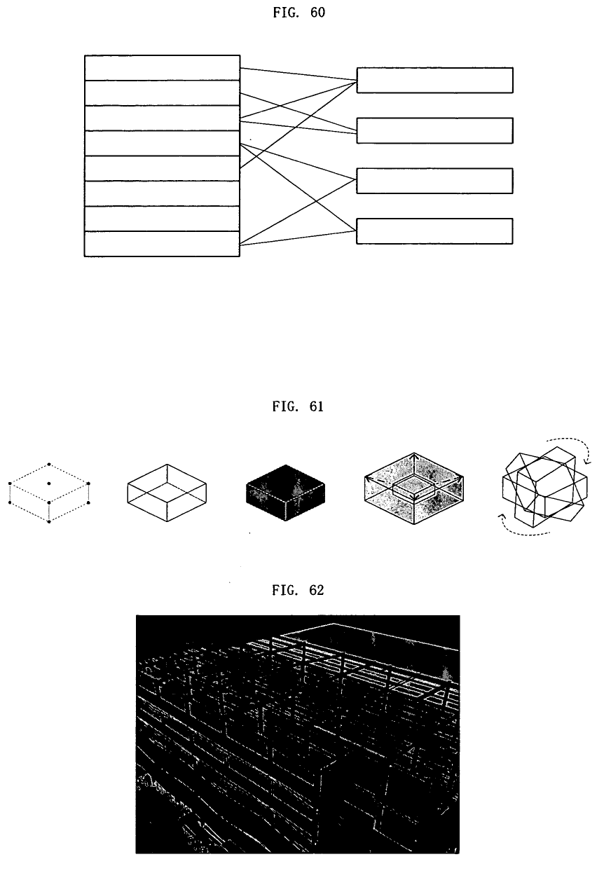

In the present invention, in addition to visual attributes, such as color, tone, and size, new visual representations, such as superimposition, shaking, and scale change for construction-specific systems are also introduced. Distinctive visualization techniques used in this research include the following:
Concurrent representation of multivariable data by multiple visual properties of a 3D model.
The conventional 3D model-based system limited its display to one data set on a 3D model using the face color of 3D objects (See FIG. 62). In FIG. 62, gray color represents ‘completed’ and blue color represents ‘in progress’. For instance, in CommonPoint's “project 4D” and Bentley's “Schedule Simulator,” the user can select a data set among activity status (e.g., in progress, completed), criticality (e.g., critical or noncritical), or types of building components (e.g., permanent or temporary) and may apply the desired color on the face of the 3D model.
The visualization method proposed by this paper was used as a tool for expressing information on geometric components like the face and border of the 3D model as well as dynamic movements like rippling and shaking of the 3D model. FIG. 63 is an example of visualization using the object face and border that comprise each 3D model. In FIG. 63, gray color represents ‘completed’, blue color represents ‘in progress’ and red and yellow colors represent ‘criticality’. With these, two kinds of data sets can be applied to different geometric components.

Just as the Pollalis system can flexibly apply time on the X-axis and diverse quantitative information on the Y-axis of a rectangle using the quantitative bar, the present invention can also apply diverse information. Comparison results between the Pollalis system and the proposed system are contained in Table 16.

TABLE 16

| System | Data set 01 | Data set 02 |
|---|---|---|
| The Pollalis system | x-axis of bar | y-axis of bar |
| Proposed system | Face of 3D model | Border of 3D model |

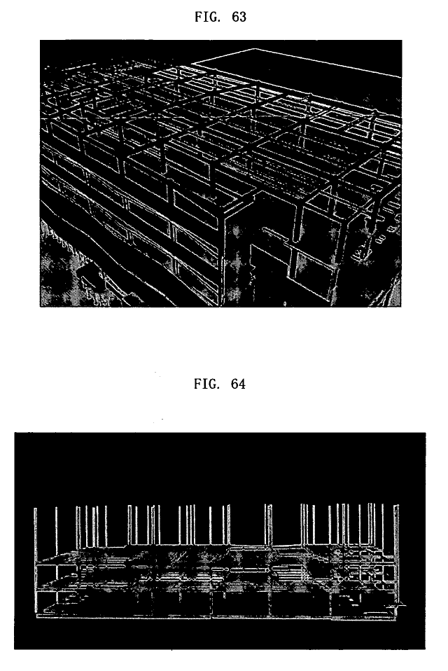

It can include dynamic visualization through movements and distortions like shaking or rippling, in addition to the genetic visual attributes of 3D models
Comparison by ghost images
This method provides intuitive information about two or more 3D models that supply different information about the same building part through superoimposition. This also coincides with the Pollalis system which overlaps two quantitative bars for visual comparison. FIG. 64 indicates how existing model-based systems express progress made at a certain point in time with animation, visually displaying only the completed parts and parts in progress.

In contrast, the method proposed in this paper, which superimposes a number of ghost images, enables simultaneous expression at one point in time by using gray to indicate completed work, blue for work in progress, a ghost image in orange for delays, and a ghost image in red for the planned schedule as shown in FIG. 65. This method differ from those using color or animation to depict activity status, in that different percentages of opacity are superimposed on one screen, allowing comparison of plan, actual progress and design changes without visual interruption.

Application of Baseline Information

Construction Sequence

As above discussed, if logical relations shown in the network diagram are applied to the product model, the relationship will change, depending on the model's level of detail and type of activities. Critical path and dependencies presented in CPM or PERT lose their significance when they are linked to the product model because many activities may be aggregated into one object or one activity may be linked to many 3D objects. Therefore, the sequence, criticality, and dependencies that should be displayed on the model-based platform must reflect the spatial constraints of the actual construction site, rather than the calculation obtained from CPM and PERT.

Sequence by Animation

The model by Shih and Huang in FIG. 66 shows the advantages when work logic in a network diagram is applied to the product model by using a convincing example of equipment constraint.

A model-based interface makes it easy to see that the C1 C2 L1 C3 L2 P1 C4 L3 P2 logic is more efficient than the sequence of C1 C2 C3 C4 μL2 L3 P1 P2, due to the weight lift constraint in the construction logic of this network diagram (Shih and Huang 2001). This is a critical issue that is not represented in CPM, a calculation based only on time without considering spatial constraints.

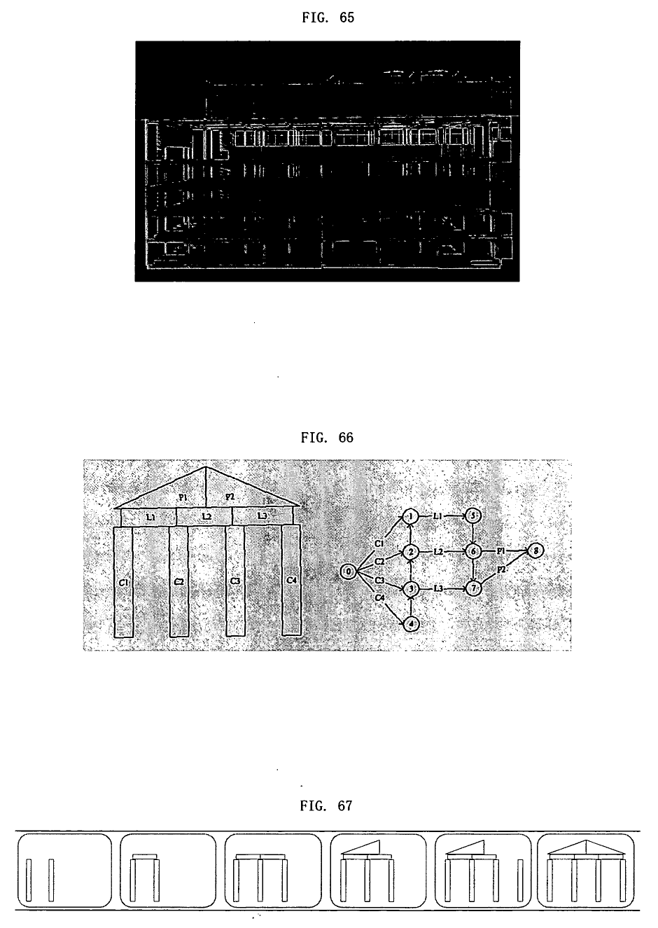

When the sequence of the given example in FIG. 66 is represented in 4D CAD, it needs at least seven or more keyframes of animation to show the sequence of construction, as seen in FIG. 67.

Since the entire sequence cannot be seen at once, it is difficult for the user to remember and understand all the relations with activities that do not appear on the screen in complicated sequences. Also, presentation of the 4D CAD example requires a computer screen, since the display involves multiple screen shots. Mobility is a critical issue for conveying information at a construction site. Communication, monitoring, and control occur not only in the field office but also in all work zones of the job site. Therefore, it is better for displays to be provided using color printouts and other simple and cost-efficient methods.

Sequence by Tone of Color

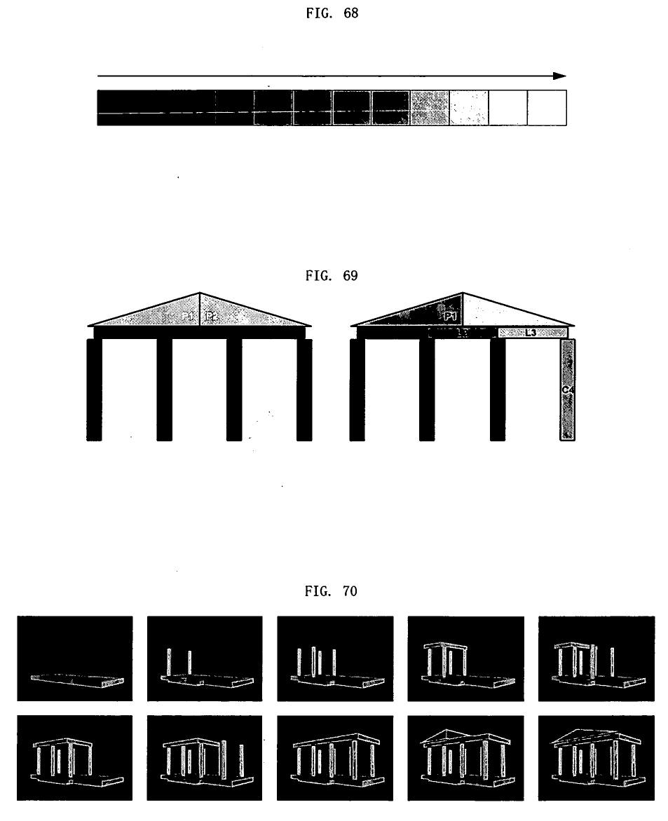

To present the whole sequence of a project, color tones are used in the proposed methodology. This enables the presentation of a sequence on a single screen. FIG. 68 shows the direction and chronological order of changes by the tone of a monotone table. FIG. 69 displays the same information as FIG. 66 using a color sequence. As can be seen in this diagram, the construction sequence is expressed as a static image due to the value of the monotone.

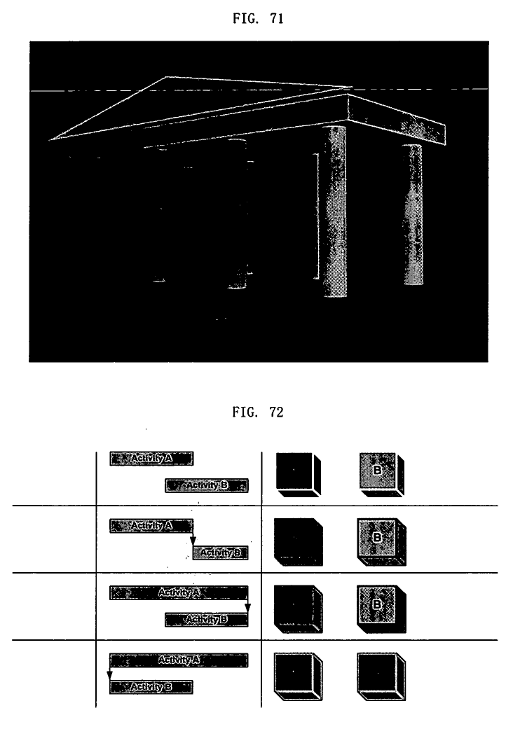

The sequence of the temple construction can be represented in a 3-dimensional view as seen in FIGS. 70 and 71.

Dependencies of Activities

Activities on the critical path can be easily distinguished using different degrees of tone (Schedule 2, FIG. 72). But non-critical activities, or hammock activities, represented by tone do not clearly show interdependencies with other activities in the proposed method, as shown in Schedule 1, FIG. 72. In the case of Schedule 1, the relationship between activity A and B is not explicitly presented in model-based form. However, control sliders of the actual time and the time range, support visualization of the start time and finish time of each activity.

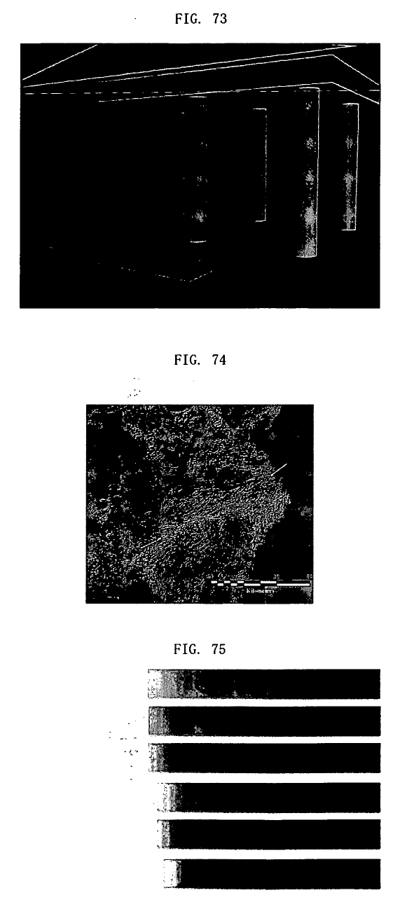

If temple slab and stair have a relationship of finish to finish, dependency can be represented by the same border color of 3D objects as seen in FIG. 73.

Another limitation of the current 3D model based systems is that they do not distinguish between types of 3D objects. In the present invention, the visualized 3D objects are differentiated into four types; destructive items, permanent items, temporary items, and construction equipment. In the current 4D CAD system, the only distinction possible is the peculiar form of the object or the existence of the object based on status of activity. It is difficult to determine the type of object without actually playing the animation from beginning to end.

Types of 3D Models

The concept of pseudo-color is a good example of the efficient use of color and tone together. Pseudo-coloring is widely used for astronomical radiation charts, medical imaging, and many other scientific applications. Geographers use a well-defined color sequence to display height above sea level: lowlands are always green, which evokes images of vegetation, and the scale continues upward, through yellow, to red at the peaks of mountain color sequences. FIG. 74 is a pseudocolor map.

Color expresses type of object, and each color tone change expresses sequence. When tone and pseudo-color are combined, a complex data structure can be represented in a visually intuitive way.

Method of Representing Types of the Building Components

The proposed design methodology for a 3D model-based system doesn't apply a specific color to a data value. Color images designed for on-screen presentation are always at the mercy of the viewer's platform, monitor and respective settings. Some systems, for instance, tend to darken colors significantly and may even display many of the darker on-screen hues as black. Other systems tend to be overly light and inadequately display lighter hues (Krause 2002). Color can be chosen intelligently by the number of variables. Below is an example of color selection.

Color representing sequence is mapped on the face of 3D objects. The color scheme shown in FIG. 75 is a example. However, color can be chosen according to user preference. FIG. 76 shows a representation of the work sequence for the construction of the Allamilo Bridge. Having a specific time point as a benchmark, blue is designated as the face color of the 3D model that represents “in-progress activity.” Incoming activities gradually change from darker red to lighter red, completed activities from darker gray to lighter gray. Color and tone are always interactively modified with the time slider and time range bar.

Criticality

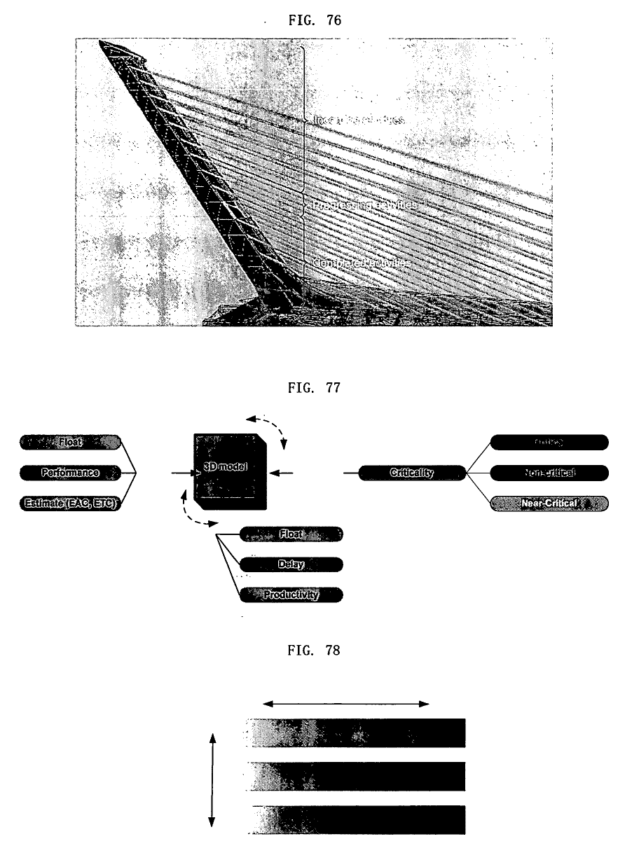

Criticality can be expressed by the border or face color of the 3D model. In the prototype, border color is applied. At the same time that criticality is applied to the border, an information set is expressed in the face of the model, thus, visually prioritizing the part that needs to be focused on. As shown in FIG. 77, face color represents sequence, border color, as criticality, and shaking as the productivity simultaneously.

Float

The float has values available to non-critical activities, which can be expressed by changes in face tone and a shaking movement of the model.
The method for applying a quantitative value to floats using tone:
The highest float (days) value of all the floats in a project schedule is set with the darkest tone, and the brightest tone represents one day. The smaller the float, the more vivid the color, making it visually dominant. Three colors are used for the float's visual expression, and gray is for default, as in the case of the ‘Map of Stock Market’ (See FIG. 78). Green indicates that the float value has increased, and red that if it has decreased.
Method using 3D model shaking:

When activity float in the planned schedule decreases, shaking begins, and the shaking gets stronger according to the rate of actual float decrease against the plan.

Budget Distribution

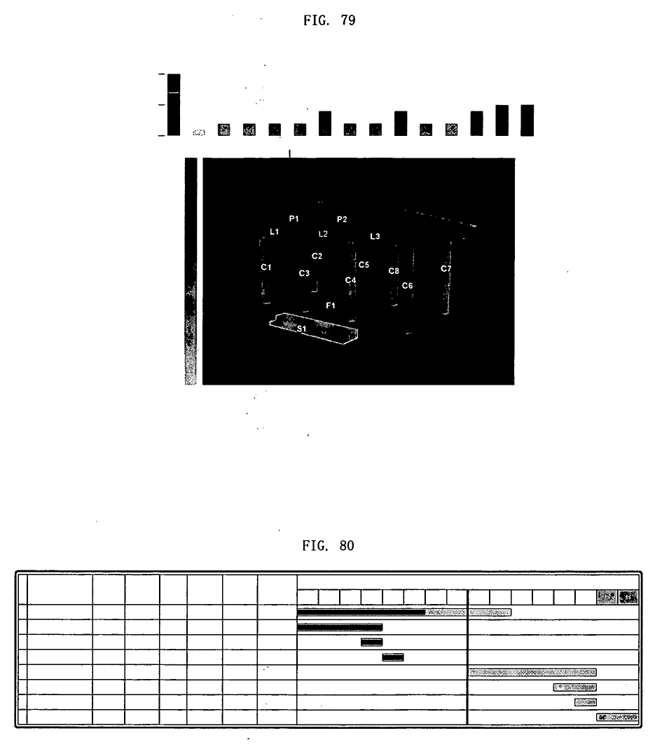

Information on budget distribution for each individual construction part expresses the relative cost information. This is important information requiring the attention of management. By visually expressing budget distribution for each construction part, the areas that require careful observation can easily be identified. FIG. 79 shows visual representation of cost distribution

Application of Actual Performance

Progress

Progress can be measured by using comparison. As is found in a bar chart, three visual elements are essential for graphically presenting progress. The baseline schedule bar serves as the norm for progress measurement, while the actual progress bar shows percentage of completion. The actual time line shows the influence of activity progress on the baseline schedule. FIG. 80 visually presents the activity “framework” being delayed by two days compared to plan.

Since the current 4D CAD-based system cannot visually present real-time progress, it cannot be used for purposes other than planning, such as project monitoring and control. The Gantt chart only presents progress or delay in terms of time, the cost or resource impact due to schedule changes cannot be indicated. However, the Pollalis system can clearly show progress using superimposition of the quantified bars representing plan and progress. FIG. 22 shows that the superimposition of the quantified bars representing the estimated quantities during the initial planning with the mate quantified bars representing the actual quantities offers a visual comparison of the two (Pollalis 1993). It shows that more manpower was involved, although there was no time delay in the actual activity, thereby clearly representing the relationship between schedule, resources, and cost. Tree map by Songer and Hays represents the cost index by color differences. The percent complete of each pay item is displayed by the degree of shading for each rectangle (Songer and Hays 2001). For instance, a pay item with completeness of 50 percent is shaded 50 percent.

Two Visual Representations of Expressing Progress

This research has developed two types of visual expression depicting progress. One is the case when visual completion of physical construction and the time schedule match. A steel-frame structure is an example where activity completion and visual completion of the building coincide. Type two is when visual completion of physical construction and the time schedule don't match. A concrete structure can be a good example of this type, where a time lag for the curing process is necessary even after the completion of the physical building.

Method by Visual Completion

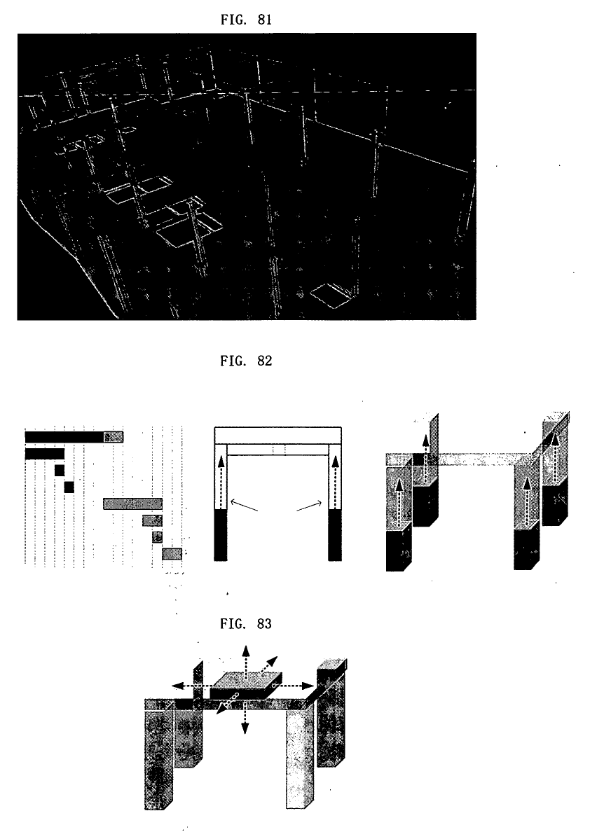

It is difficult to express the precise status of progress using the existing measurements, due to their vagueness and subjectivity. Taking advantage of the ability to display the same visual quality, a 3D model can actually express the physical building progress on a virtual product model. In FIG. 81, color and opacity represent the progress of steel-frame structure building construction. Solid gray represents the part that has been completed; solid red represents the part that is in process; and, translucent orange represents the part that has not yet been started.

Method by % Completion

In a 3D model, the percentage completed can be expressed in changes in object scale. Using ghost images, the 3D objects representing the as-built model and percentage of completed are superimposed. Because the user can control the opacity of each object group, as-built model and scaled model, they can visually compare the plan and actual progress. As is shown in FIG. 82, the model displaying the actual progress can change its scale depending on the input percentage of completion. If 50 percent is completed, the relevant 3D object is scaled down by 50 percent and superimposed with the as-built (100% in size), making it easy to see the progress. Along with such ghost effects, the CPI/SPI index value is simultaneously expressed in color on the object surface, allowing identification of both progress and performance in each part of the construction.

There are two methods of scale-down and -up, depending on the user's preference or type of construction. With user-defined filling-out direction, the user can choose the direction in which building components are to be completed. The as-built model shape exists as a ghost, and the percentage of completion is filled in with solid color starting from each object's center point or the lowest face of the Z-axis. If the user desires filling on a level surface of an elevation, the definition should be given on the control panel, and the percentage of completion begins filling up by calculating the entire object volume.

a. One-Directional Completion (by Z-Axis)

When the activities for column production in the bar chart schedule below are column rebar (four days) and column concrete (six days), and if activity “rebar” is completed, then the same amount of work completed is filled in with a solid color in the model. The 3D model in the prototype Project Dashboard basically has two models overlapping. One of them is a ghost image for showing the basic model framework, and the other provides visual variables.

b. Three-Directional Completion: xyz-Axis (XYZ): from Center

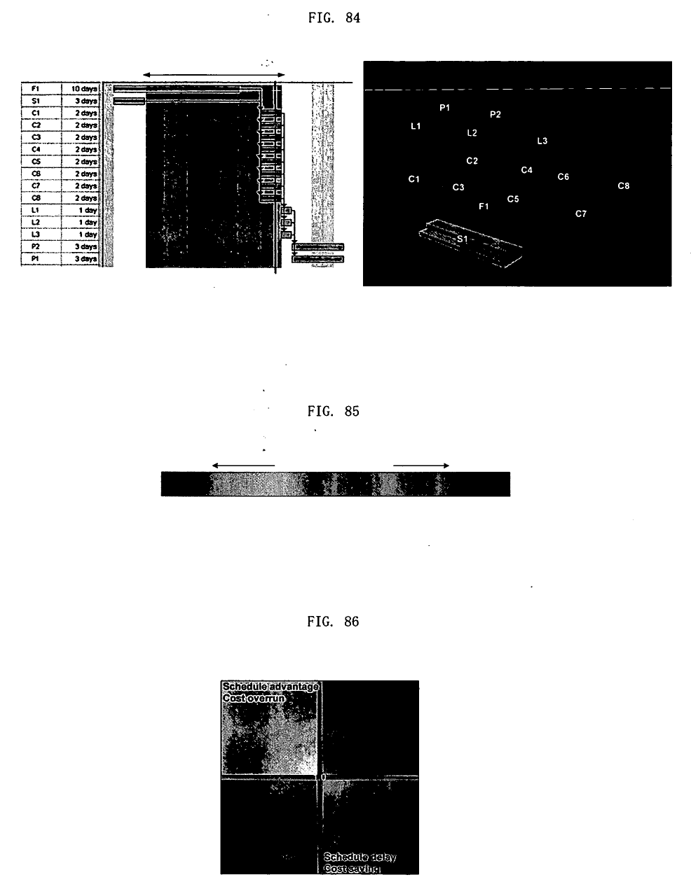

This is a method of filling up the percentage of completion in solid color from the center point of the 3D object towards the xyz direction. FIG. 83 is a diagram of a slab being filled up in the direction of the three axes. With the current prototype Project Dashboard, this is the only possible method. FIG. 84 shows visual representation of percent of completion by ghost image.

TABLE 17

| | | | Visual |
|---|---|---|---|
| System | Baseline | Actual | representation |
| 4D CAD | NA | NA | NA |
| Pollalis System | Quantified | Quantified bar | Superimposition |
| | bar | | |
| Tree map | | Color shading | Color & shade |
| (Songer and Hays) | | | composition |
| Project Dashboard | Original | Scale change by % | Superposition: |
| | shape | of completion | ghost |
| | | or filling - up face | |

Performance

Kerzner (2001) observed that the budgeting and scheduling system variance must be compared together because:
the cost of variance compares deviations only from the budget and does not provide a measure of comparison between work scheduled and work accomplished;
the scheduling variance provides a comparison between planned and actual performance but does not include costs.

The cost and schedule performance index must be presented in a system for it to have value as information for control. The method currently used to present performance uses the line graph, which is efficient for presenting performance measure of an entire project, but does not present performance by individual activity. This is because a project comprising 100 activities it would require 100 earned-value graphs. In a model-based system, the entire model can be seen in a single screen. Therefore, performance on each building component can be presented depending on how the CPI/SPI value is shown, while performance of the whole project can also be presented in a graphically intuitive manner.

In the case of Samsung Construction's earned value management system, although presentation of 3D objects does not have color mapping, the user can intuitively understand the current project conditions using color in the data table as seen in Table 18. Obviously, there are limitations if presentation utilizes a single color for the understanding of performance. Such information would be inadequate for project managers to understand the cause and impact of the deviations. For instance, purple warns of deviation reaching a dangerous level, but does not indicate whether the issue lies in cost or schedule.

TABLE 18

CPI

| SPI | Less than 100% | 100-105% | Over 105% |
|---|---|---|---|
| Over 95% | Blue | Sky blue | Yellow |
| 90-95% | Sky blue | Yellow | Purple |
| Less than | Yellow | Purple | Red |
| 90% | | | |

Method of Representation in Regards to the Performance of Building Components

The concept of opponent colors is used to represent CPI/SPI. Late in the nineteenth century, the German psychologist Ewald Hering proposed the theory that there are six elementary colors and these colors are arranged perceptually as opponent pairs along three axes: black-white, red-green, and yellow-blue (1920). In recent years, this principle has become a cornerstone of modern color theory, supported by a large amount of experimental evidence about opponent colors (Hurvich 1980; Ware 2000). There are two methods of expressing performance with color. One is to express either SPI or CPI using the linear color scheme shown in FIG. 85. The other, shown in FIG. 86, expresses both simultaneously using a quadrangle color scheme.

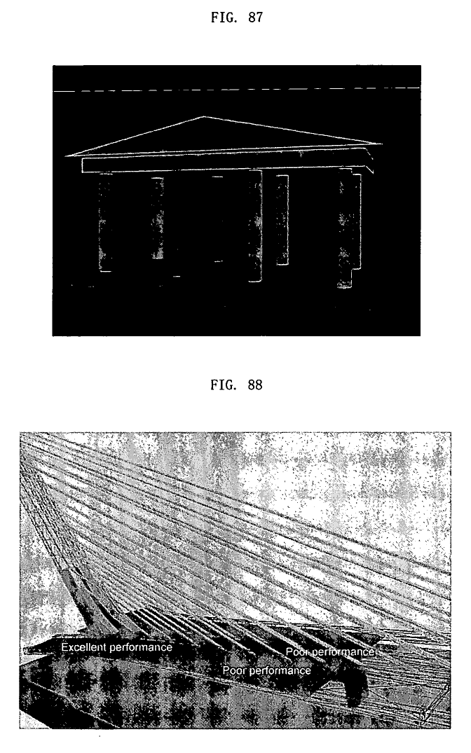

Performance, as seen in Table 19, is mapped on the face of the 3D object. Green represents perfect performance with CPI/SPI at 1.0; if the object's face color is blue, both schedule and cost are showing exceptional performance; orange means CPI is exceptional but SPI is showing poor performance. Also, a rough value can be estimated using each color's tone difference. There are buffers in the boundaries of the four colors, which can, for example, hint at possible problems by showing sky blue when the value is within a certain tolerance zone determined by the user. FIG. 87 shows visual representation of performance index. And FIG. 88 shows visual representation of performance on bridge.

TABLE 19

| CPI | SPI | Color | Implication |
|---|---|---|---|
| 1.0 | 1.0 | Green | Perfect |
| | | | performance |
| Buffer zone | Buffer zone | Buffer | |
| | | zone | |
| Over 1.0 | Over 1.0 | Blue | Exceptional |
| (or over tolerance) | (or over tolerance) | | performance |
| Below 1.0 | Over 1.0 | Orange | Cost is over |
| (or below tolerance) | (or over tolerance) | | budget, schedule |
| | | | is exceptional |
| Over 1.0 | Below 1.0 | Yellow | Cost is under |
| (or over tolerance) | (or below tolerance) | | budget, schedule |
| | | | is behind |
| Below 1.0 | Below 1.0 | Red | Cost is |
| (or below tolerance) | (or below tolerance) | | overrun, schedule |
| | | | is delayed |

Method of Representation in Regard to the Types of the Building Components

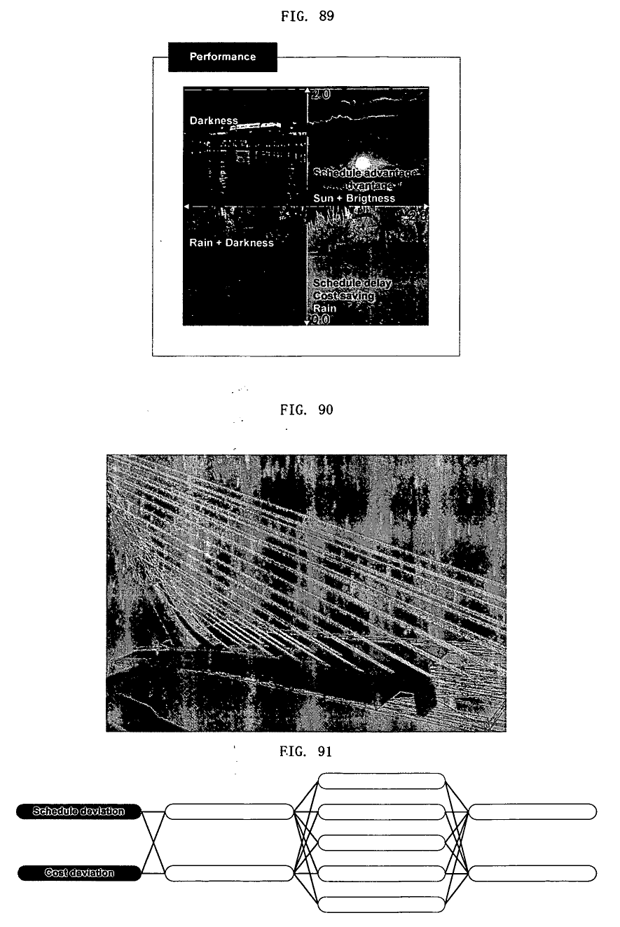

As shown in FIG. 89, overall project performance is presented as a weather change in the window. For example, if both the SPI and CPI value is over 1.0, the sun would rise and the background color would become lighter by degree of performance index. FIG. 89 is a drawing illustrating visual representation of performance index for project. And FIG. 90 is a drawing illustrating visual representation of overall performance on bridge.

TABLE 20

| CPI | SPI | Weather |
|---|---|---|
| Buffer zone | Buffer zone | Blue sky |
| Over 1.0 (or over tolerance) | Over 1.0 | Bright and sunny |
| | (or over tolerance) | |
| Below 1.0 | Over 1.0 | Dark |
| (or below tolerance) | (or over tolerance) | |
| Over 1.0 (or over tolerance) | Below 1.0 | Bright and raining |
| | (or below tolerance) | |
| Below 1.0 | Below 1.0 | Dark and raining |
| (or below tolerance) | (or below tolerance) | |

Deviation

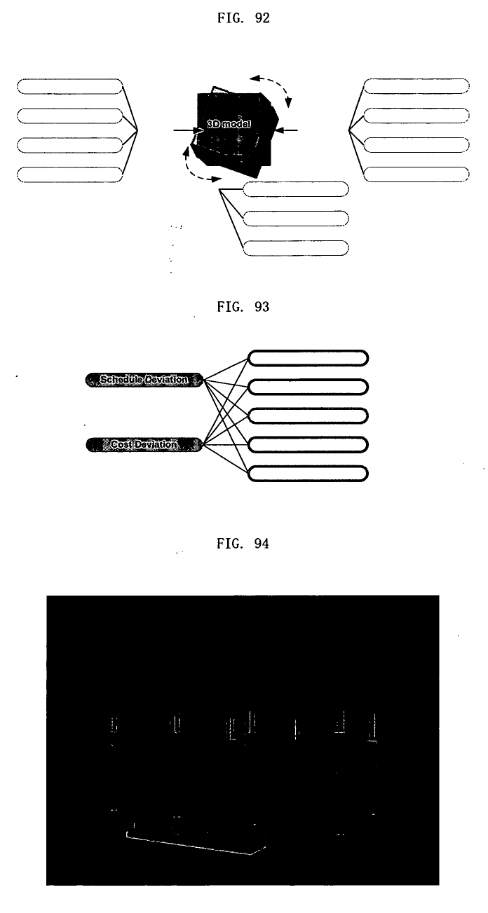

Deviation information and reasons for deviation are mapped together on the 3D model. This allows simultaneous visual identification of both quantity of deviation as well as the causes and impact of the deviation. FIG. 91 shows an example of possible associations among data related to deviation, while FIG. 92 provides an example of information application where such data is explicitly expressed using the visual properties of 3D models.

The color shows deviation type (e.g., non-critical or critical), cause (e.g., accident, weather, equipment, material, or labor) or characteristic (e.g., compensable or non-compensable) and the tone displays quantitative value. Based on the object's level of shaking, the quantitative value can be displayed, and using the two variables of shaking on and off, the two types or characteristics of deviation can be expressed.

In terms of mapping information on 3D models, the application may be inefficient due to the nature of the visual properties of information and a 3D model. For instance, since the 3D model's border is not as visually distinct as the model face in terms of color tone application, the expression of quantitative value with tone at the border of a 3D model would not be effective. FIG. 92 shows concurrent representations of deviation-related information on a 3D model.

Causes

Identifying the cause is critical information for resolving problems when a deviation occurs. The cause of a problem can be expressed through the face or border color of the 3D model. FIG. 93 shows a color scheme for types of causes.

Application of Forecasting Information

Estimate at Completion

The estimate at completion (EAC) is expressed through scale changes in the 3D model. The 3D models made up of two clones are superimposed, with the size of the as-build model showing BCWS (budgeted cost work scheduled), and the superimposed model size showing EAC. Cost summary for work in progress, in case of Activity A, is shown in Table 21. For example, if Activity A's BCWP is $ 10,000 and ACWP is $15,000 at a certain point in time:

EAC=(ACWP/BCWP)*BCWS=(15000/10000)*20000=$30,000

TABLE 21

| | BCWS | BCWP | ACWP | EAC |
|---|---|---|---|---|
| Activity A | $20,000 | $10,000 | $15,000 | $30,000 |

Then, the size of the ghost object expressing EAC is scaled-up by 150 percent. The two types of 3D models have individual opacity control from the prototype, allowing easy visual depiction of differences. FIG. 94 shows superimposition of the clone models. In FIG. 94, grey color represents ‘BCWS’ and red color represents ‘EAC’.

C-6 Data Combinations of 3D Model-Based System

FIG. 95 shows examples of data sets where 3D objects can be simultaneously applied. Data combination can be diverse according to the purpose it serves. Based on user preference and the specific purpose of control, a variety of information can be seen by applying it flexibly on the product model-based interface. As an example, if schedule deviation occurs on part of the construction, information such as criticality, reason for deviation, estimate at completion (EAC), and performance index can be applied to the 3D model to see the current issue, its impact on other construction parts, and future trends all at once.

So far, design principles of multiple data representation using the 3D model have been demonstrated, with concurrent representation of very flexible information through the combination of diverse graphical properties and visual attributes offered by the 3D model.

### EXAMPLE

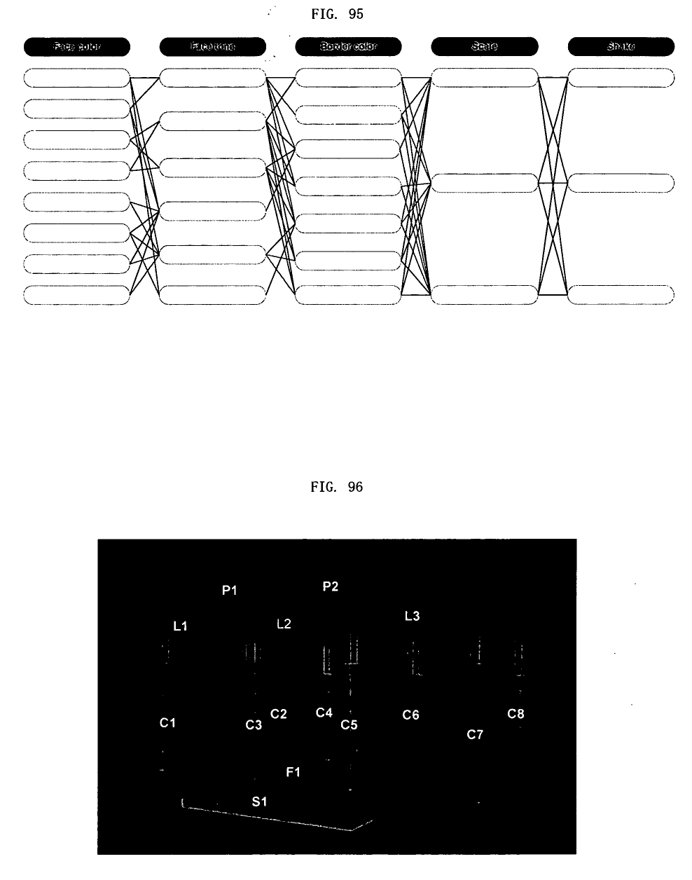

FIG. 96 shows an example of five types of information expressed in the 3D model at once. Only the data value of activity within the time range set by the user using the time range slider (see section 6.2.2) control is expressed in the 3D model, and in this example, F1, C1, C2, C3, C4, C5, C6, C7, and C8 are within the time range. Among the activities outside the time range, those that are completed (S1) are expressed in solid gray color without data value application, while incoming activities (L1, L2, L3, P1, P2) are expressed in wire frame. Expression of information using the visual properties of activities within the time range is done as follows:
ghost model: as-build model
face color of ghost model: criticality
shape of solid model: percent complete
C1-C8: 80% is completed
face color of solid model: CPI/SPI
F1: blue, excellent performance
C1-C8: orange, schedule delay and cost saving by quadrangle color scheme or poor performance by band color scheme
border color of solid model: causes of deviation (see FIG. 5.41)
color of as-build model: criticality

In this example, the project manager can identify the status of the activities currently in progress, as well as the areas and causes of delays or cost overruns. It is possible to see that the following activities can impact the schedule due to criticality.

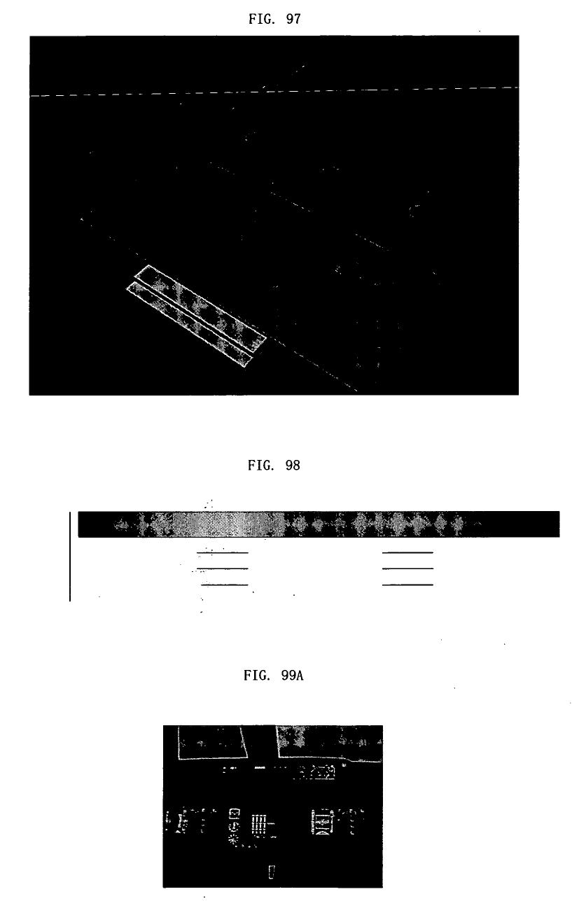

FIG. 97 is an example of expressing 6 types of information at once.
wireframe model: as-build model
border color of wireframe model: causes of deviation
ghost model: estimate at completion
face color of ghost model: criticality
shape of solid model: percent complete
C1-C8: 80% is completed
face color of solid model: CPI/SPI
F1: blue, excellent performance
C1-C8: orange color, schedule delay and cost saving by quadrangle color scheme or poor performance by linear color scheme
Criticality (color of as-build model)

Application of the Proposed Design Principles

The many 3D model-based visualization methods proposed so far show examples of flexible application in which multivariable data can be expressed simultaneously. As the number of data applied to the 3D model grows, it is inevitable that the model grows more visually complex. A few suggestions have been made below for the effective application of the methodology proposed by this thesis.

Use of Consistent Color

Based on the consistent application of color, as in the example of FIG. 98, blue was used as an index to show the multiple facets requiring less management in terms of project control. Red was used to express areas of schedule or cost deviation requiring special control, as well as areas where the float decreases due to critical activities and delays. This makes information much easier to understand.

Use of Tone

When the tone variation is applied to the borders of the 3D model, the difference is not visible. This is why the application of tonal changes is limited to the face.

Use of Opacity

Application of opacity (or a ghost image) should not be used alongside the application of tone since the color of the ghost image may distort the color tone.

D. Project Control System for Project Manager, Project Dashboard

Most project managers manually acquire information created by other professionals, view the fragments of information, and interpret them in comparison to actual progress. Such responsibility requires a great deal of experience, time, and effort in the absence of a project manager's control system. Project Dashboard was specifically developed for project managers who, up to now, haven't been able to use computer technology as a tool for control.

The design principle for integrating temporal and spatial information cannot be used effectively without an appropriate user control interface within the control system. The system interface is demonstrated using Project Dashboard. Explanations about the representation of the information are provided below.

D-1 Graphical User Interface: Dashboard

The term “dashboard” is commonly used to refer to the surface located below the windscreen of a motor vehicle or aircraft, which contains instruments and controls. Raskin (2000) notes that users do not care what processor is used, or whether the programming language is object-oriented or multithreaded. What users want is convenience and results. All that they see is the interface. As far as the customer is concerned, the interface is the product. A well-designed dashboard interface gives correct, critical, but easy and intuitive guidance, regardless of the driver's level of knowledge, age or genders. FIGS. 99A and 99B are examples of dashboard interfaces.

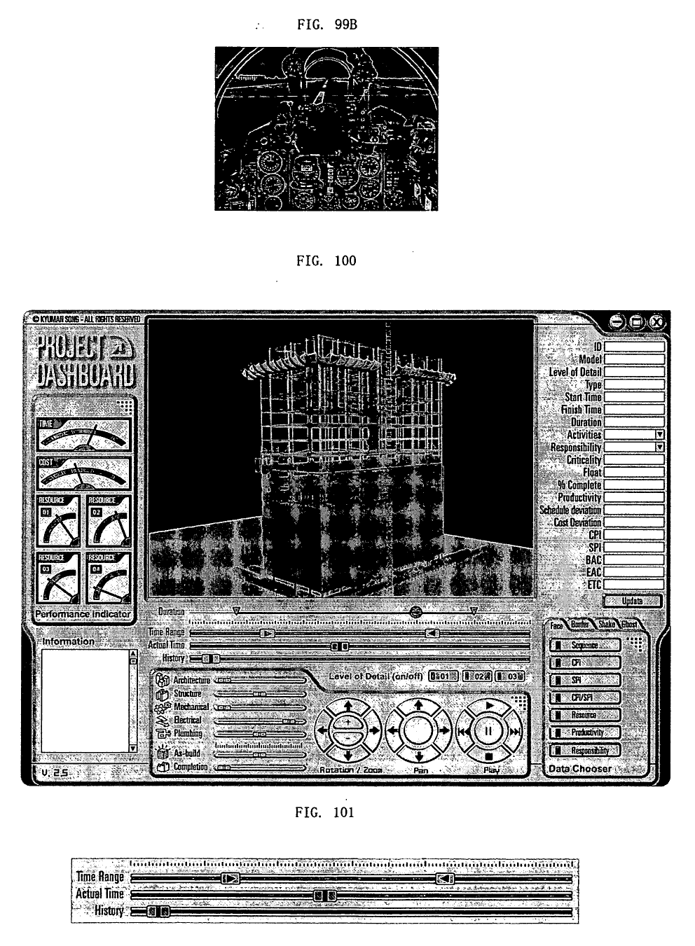

The project manager, as project driver, is responsible for monitoring and controlling a dynamic construction process involving vast amounts of information from the site and various participants. His or her reaction time should be accurate and quick in order to minimize conflicts, time delays, and cost overruns. Unlike architects, schedulers, or cost engineers, who need specific computer functions to develop and manage a certain set of information, project managers need a decision support system, which can aggregate all project-related information in a single and intuitive language and show a whole picture of it on an easy control interface. A dashboard-like interface can improve understanding of the project status and give accurate information to decision makers for correct action and predictions. FIG. 100 is the graphical interface of the prototypical system, “Project Dashboard.”

D-2 Control Interface

Summary of Features
“Navigator” to control the 3D model dynamically
“History” slider to view data changes both forward and backward in time
“Time range” slider to view the user's interest in a certain period of time.
“Actual time” slider to define a point of certain time.
“X-ray” sliders to control opacity of the selected types of building components.
“Data selector” to choose data sets for assigning visual properties to a 3D model.

Navigator

A basic tool for controlling the 3D model window, the Navigator control cluster consists of “Zoom,” “Pan,” “Rotation,” and animation play buttons. The animation play button shows the linear sequence of construction as is the case with 4D CAD.

Time Control Sliders

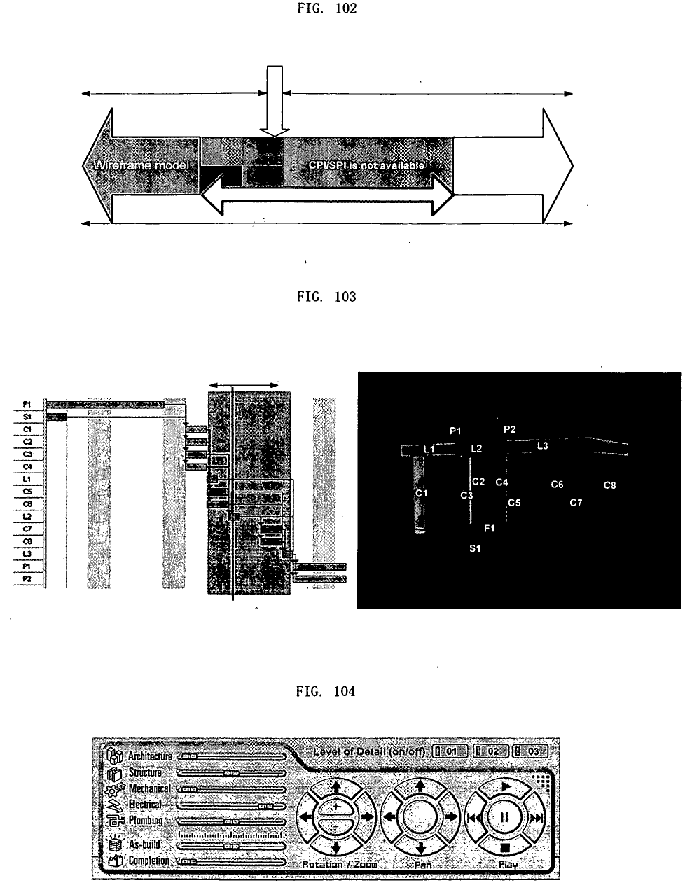

Among the most important control functions of Project Dashboard are the three sliders linked to time: time range, actual time, and history slider. The total length of the slider shows the project's total duration. FIG. 101 shows an example of time control slider.

Time Range Slider

The time range bar defines user's focus time. Information is presented on 3D elements only in the specified time range. Only the activities data value corresponding to the duration between the bars that define two points in time are applied to the 3D model, and therefore the user can selectively view the status of the desired duration. In other words, the user can see information selectively for the time scope of their choice. FIG. 102 shows how to select visual representation of performance by controlling of actual and time ranger sliders.

Actual Time Slider

The actual time slider and time range slider interact. The following two examples will describe how the actual time slider works with the time range slider, according to different visual representations of information.

### Example 1

### Sequence

Based on the actual time bar, 3D objects representing completed activities are in a gray tone, while in-progress and incoming activities appear in the applied color. A lighter tone is applied for completed activities as completion time moves away from actual time, while the darker color is used as the activity start time of in-progress activities and incoming activities draws closer to the actual time. 3D objects in which activities outside the time range are applied, are expressed in wireframe. FIG. 103 shows an output image corresponding to visual representation of sequence by time range slider and actual time slider. Meanwhile, color representation of sequence is suggested in Table 22.

TABLE 22

| | Day 01 | Day 02 | Day 03 | Day 04 | Day 05 | Day 06 |
|---|---|---|---|---|---|---|
| Completed activities | Actual time Incoming activities | | | | | |
| Color & tone On 3D objects | 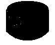 | 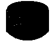 | 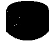 | 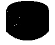 | 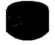 | 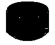 |

### Example 2

### Performance

Performance is displayed as follows. Based on actual time, 3D objects for completed activities and in-progress activities have their relevant performance index value expressed in color. At the same time, 3D objects for incoming activities, having no application value, are expressed in gray. As for 3D objects for outside the time range, the completed objects with performance value are expressed in grey and incoming activities in wireframe.

History Navigator

Using the history slider, the user can see animations on changes in project history with the passage of time. In the example of Table 23, below, the total project duration of Project A is 6, the history slider's total length shows the same duration, and each day's changes are shown through keyframe animation following the movement of the slider.

TABLE 23

| | Day 01 | Day 02 | Day 03 | Day 04 | Day 05 | Day 06 |
|---|---|---|---|---|---|---|
| CPI | 1.0 | 1.2 | 1.1 | 0.9 | 0.7 | 1.0 |
| Color | Blue | Darker | Green | Darker | Yellow | Blue |
| | | green | | yellow | | |
| Object | 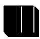 | 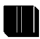 | 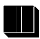 | 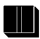 | 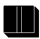 | 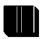 |

Opacity Control Sliders

FIG. 104 shows opacity control sliders, navigators, and level of detail control buttons of Project Dashboard.

Group Opacity Sliders

These are the sliders that control the opacity of each user-defined group. For example, the building components are divided into five groups; architectural, structural, mechanical, electrical, and plumbing, which can be distinguished and applied to the project dashboard, with 100 percent presented in solid and 0 percent being invisible. It allows an easy view of problematic groups of 3D models and hiding 3D models that are visually blocked by other building components.

Opacity Slider for as-Build Model

The models presented in the 3D model viewer always superimpose two identical models, in order to compare plan with actual status. The as-build slider provides opacity control of the basic geometric shape of building 3D objects, that is, the as-build model.

Opacity Slider for Actual Completion

The other slider controls opacity of the 3D model, which goes through scale changes when percentage of completion or actual cost is assigned. By superimposing these two sliders and simultaneously comparing the 3D objects displaying the plan and the actual performance, respectively, the project status can easily and intuitively be known.

Data Selector

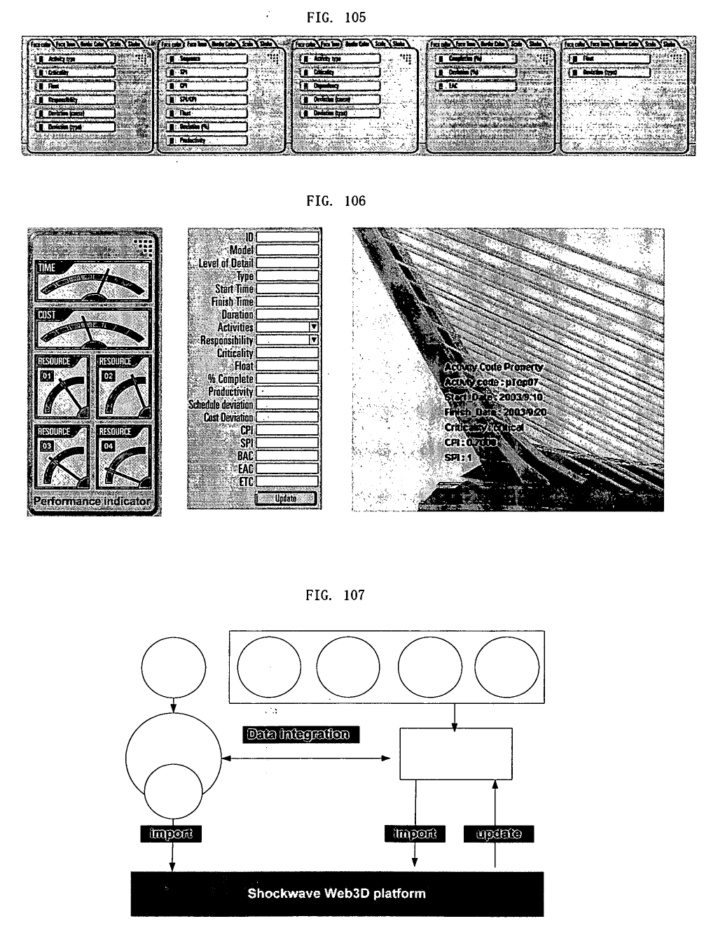

The user can freely choose sets of data for applying to the different visual attributes of the 3D model. In the data selector, when the tab for each visual attribute is pressed, the applicable data set appears, of these, one data variable can be chosen to easily apply to the 3D model. FIG. 105 shows data selector of Project Dashboard.

Level of Detail Buttons

This is a function that allows the user to select among three levels of detail. The prototype allows distinction of up to 3 levels. The level of detail for each 3D model component can be defined in the text pane.

D-3 Information Panes

Summary of Features
information list pane
Performance Indicator
Interactive text annotation

Information List Pane

The information list shows the numerical value of information applied to the 3D model, and offers editing functions. When one of the 3D building components is selected, the relevant value in FIG. 106 is presented in the editable text box. Since new data is that has been input is immediately applied to the value on the model, developments due to data change can easily be known.

Performance Indicator

These indicators apply to schedule, cost, and resource performance of the entire project. If the needle is within the green range, this means “perfect performance.” In the red range, it means “poor performance,” If the needle moves to the green range farther to the right, it shows “excellent performance.” The resource indicators show the performance of the specific resources or areas chosen by the user.

Interactive Text Annotation

Text annotation is a function of expressing in text form detailed information about the relevant 3D objects that are mouse-over within the 3D model window.

D-4 Prototyping Technology & Process

A 3D model produced by either MAYA or 3D MAX is exported to Macromedia Director 8.5 Shockwave Studio in a form of W3D file format. The Macromedia Director enables this model to communicate with the database. Before the data integration between 3D model and scheduling data, schedule spreadsheet must include each 3D component name in the list. The user can view and control it via internet browsers or as a standalone application. FIG. 107 shows prototyping process.

E. Conclusion

E-1 Summary

The always-dynamic and uncertain circumstances of building require an efficient control and monitoring system capable of clearly and intuitively presenting the impact of changes, deviations, constraints, and critical issues to enable accurate understanding and timely decision making. The massive amount of information collected from the various parties and from the site is not delivered to the project manager using a uniform method, but rather as fragmented data in variable formats. To interpret such data in an integrated way and to use it for project control requires a great deal of work and time, with inevitable cases of erroneous interpretation and overlooked information. Even within a single software suite, information is broken down and expressed using multiple graphical methods, making it difficult for the user to read or understand the data expressed.

For effective project control, an accurate comparison of baseline and actual performance as well as an analysis of discrepancies and impact is critical. In order for the control system to have value, multiple sets of data must be expressed comprehensively for the user to compare data and identify problems, their causes, and their effects simultaneously. The absence of a control system that satisfies these conditions is not due to limitations in technology, but rather to the fact that there is no uniform visual representation method that can comprehensively express multi-variable information.

A study which defined the data needed for control among the mass of data available to a project should have been the one to precede this study. The diverse subcomponents of earned value analysis, which provides an accurate measure of progress and also shows future impact using a uniform unit of measure, are defined as target data for the methodology of visual representation.

Going beyond traditional methods, which only allowed the expression of very limited information, diverse information visualization techniques were explored through the Pollalis System, multi-dimensional tree-maps, and the development of prototypes for 3-dimensional visualization. As a result, a multi-dimensional integration methodology between data and graphical attributes was developed, revealing the limitations in the ability of abstract visualization to show the relationship between temporal and spatial information.

A 3D product model-based visual platform has significant value as a construction information delivery platform. It is a consistent and realistic method with which to represent construction information using a common language that anyone can understand. Through the 4D CAD and parametric CAD systems analysis, the current 3D model-based system was found to be very limited in its scope because it lacked a visual representation method using the 3D model's graphical properties.

Expression of diverse information was made possible by applying visual attributes of color, tone, opacity, superimposition and movement on properties such as object face, border, and size on a single 3D building component. Only through such a multi-dimensional depiction of project control data can the accurate status of a project be determined, problems diagnosed and causes identified. Moreover, information can be easily identified without special knowledge by setting consistent visual attributes based on user preference. For instance, if the color red is applied to all data to represent a negative condition or circumstance, problems are readily apparent. In addition, the relationship among the data is explicitly shown spatially and in patterns to allow trend analysis for the future.

The various methods of information representation using the 3D model as proposed by this thesis obtain their values through an effective control interface tailored to the user's specific conditions and demands. Project Dashboard, the prototype, presents a new control system concept called an information representation system. This system can display information in a uniform manner by integrating multivariable data delivered from many other systems or from the construction site, breaking away from the existing input-oriented, production-oriented project control system. Functions like the time range slider, which allows the user to view a specific time range, and the data selector, which applies the desired information to the 3D model, provide users with more freedom to obtain information.

E-2 Contributions

Research and development in 3D product model-based systems are currently making swift advances. However, there has been almost no research or development done on methods for utilizing 3D models as a platform for information representation. The present invention introduces guidelines and design principles for multi-dimensional visual representation of multivariable project information using 3D models. It also seeks to provide a picture of a future 3D model-based system that can be applied with flexibility in diverse areas through soft-line drawing.

E-3 Future Work

The present invention for information visualization methods using 3D models may be expanded and developed in a variety of directions. In one direction, a study on visual representation methods able to explicitly express the interactive impact between design changes during the project and performance is needed. Frequent design changes during construction have a major impact on project performance, and should therefore be a target of future study. Another direction, in the area of multi-user collaborative environments for project teams, would be to provide accessibility to data based on each entity's role and responsibility. This could extend into the development of a 3D model-based management system suite that provides visual representation at the level of complexity appropriate to the needs of each entity.

The present invention has introduced a multidimensional visual representation method for multivariable project information using a 3D product model, and has also redefined the project control system as an information representation system. The new visual representation method proposed by this thesis will not be able to directly shorten the project schedule or offer cost savings. However, by simultaneously bundling multivariable data, which so far has not been used with value in project control, on the building 3D model-based platform, the interrelationship among data was revealed. This is not to imply that the proposed visual representation method should substitute for the diverse visual representation methods currently used in construction projects. However, it is a method that can eliminate some of their limitations. Hopefully it will be broadly applied as a toolkit for developing product model-based systems for the diverse areas of architecture, engineering, and construction in the future.

The present invention may be embodied in a general-purpose computer by running a program from a computer readable medium, including but not limited to storage media such as magnetic storage media (ROMs, RAMs, floppy disks, magnetic tapes, etc.), optically readable media (CD-ROMs, DVDs, etc.), and carrier waves (transmission over the Internet). The present invention may be embodied as a computer readable medium having a computer readable program code unit embodied therein for causing a number of computer systems connected via a network to effect distributed processing.

The present invention can be applied not only to the construction process but also to the production process of cars and electronic products

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for visually representing project metrics on 3-dimensional (3-D) product models, comprising the steps of:
establishing temporal and/or spatial relationships between objects to be visualized;
setting the variations in the color and color tone of the objects in response to the course of a project;
receiving an input of information concerning the project course from a user or an external system;
determining colors and color tones of the objects according to the project course based on output conditions input by the user; and
forming and outputting 3-dimensional images of the objects by the determined colors and color tones.

2. The method according to claim 1, wherein the project course is divided into ‘completion of production’, ‘during production’ and ‘before production’, and an inherent color is assigned to each project course.

3. The method according to claim 1, further comprising the steps of:
calculating cost performance index (i.e. budgeted cost of work performed/actual cost of work performed) and schedule performance index (i.e. budgeted cost of work performed/budgeted cost of work scheduled); and
changing the formed 3-dimensional images based on the calculated cost performance index and/or schedule performance index.

4. The method according to claim 3, wherein the step of changing the images includes the sub-steps of:
calculating the performance of the overall project based on the calculated cost performance index and schedule performance index; and
changing background color tones and/or background images of the 3-dimensional images in response to the calculated performance of the overall project.

5. The method according to claim 3, further comprising the step of changing at least one factor selected from the colors, color tones, border colors and display locations of the objects belonging to respective constituent substages of the overall project in response to the variations in the complexity, execution period of the substages and/or the calculated cost performance index and schedule performance index.

6. The method according to claim 1, further comprising the step of changing at least one factor selected from the colors, color tones, border colors and display locations of the objects belonging to respective constituent substages of the overall project in response to the variations in the complexity and/or execution period of the substages.

7. The method according to claim 1, further comprising the steps of:
receiving respective production costs of the objects;
changing the colors of the objects to predetermined display colors for the production costs according to the choice of a user; and
changing the tones of the display colors for the production costs depending on the respective production costs of the objects.

8. The method according to claim 7, further comprising the steps of:
calculating cost performance index (i.e. budgeted cost of work performed/actual cost of work performed) and schedule performance index (i.e. budgeted cost of work performed/budgeted cost of work scheduled); and
changing the formed 3-dimensional images based on the calculated cost performance index and/or schedule performance index.

9. The method according to claim 1, further comprising the steps of:
receiving objects and causes to be changed in the project from a user and/or an external system; and
changing the colors and color tones of the objects to be visualized corresponding to those of the input objects in response to the input causes.

10. The method according to claim 9, further comprising the step of changing at least one factor selected from the colors, color tones, border colors and display locations of the objects belonging to respective constituent substages of the overall project in response to the variations in the complexity and/or execution period of the substages.

11. A system for visually representing project metrics on 3-dimensional (3-D) product models, comprising:
a user interface unit for receiving an input of color information, including variations in the colors and color tones of objects to be visualized in response to the course of a project, and output conditions, including a time interval at which an output is required, from a user;
a database unit for storing the objects and temporal and/or spatial relationships between the objects; and
an image formation unit for determining colors and color tones of the objects according to the project course based on the output conditions input by the user, and forming and outputting 3-dimensional images of the objects by the determined colors and color tones.

12. The system according to claim 11, wherein the user interface unit receives an input of color information and output conditions through a user interface screen by a user, the user interface screen including a data selection unit for allowing the user to input color information including variations in the colors and color tones of the objects in response to the project course and a time setting unit for allowing the user to input output interval and output time.

13. The system according to claim 11, wherein the project course is divided into ‘completion of production’, ‘during production’ and ‘before production’, and an inherent color is assigned to each project course.

14. The system according to claim 11, wherein the image formation unit serves to calculate cost performance index (i.e. budgeted cost of work performed/actual cost of work performed) and schedule performance index (i.e. budgeted cost of work performed/budgeted cost of work scheduled), and to change the formed 3-dimensional images based on the calculated cost performance index and/or schedule performance index.

15. The method according to claim 11, further comprising the step of changing at least one factor selected from the colors, color tones, border colors and display locations of the objects belonging to respective constituent substages of the overall project in response to the variations in the complexity, execution period of the substages and/or the calculated cost performance index and schedule performance index.

16. The system according to claim 11, wherein the image formation unit serves to calculate cost performance index (i.e. budgeted cost of work performed/actual cost of work performed) and schedule performance index (i.e. budgeted cost of work performed/budgeted cost of work scheduled), to calculate the performance of the overall project based on the calculated cost performance index and schedule performance index, and to change background color tones and/or background images of the 3-dimensional images in response to the calculated performance of the overall project.

17. The system according to claim 11, wherein the image formation unit serves to change at least one factor selected from the colors, color tones, border colors and display locations of the objects belonging to respective constituent substages of the overall project in response to the variations in the complexity and/or execution period of the substages.

18. The system according to claim 11, wherein the image formation unit serves to change the colors of the objects to predetermined display colors for the construction costs in response to respective set construction costs of the objects depending on the construction costs.

19. The system according to claim 11, wherein the image formation unit serves to change the colors and color tones of the objects corresponding to those of objects to be changed in a project input by a user and/or an external system in response to causes to be changed in the project input by the user and/or the external system.

20. A computer readable medium having recorded thereon a computer readable program for executing a method for visually representing project metrics on 3-dimensional product models, the method comprising the steps of:
establishing temporal and/or spatial relationships between objects to be visualized;
setting the variations in the color and color tone of the objects in response to the course of a project;
receiving an input of information concerning the project course from a user or an external system;
determining colors and color tones of the objects according to the project course based on output conditions input by the user; and
forming and outputting 3-dimensional images of the objects by the determined colors and color tones.
